(19) United States
(12) Patent Application Publication
(10) Pub. No.: US 2024/0010778 A1
(43) Pub. Date: Jan. 11, 2024

(54) CHARGED SURFACTANT PARTICLES AND BRUSH POLYMERIC PARTICLES, METHODS OF MAKING SAME, AND USES THEREOF

(71) Applicant: CORNELL UNIVERSITY, Ithaca, NY (US)

(72) Inventors: Mohamed Amen Hammami, Ithaca, NY (US); Genggeng QI, Webster, NY (US); Emmanuel P. Giannelis, Ithaca, NY (US)

(21) Appl. No.: 18/025,279

(22) PCT Filed: Sep. 9, 2021
(86) PCT No.: PCT/US21/49730

§ 371 Date: Mar. 8, 2023

Related U.S. Application Data
(60) Provisional application No. 63/076,371, filed on Sep. 9, 2020.

(51) Int. Cl. C08F 12/28; C08F 12/30; C08J 3/12

(52) U.S. Cl. CPC C08F 12/28; C08F 12/30; C08J 3/126; C08J 2329/04; C08J 2371/00; C08F 2500/24; C08J 2323/06; C08J 2323/12

(57) ABSTRACT

Polymeric particles (e.g., charged polymeric particles or brush polymeric particles), methods of making polymeric particles, and uses thereof. The brush polymeric particles include polymeric brushes disposed at an exterior surface. The polymeric particles can be nanoparticles or microparticles. The polymeric particles can be capsules or solid particles. A capsule includes a polymeric shell. A solid particle or a polymeric shell may include polymeric materials and surfactants and/or surfactant precursors. A polymeric particle may include a positive charge on at least a portion of an exterior surface of the polymeric particle. At least a portion of the surfactant(s) and/or the surfactant precursor(s) can diffuse out of and/or can be released by the hydrolysis of at least a portion of the polymeric material(s). The polymeric particles can be used in oil recovery applications to deliver surfactant(s) and/or surfactant precursor(s) to oil reservoirs.

### CROSS-REFERENCE TO RELATED APPLICATIONS

This application claims the benefit of U.S. Provisional application No. 63/076,371 filed Sep. 9, 2020, the contents of the above-identified application are hereby fully incorporated herein by reference in their entirety.

### BACKGROUND OF THE DISCLOSURE

World energy consumption relies heavily on fossil fuels and oil remains at the forefront contributing more than 30% to the total. In order to meet the energy demands worldwide there is a need to identify more reserves as well as increase the levels of production of existing ones. Exploration and discovery of new reserves used to be the most common solution to increase oil production. However, it is energy-intensive and the cost to build new infrastructure is high. Furthermore, the discovery of new fields seems to be approaching saturation. To overcome this limitation, researchers have sought alternative approaches involving lower capital and operational expenditures to improve the production/recovery of existing fields using enhanced oil recovery (EOR) processes.

For maximum oil recovery, tertiary recovery (EOR) has been utilized to efficiently recover oil left in an oil reservoir after waterflooding (secondary recovery) and the primary recovery based in the natural pressure of the field. EOR techniques can contribute to a longer lifetime of an existing reservoir by mobilizing the remaining oil trapped in the pores of the reservoir. EOR processes include thermal (combustion), gas (nitrogen or CO₂ injection), and chemical methods (mostly polymer flooding, surfactant flooding, or alkaline flooding).

Surfactant injection has been investigated. However, the use of surfactants suffers currently from several drawbacks including high rock adsorption, which makes the process less effective and adds to the cost. To overcome these challenges, the addition of sacrificial chemicals to lower the adsorption has been explored. However, this is also cost-intensive for the oil and gas industry.

Injection of surfactants has been investigated as an efficient approach for enhanced oil recovery (EOR). Surfactants can reduce the interfacial tension (IFT) and alter the wettability of the mineral surface in a reservoir both of which lead to enhanced oil recovery. A challenge of injecting neat surfactants is their high adsorption by the rock, which adds to the cost of the process. Another challenge is dilution of injected surfactants along the pathways, which leads to reduced effectiveness deep into the reservoir.

Injection of particles (e.g., nanoparticles or microparticles) into hydrocarbon or geothermal reservoirs has been proposed as an attractive approach for reservoir monitoring and remediation. One challenge that limits particle deployment in subsurface reservoirs is their colloidal stability in typical reservoir environments of high salinity (several thousand ppm) and high temperature (up to 150° C.). Downhole aquatic media generally exhibit very high ionic strength due to the presence of monovalent (Na⁺, C⁻) and divalent (Ca²⁺, Mg²⁺, SO₄²⁻) ions, which screen the charge on the particles and can cause aggregation and settling. This challenge is exacerbated by the high temperature environment. This aggressive environment leads frequently to particle aggregation and settling. An additional challenge is adsorption on the surface of the mineral rocks present in the reservoir, which limits the distance that the particles can travel inside the reservoir.

### SUMMARY OF THE DISCLOSURE

In an aspect, the present disclosure provides a charged polymeric particle. A charged polymeric particle can comprise various internal structures. In various examples, a charged polymeric particle is a solid particle or a capsule comprising a polymeric shell defining a spherical space. In various examples, a solid particle or a polymeric shell comprises one or more polymeric material(s). In various examples, a solid particle or a polymeric shell further comprises one or more additive(s). In various examples, the additive(s) comprise one or more surfactant(s), one or more surfactant precursor(s), or the like, or any combination thereof disposed in the polymeric material(s) and/or the spherical space. In various examples, the polymeric material(s) is/are not crosslinked and/or not complexed.

A charged polymeric particle can comprise various charge types disposed at various portion(s) of a charged polymeric particle. In various examples, one or more or all portion(s) of an outer surface of a charged polymeric particle are positively charged, such as, for example, with a static positive charge or a non-static positive charge.

A charged polymeric particle can have various dimensional values. In various examples, a charged polymeric particle is a charged polymeric nanoparticle, a charged polymeric microparticle, or the like. In various examples, a polymeric shell comprises a thickness measured in nanometers (e.g., a nanoshell), microns (e.g., a microshell), or the like.

A charged polymeric particle can comprise various polymeric material(s), such as, for example, polymer(s), copolymer(s), or the like, or any combination thereof. In various examples, the polymeric material(s) comprise(s) one or more hydrolyzable polymeric material(s), one or more non-hydrolyzable polymeric material(s), a copolymer thereof, or the like, or any combination thereof. In various examples, the hydrolyzable polymeric material(s) each comprise one or more hydrolyzable group(s).

A charged polymeric particle can comprise various surfactant(s) and/or surfactant precursor(s). In various examples, the surfactant(s) is/are chosen from cationic surfactant(s), anionic surfactant(s), nonionic surfactant(s), zwitterionic surfactant(s), and the like, and any combination thereof. In various examples, the surfactant(s) is/are polymeric surfactant(s). In various examples, one or more or all portion(s) of the hydrolyzable polymeric material(s) is/are the surfactant precursor(s).

A charged polymeric particle can comprise various charged groups. In various examples, one or more or all portion(s) of an outer surface of a charged polymeric particle comprise(s) a plurality of positively charged groups. In various examples, the polymeric material(s) comprise(s) a plurality of positively charged groups disposed on one or more or all portion(s) of an outer surface of the charged polymeric particle, where the positively charged groups of the polymeric material(s) provide some or all of the positive charge of the charged polymeric particle.

In an aspect, the present disclosure provides a brush polymeric particle (e.g., a nanoparticle, a microparticle, or the like) comprising one or more polymer brush(es). A brush polymeric particle (e.g., a nanoparticle, a microparticle, or the like) can comprise various types of polymer brush(es) disposed on various portion(s) of the brush polymeric particle (e.g., a nanoparticle, a microparticle, or the like). A brush polymeric particle (e.g., a nanoparticle, a microparticle, or the like) may be a charged brush polymeric particle (e.g., a nanoparticle, a microparticle, or the like). In various examples, the polymer brush(es) is/are positively charged polyelectrolyte brush(es).

A brush polymeric particle (e.g., a nanoparticle, a microparticle, or the like) can comprise various internal structures. In various examples, a brush polymeric particle (e.g., a nanoparticle, a microparticle, or the like) comprises one or more polymer brush(es) disposed on an exterior surface of a solid particle or a capsule comprising a polymeric shell defining a spherical space. In various examples, a solid particle or a polymeric shell comprises one or more polymeric material(s). In various examples, a solid particle or a polymeric shell further comprises one or more additive(s). In various examples, the additive(s) comprise one or more surfactant(s), one or more surfactant precursor(s), or the like, or any combination thereof disposed in the polymeric material(s) and/or the spherical space. In various examples, the polymeric material(s) is/are not crosslinked and/or not complexed.

A brush polymeric particle (e.g., a nanoparticle, a microparticle, or the like) can comprise various charges disposed at various portion(s) of a brush polymeric particle (e.g., a nanoparticle, a microparticle, or the like). In various examples, one or more or all portion(s) of an outer surface of a brush polymeric particle (e.g., a nanoparticle, a microparticle, or the like) is/are positively charged, such as, for example, with a static positive charge or a non-static positive charge.

A brush polymeric particle (e.g., a nanoparticle, a microparticle, or the like) can have various dimensional values. In various examples, a brush polymeric particle is a brush polymeric nanoparticle, a brush polymeric microparticle, or the like. In various examples, a polymeric shell of a brush polymeric nanoparticle comprises a thickness measured in nanometers (e.g., a nanoshell), microns (e.g., a microshell), or the like.

A brush polymeric particle can comprise various polymeric material(s), such as, for example, polymer(s), copolymer(s), or the like, or any combination thereof. In various examples, the polymeric material(s) comprise(s) one or more hydrolyzable polymeric material(s), one or more non-hydrolyzable polymeric material(s), a copolymer thereof, or the like, or any combination thereof. In various examples, the hydrolyzable polymeric material(s) each comprise one or more hydrolyzable group(s).

A brush polymeric particle can comprise various surfactant(s) and/or surfactant precursor(s). In various examples, the surfactant(s) is/are chosen from cationic surfactant(s), anionic surfactant(s), nonionic surfactant(s), zwitterionic surfactant(s), and the like, and any combination thereof. In various examples, the surfactant(s) is/are polymeric surfactant(s). In various examples, one or more or all portion(s) of the hydrolyzable polymeric material(s) is/are the surfactant precursor(s).

A brush polymeric particle can comprise various charged groups. In various examples, one or more or all portion(s) of an outer surface of a brush polymeric particle comprise(s) a plurality of positively charged groups. In various examples, one or more polymeric material(s) comprise(s) a plurality of positively charged groups disposed on one or more or all portion(s) of an outer surface of a charged polymeric particle, where the positively charged groups of the polymeric material(s) provide some or all of the positive charge of the brush polymeric particle. In various examples, one or more polyelectrolyte brush(es) disposed on one or more or all portion(s) of an outer surface of a brush polymeric particle comprise(s) a plurality of positively charged groups, where the positively charged groups of the polyelectrolyte brushe(s) provide some or all of the positive charge of the brush polymeric particle.

In an aspect, the present disclosure provides a composition comprising one or more charged polymeric particle(s) of the present disclosure. In various examples, a composition comprise(s) one or more positively charged polymeric particle(s) of the present disclosure.

In an aspect, the present disclosure provides a method for oil recovery. In various examples, a method comprises contacting an oil-containing geological formation with one or more positively charged polymeric particle(s) of the present disclosure. In various examples, after contacting, one or more surfactant(s) and/or one or more surfactant precursor(s) is/are released from at least a portion of the positively charged polymeric particle(s). In various examples, contacting is achieved by pumping the positively charged polymeric particle(s) through a well bore. In various examples, contacting results in increased oil production from a geological formation. In various examples, releasing is achieved by diffusion out of at least a portion of the positively charged polymeric particle(s) and/or hydrolysis of at least a portion of the polymeric material(s). In various examples, the positively charged polymeric particle(s) is/are present as a composition of the present disclosure.

In an aspect, the present disclosure provides a composition comprising one or more brush polymeric particle(s) of the present disclosure. In various examples, a composition comprise(s) one or more positively charged brush polymeric particle(s) of the present disclosure.

In an aspect, the present disclosure provides a method for oil recovery. In various examples, a method comprises contacting an oil-containing geological formation with one or more positively charged brush polymeric particle(s) of the present disclosure. In various examples, after contacting, one or more surfactant(s) and/or one or more surfactant precursor(s) is/are released from at least a portion of the positively charged brush polymeric particle(s). In various examples, contacting is achieved by pumping the positively charged polymeric particle(s) through a well bore. In various examples, contacting results in increased oil production from a geological formation. In various examples, releasing is achieved by diffusion out of at least a portion of the positively charged brush polymeric particle(s) and/or hydrolysis of at least a portion of the polymeric material(s). In various examples, the positively charged brush polymeric particle(s) is/are present as a composition of the present disclosure.

### BRIEF DESCRIPTION OF THE FIGURES

For a fuller understanding of the nature and objects of the disclosure, reference should be made to the following detailed description taken in conjunction with the accompanying figures herein.

FIGS. 1A-1B show (FIG. 1A) a representation of a design for preparation of charged polymeric nanoparticles (“NPs”) and (FIG. 1B) attachment of charged polymeric NPs to an oil interface and release of additives for enhanced oil recovery (“EOR”).

FIGS. 2A-2B show TEM micrographs of (FIG. 2A) positively charged polystyrene NPs (“PS+ NPs”), and (FIG. 2B) negatively charged polystyrene NPs (“PS− NPs”). The scale bars for FIGS. 2A-2B correspond to 200 nanometers (nm).

FIGS. 3A-3D show confocal micrographs showing attachment of PS+ NPs on an oil-water interface for (FIGS. 3A-3B) a 1000 parts per million (ppm) injection of PS+ NPs and (FIG. 3C) a 100 ppm injection of PS+ NPs and (FIG. 3D) non-attachment of PS− NPs on an oil-water interface. The scale bar for FIG. 3A corresponds to 50 microns (μm) while the scale bars for FIGS. 3B-3D correspond to 10 μm.

FIGS. 4A-4C show 3D-confocal micrographs of an oil droplet covered with PS+ NPs at increasing (down to up) depth within the droplet: (FIG. 4A) fluorescence of the PS+ NPs on an oil droplet using a red filter, (FIG. 4B) fluorescence of an oil droplet using a blue filter, and (FIG. 4C) an overlap of fluorescence of PS+ NPs and an oil droplet using two filters. The scale bars for FIGS. 4A-4C correspond to 10 μm.

FIGS. 5A-5F show 3D-confocal micrographs of an oil droplet covered with PS+ NPs at increasing (down to up) depth within a droplet: fluorescence of PS+ NPs on an oil droplet using a red filter and fluorescence of an oil droplet using a blue filter (PS+ NPs 1000 ppm in DI water/Model Oil). The scale bars for FIGS. 5A-5F correspond to 50 μm.

FIG. 6A-6B show confocal micrographs showing attachment of PS+ NPs on an oil-100% seawater interface for (FIG. 6A) a 1000 ppm injection of PS+ NPs and (FIG. 6B) a 100 ppm injection of PS+ NPs. The scale bars for FIGS. 6A-6B correspond to 50 μm.

FIGS. 7A-7C show confocal micrographs of the attachment of PS+ NPs on an oil-100% seawater interface (PS+ NPs 1000 ppm in seawater). The scale bar for FIG. 7A corresponds to 200 μm, while the scale bars for FIGS. 7B-7C correspond to 50 μm.

FIGS. 8A-8D show confocal micrographs of attachment of PS+ NPs on an oil-50% seawater interface at (FIG. 8A) 1000 ppm PS+ NPs injection and (FIG. 8B) 100 ppm PS+ NPs injection, on an oil-20% seawater interface at (FIG. 8C) 1000 ppm PS+ NPs injection and (FIG. 8D) 100 ppm PS+ NPs injection. The scale bars for FIGS. 8A-8D correspond to 50 μm.

FIGS. 9A-9D show confocal micrograph showing: an oil-5% NaCl brine water interface for brines at (FIG. 9A) a 1000 ppm injection of PS+ NPs and (FIG. 9B) a 100 ppm injection of PS+ NPs; an oil-1% NaCl interface for brines at (Fig. C) a 1000 ppm injection of PS+ NPs and (D) a 100 ppm injection of PS+ NPs. The scale bars for FIGS. 9A-9D correspond to 50 μm.

FIGS. 10A-10F show confocal micrographs showing an oil-water interface at (FIGS. 10A-10C) a 100 ppm injection of PS+ NPs at pH 7, 4, and 2, respectively, and (FIGS. 10D-10F) a 100 ppm injection PS− NPs at pH 7, 4, and 2, respectively. The scale bars for FIGS. 10A-10F correspond to 50 μm.

FIGS. 11A-11B show confocal micrographs showing Nile red diffusion from PS+ NPs into an oil phase (FIG. 11A) before and (FIG. 11B) after shaking in an oil-water mixture for 24 hours. The scale bar for FIG. 11A corresponds to 200 μm, while the scale bar for FIG. 11B corresponds to 50 μm.

FIGS. 12A-12B show fluorescence spectra of a calcite mixture with (FIG. 12A) PS+ NPs and (FIG. 12B) PS− NPs, showing no attachment between PS+ NPs and calcite (red: PS only, Black: PS and calcite).

FIG. 13 shows a schematic of an AFM used to obtain an image and an AFM image of PS+ NPs (1000 ppm) assembled at a oil-water interface. The tick marks of the AFM image correspond to 1.5 μm.

FIG. 14 shows confocal images demonstrating a successful delivery of ODA surfactant to an oil-water mixture: (FIG. 14A) DI water-model oil mixture showing large-scale phase separation and no finer oil droplets right after mixing and after 24 hours; (FIG. 14B) aqueous dispersion of ODA containing PS+ NPs-oil mixture right after mixing; (FIG. 14C) after 24 hours, where a finer emulsion can be seen. The scale bars for FIGS. 14A-14B correspond to 50 μm.

FIG. 15 shows a representation of hydrolyzable nanocapsules (“NCs”) encapsulating a surfactant precursor via interfacial emulsion polymerization.

FIGS. 16A-16F show an effect of monomer concentration on size of hydrolyzable capsules: (FIG. 16A) a chart of monomer concentration versus capsule dimension in nanometers (nm). SEM images of hydrolyzable capsules prepared with (FIG. 16B) 500%, (FIG. 16C) 300%, (FIG. 16D) 150%, (FIG. 16E) 100%, and (FIG. 16F) 66% of an original amount of monomer. The scale bars for FIGS. 16B-16D, and 16F correspond to 2 μm, while the scale bar for FIG. 16E corresponds to 500 nm.

FIGS. 17A-17E show hydrolyzable NCs undergoing hydrolysis in saline solution (FIG. 17A) at RT at t=0 min, (FIG. 17B) at 80° C. and at t=0 min, and (FIG. 17C) at 80° C. and at t=800 min, and SEM images of hydrolyzable NCs (FIG. 17D) before and (FIG. 17E) after hydrolysis. The scale bar for FIG. 17D corresponds to 2 μm, while the scale bar for FIG. 17E corresponds to 1 μm.

FIGS. 18A-18B show (FIG. 18A) degradation rates of an acid precursor dodecane sulfonyl chloride with and without encapsulation in hydrolyzable NCs and (FIG. 18B) a representation of a proposed delayed generation of a sulfonic acid and a sulfonate salt by encapsulation of an acid precursor in hydrolyzable NCs.

FIG. 19 shows an emulsification of crude oil and distilled water with and without encapsulation of an acid precursor dodecane sulfonyl chloride in hydrolyzable NCs.

FIG. 20 shows a representation of a synthesis of solid hydrolyzable NPs using emulsion polymerization. Micellar nucleation occurs without sonication. Swollen micelles grow into particles. Droplets only serve as a monomer reservoir.

FIG. 21 shows a representation of solid hydrolyzable NPs undergoing retarded surfactant release via hydrolysis.

FIG. 22 shows hydrolysis rates of solid hydrolyzable NPs prepared from poly(vinyl laurate)/poly(vinyl acetate)(3:1 mole ratio) (PVL/PVA (3:1)) copolymers in varying NaOH concentrations for varying time (days).

FIG. 23 shows FTIR spectra of hydrolyzable NPs prepared from PVL/PVA (3:1) before and after hydrolysis, compared with sodium laurate (NaL).

FIGS. 24A-24B show hydrolysis of PVL/PVA (3:1) NPs: (FIG. 24A) SEM of pristine PVL/PVA NPs, (FIG. 24B) photographs of solutions after hydrolysis at t=2 days (d), t=4 d, or t=10 d. The scale bar for FIG. 24A corresponds to 200 nm.

FIGS. 25A-25C show contact angle changes for PVL/PVA (3:1) NPs hydrolyzed in 1N NaOH: (FIG. 25A) at t=0 days (d), (FIG. 25B) at t=3 d, (FIG. 25C) at t=30 d.

FIG. 26 show a schematic of different types of NPs. The charge of a decorating corona is placed at the end of a polymer (left) or distributed along a polyelectrolyte chain (right).

FIG. 27 shows a schematic showing a synthesis of the NPs.

FIGS. 28A-28D show SEM images of core NPs (FIGS. 28A-28B) and NPs with positively-charged polyelectrolyte brushes (“b-NPs(+)”) (FIGS. 28C-28D). The scale bars for FIGS. 28A and 28C correspond to 200 nm, while the scale bars for FIGS. 28B and 28D correspond to 20 nm.

FIGS. 29A-29D show confocal micrographs showing the assembly of positively-charged NPs at the oil-water interface. A red fluorescent dye has been added to all NPs while a blue fluorescent dye has been added to an oil for clarity. (FIG. 29A) core NPs in an oil-deionized (DI) water mixture. (FIG. 29B) core NPs in an oil-seawater mixture. (FIG. 29C) NPs decorated with positively-charged polyelectrolyte brushes in an oil-DI water mixture. (FIG. 29D) NPs decorated with positively-charged polyelectrolyte brushes in an oil-seawater mixture. The scale bars for FIGS. 29A-29D correspond to 50 μm.

FIG. 30 shows confocal micrographs showing attachment of NPs decorated with positively-charged polyelectrolyte brushes at an oil-high salinity water (HSW) interface at 22 d in high salinity water at 90° C. On the left, the scale bar corresponds to 50 μm, while on the right, the scale bar corresponds to 20 μm.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise stated, “about,” “approximately,” “substantially,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of +/−10% or less, +/−5% or less, +/−1% or less, and +/−0.1% or less of and from the specified value), insofar such variations are appropriate to perform in the context of the disclosure. As used herein, the terms “about,” “approximate,” “at or about,” and “substantially” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

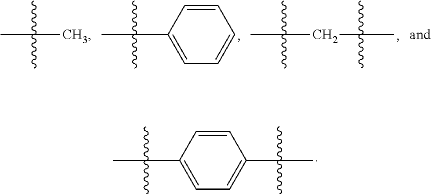

The present disclosure provides charged polymeric particles (e.g., nanoparticles, microparticles, or the like, or any combination thereof) and compositions thereof. The present disclosure also provides methods of making charged polymeric particles (e.g., nanoparticles, microparticles, or the like, or any combination thereof) and uses thereof.

This disclosure describes, inter alia, various examples of a system that combines into a single platform, both controlled assembly and targeted delivery. To that end, various examples of the design and fabrication of new charged polymeric particle systems (e.g., nanoparticle systems, microparticle systems, or the like, or any combination thereof) for the targeted and controlled release of additives (e.g., surfactants, surfactant precursors, or the like, or any combination thereof) is described. In various examples, the charged polymeric particles (e.g., nanoparticles, microparticles, or the like, or any combination thereof) are solid particles (e.g., nanoparticles, microparticles, or the like, or any combination thereof) or hollow particles (e.g. nanocapsules, microcapsules, or the like, or any combination thereof), and incorporate or consist of a hydrolyzable compound whose reaction product is a surfactant or a surfactant precursor. In various examples, the charged polymeric particles (e.g., nanoparticles, microparticles, or the like, or any combination thereof) are positively charged, which allows them to preferably attach to the negatively charged oil droplets in an oil reservoir and release the hydrolyzable compound adjacent to the oil. In various examples, the produced surfactant reduces the interfacial tension (IFT) and/or alter the wettability to enhance oil recovery.

In various examples, the present disclosure provides charged (e.g., positively charged or negatively charged) polymeric carriers (e.g., nanocarriers, microcarriers, or the like, or any combination thereof) such as, for example, solid particles (e.g., nanoparticles, microparticles, or the like, or any combination thereof) or hollow particles (e.g. nanocapsules, microcapsules, or the like, or any combination thereof) loaded with additives (e.g., surfactants and/or surfactant precursors, or the like, or any combination thereof). In various examples, using their positive surface charge, the charged polymeric carriers can selectively and preferentially attach to oil droplets. In various examples, after attachment, they can slowly release their cargo greatly improving local surfactant concentration around oil droplets and meanwhile minimizing surfactant dilution, loss by adsorption and/or degradation.

In various examples, the charged polymeric particles (e.g., nanoparticles, microparticles, or the like, or any combination thereof) and the charged polymeric carriers (e.g., nanocarriers, microcarriers, or the like, or any combination thereof) of the present disclosure combine targeted and slow release of surfactants and/or surfactant precursors.

Approaches described in the present disclosure are expected to provide high efficiency oil recovery since it addresses various challenges of surfactant injection, such as, for example, surfactant dilution during transport, loss by adsorption on the mineral in the reservoir, potential early degradation under harsh reservoir conditions, or the like, or a combination thereof.

In an aspect, the present disclosure provides charged polymeric particles (e.g., nanoparticles, microparticles, or the like, or any combination thereof). A charged polymeric particle (e.g., nanoparticle, microparticle, or the like, or any combination thereof) may be referred to in the alternative as a charged polymeric carrier (e.g., nanocarrier, microcarrier, or the like, or any combination thereof). Non-limiting examples of the charged polymeric particles (e.g., nanoparticles, microparticles, or the like, or any combination thereof) are provided herein.

In various examples, charged polymeric particles (e.g., nanoparticles, microparticles, or the like, or any combination thereof) comprise one or more additive(s) (e.g., surfactant(s), surfactant precursor(s), hydrolysable compound(s), or the like, or any combination thereof). In various examples, the charged polymeric particles (e.g., nanoparticles, microparticles, or the like, or any combination thereof) are hollow particles (e.g., nanocapsules, microcapsules, or the like, or any combination thereof) or solid particles (e.g., nanoparticles, microparticles, or the like, or any combination thereof). The charged polymeric particles (e.g., nanoparticles, microparticles, or the like, or any combination thereof) are referred to herein, in various examples, as targeted delivery particles. In various examples, a charged polymeric particle (e.g., nanoparticle, microparticle, or the like) is made by a method of the present disclosure.

In various examples, the surface charge of a charged polymeric particle (e.g., nano particle, micro particle, or the like) is tuned using emulsifiers, monomers and functional comonomers. In various examples, a positive surface charge is introduced using cationic surfactants, monomers and/or comonomers containing positively charged functionalities or precursors of the positively charged functionalities (e.g., functional groups) including, but not limited to, amines, pyridines, imidazoles, guanidines, sulfonium, ammonium, phosphonium, boronium, and the like.

A charged polymeric particle (e.g., a nanoparticle, a microparticle, or the like) can comprise various internal structures. In various examples, a charged polymeric particle (e.g., nanoparticle, microparticle, or the like) is a capsule (e.g., nanocapsule, microcapsule, or the like). In various examples, a capsule (e.g., nanocapsule, microcapsule, or the like) comprises a polymeric shell (e.g., nanoshell, microshell, or the like) defining a spherical space. In various examples, a polymeric shell (e.g., nanoshell, microshell, or the like) is continuous and/or has no defects that connect (e.g., provide fluid contact with or the like) a spherical space with an exterior environment of a charged polymeric particle (e.g. nanoparticle, microparticle, or the like). In various examples, a spherical space comprises an aqueous medium or a non-aqueous medium (e.g., hydrophobic medium, oil medium, or the like). In various examples, a charged polymeric particle (e.g., nanoparticle, microparticle, or the like) is a solid particle (e.g., nanoparticle, microparticle, or the like).

In various examples, a polymeric shell (e.g., nanoshell, microshell, or the like) or a solid particle (e.g., nanoparticle, microparticle, or the like) comprises one or more polymeric material(s). In various examples, a polymeric shell (e.g., nanoshell, microshell, or the like) or a solid particle (e.g., nanoparticle, microparticle, or the like) further comprises one or more additive(s) disposed in the polymeric material(s) and/or the spherical space. In various examples, additive(s) comprise(s) one or more surfactant(s), one or more surfactant precursor(s), or the like, or any combination thereof.

A charged polymeric particle (e.g., nanoparticle, microparticle, or the like) can comprise various polymeric material(s) comprising various inter- and/or intra-molecular bonds. In various examples, the polymeric material(s) is/are not crosslinked and/or not complexed.

A charged polymeric particle (e.g., nanoparticle, microparticle, or the like) can comprise various charge types. In various examples, one or more or all portion(s) of an outer surface of a charged polymeric particle (e.g., nanoparticle, microparticle, or the like) comprise(s), for example, on average, a charge (e.g., positive charge or negative charge). In various examples, one average, one or more or all portion(s) of an outer surface of a charged polymeric particle (e.g., nanoparticle, microparticle, or the like) comprise(s) a positive charge.

In various examples, a charged polymeric particle (e.g., nanoparticle, microparticle, or the like) is a capsule (e.g., nanocapsule, microcapsule or the like) comprising a polymeric shell (e.g., nanoshell, microshell, or the like) defining a spherical space, where a polymeric shell (e.g., nanoshell, microshell, or the like) comprises one or more polymeric material(s) and one or more surfactant(s), one or more surfactant precursor(s), or a combination thereof disposed in a polymeric material(s) and/or a spherical space; or a solid particle (e.g., nanoparticle, microparticle, or the like) comprising one or more polymeric material(s) and one or more surfactant(s), one or more surfactant precursor(s), or a combination thereof disposed in the polymeric material(s), where one or more or all portion(s) of an outer surface of a charged polymeric particle (e.g., nanoparticle, microparticle, or the like) is/are positively charged. Optionally, the polymeric material(s) is/are not crosslinked and/or not complexed.

A charged polymeric particle (e.g., a nanoparticle, a microparticle, or the like) can comprise various types of charge. In various examples, one or more or all portion(s) of an outer surface of a charged polymeric particle (e.g., nanoparticle, microparticle, or the like) has/have, for example, on average, a static charge or a non-static charge. In various examples, a charged polymeric particle (e.g., nanoparticle, microparticle, or the like) has, for example, on average, a static positive charge or a non-static positive charge, such as, for example, a partial positive charge or a coulombic charge (e.g., resulting from dipolar interactions or the like).

In various examples, one or more or all portion(s) of an outer surface of a charged polymeric particle (e.g., nanoparticle, microparticle, or the like) has/have, for example, on average, an inducible charge depending upon external conditions (e.g., pH or salt concentration). In various examples, under certain external conditions, one or more or all portion(s) of an outer surface of a polymeric particle (e.g., nanoparticle, microparticle, or the like) has/have, for example, on average, an inducible positive charge.

A charged polymeric particle (e.g., nanoparticle, microparticle, or the like) can comprise various charged groups. In various examples, a charge is dependent on external conditions (e.g., an inducible charged group). In various examples, a charge is pH dependent, salt concentration dependent, or the like, or any combination thereof.

In various examples, a charged polymeric particle (e.g., nanoparticle, microparticle, or the like) has, for example, on average, a plurality of positively charged groups including but not limited to ammonium groups, phosphonium groups, and the like, and any combinations thereof. In various examples, positively charged groups is/are chosen from cationic surfactants, cationic monomers, cationic comonomers, and the like, and any combination thereof. In various examples, positively charged groups comprise positively charged functionalities, precursors of positively charged functionalities, or the like, or any combination thereof, including but not limited to, amines, pyridines, imidazoles, guanidines, sulfonium, ammonium, phosphonium, boronium, and the like, and any combination thereof.

A charged polymeric particle (e.g., nanoparticle, microparticle, or the like) can have various colloidal stability values. In various examples, a charged polymeric particle (e.g., nanoparticle, microparticle, or the like) comprises, for example, on average, a positive zeta potential in distilled and/or deionized water. In various examples, a charged polymeric particle (e.g., nanoparticle, microparticle, or the like) comprises, for example, on average, a zeta potential in distilled and/or deionized water of about 10 millivolts (mV) or greater (e.g., from about 10 millivolts (mV) to about 70 mV, including all 0.1 mV values and ranges therebetween). In various examples, one or more or all portion(s) of an outer surface of a charged polymeric particle (e.g., nanoparticle, microparticle, or the like) has/have, for example, on average, a zeta potential in distilled and/or deionized water of from about 10 millivolts (mV) to about 70 mV, including all 0.1 mV values and ranges therebetween.

A charged polymeric particle (e.g., nanoparticle, microparticle, or the like) can comprise various shapes and sizes. In various examples, a charged polymeric particle (e.g., nanoparticle, microparticle, or the like) is, for example, on average, spherical (e.g., a nanosphere, a microsphere, or the like). In various examples, a charged polymeric particle is, for example, on average, a charged polymeric nanoparticle, a charged polymeric microparticle, or the like. In various examples, a charged polymeric particle (e.g., nanoparticle, microparticle, or the like) has a longest linear dimension, such as, for example, a diameter of, for example, on average, from about 5 nm to about 2.5 microns (e.g., from about 2 nm to about 200 nm, from about 2 to about 500 nm, or from about 2 nm to about 1 micron), including all 0.1 nm values and ranges therebetween. In various examples, a charged polymeric particle has a longest linear dimension, such as, for example, a diameter of, for example, on average, from about 1 nm to about 50 microns (e.g., from about 2 nm to 200 nm, from about 2 nm to about 500 nm, 2 nm to about 700 nm, from about 2 nm to 1 micron, from about 5 nm to about 2.5 microns, from about 1 micron to about 2.5 microns, from about 1 micron to about 10 microns, from about 1 micron to about 25 microns, or from about 1 micron to about 50 microns), including all 0.1 nm values and ranges therebetween.

In various examples, a charged polymeric particle is, for example, on average, a charged polymeric nanoparticle. In various examples, a charged polymeric nanoparticle has, for example, on average, a longest linear dimension (e.g., width, such as, for example, diameter) of, for example, on average, at least about 1 nanometer (nm) to about 1 micron (e.g., from about 2 nm to about 200 nm, from about 2 nm to about 500 nm, from about 2 nm to about 700 nm, or from about 2 nm to about 1 micron), including all 0.1 nm values and ranges therebetween.

In various examples, a charged polymeric particle is, for example, on average, a charged polymeric microparticle. In various examples, a charged polymeric microparticle has a size (e.g., longest linear dimension, such as, for example, diameter) of, for example, on average, of from about 1 micron to about 50 microns (e.g., from about 1 micron to about 2.5 microns from about 1 micron to about 10 microns, from about 1 micron to about 25 microns, or from about 1 micron to about 50 microns), including all 0.1 micron values and ranges therebetween.

In various examples, a polymeric shell is, for example, on average, a polymeric nanoshell, a polymeric microshell, or the like. In various examples, a polymeric shell has a thickness of, for example, on average, from about 2 nm or greater (e.g., from about 2 nm to about 1 micron (e.g., from about 2 nm to about 500 nm, or from about 2 nm to about 100 nm)), including all 0.1 nm values and ranges therebetween. In various examples, a polymeric shell has a thickness of, for example, on average, from about 2 nm to about 25 microns (e.g., from about 2 nm to about 1 micron, from about 5 nm to about 2.5 microns, from about 1 micron to about 2.5 microns, from about 1 micron to about 10 microns, from about 1 micron to about 25 microns), including all 0.1 nm values and ranges therebetween.

In various examples, a polymeric shell is, for example, on average, a polymeric nanoshell. In various examples, a polymeric shell has a thickness of, for example, on average, from about 2 nm to about 1 micron (e.g. from about 2 nm to about 100 nm, from about 2 nm to about 500 nm), including all 0.1 nm values and ranges therebetween.

In various examples, a polymeric shell is, for example, on average, a polymeric microshell. In various examples, a polymeric shell has a thickness of, for example, on average, from about 1 micron to about 25 microns, (e.g., from about 1 micron to about 2.5 microns, from about 1 micron to about 10 microns, from about 1 micron to about 25 microns), including all 0.1 micron values and ranges therebetween.

A charged polymeric particle (e.g., nanoparticle, microparticle, or the like) can comprise various polymeric material(s). In various examples, the polymeric material(s) comprise(s) (e.g., is/are) one or more polymer(s), one or more co-polymer(s), or the like, or any combination thereof. In various examples, a solid particle (e.g., a nanoparticle, a microparticle, or the like) or a polymeric shell (e.g., a nanoshell, a microshell, or the like) comprises (e.g., is) one or more polymeric material(s) comprising one or more polymer(s), one or more co-polymer(s), or a combination thereof.

A charged polymeric particle can comprise one or more polymeric material(s) subject to various degrees of hydrolysis. In various examples, the polymeric material(s) comprise(s) one or more hydrolyzable polymeric material(s), one or more non-hydrolyzable polymeric material(s), a copolymer thereof, or the like, or any combination thereof. In various examples, a solid particle (e.g., a nanoparticle, a microparticle, or the like) or a polymeric shell (e.g., a nanoshell, a microshell, or the like) comprises (e.g., is) one or more hydrolyzable polymeric material(s).

In various examples, the hydrolyzable polymeric material(s) is/are hydrolyzable, such that hydrolysis results in release of at least a portion of or all of the contents of the charged polymeric particle (e.g., nanoparticle, microparticle, or the like). In various examples, a solid nanoparticle (e.g., nanoparticle, microparticle, or the like) or a polymeric shell (e.g., nanoshell, microshell, or the like) comprises one or more hydrolysable polymeric material(s) which is/are hydrolyzable, such that hydrolysis results in release of at least a portion of or all of the contents of the polymeric material(s) and/or spherical space.

In various examples, one or more hydrolyzable polymeric material(s) are crosslinked and/or complexed. In various examples, the rate of hydrolysis of hydrolyzable polymeric material(s) is tunable by the degree of crosslinking and/or complexation of hydrolyzable polymeric material(s).

In various examples, one or more hydrolyzable polymeric material(s) comprise(s) (e.g., is/are) polymer(s), co-polymer(s), or the like, or any combination thereof one or more or all of which are hydrolyzable. In various examples, one or more polymeric material(s) comprise(s) one or more hydrolyzable polymer(s). In various examples, a solid particle or a polymeric shell comprise polymeric material(s) which comprise(s) one or more hydrolyzable polymer(s). In various examples, the hydrolyzable polymeric material(s) comprise(s) (e.g., is/are) copolymer(s) comprising hydrolyzable polymer(s) and non-hydrolyzable polymer(s). In various examples, a solid particle (e.g., a nanoparticle, a microparticle, or the like) or a polymeric shell (e.g., a nanoshell, a microshell, or the like) comprise one or more hydrolyzable polymeric material(s) which comprise(s) (e.g., is/are) copolymer(s) comprising the hydrolyzable polymer(s) and the non-hydrolyzable polymer(s). In various examples, the polymeric material(s) is/are mixture(s) of one or more hydrolyzable polymeric material(s) (e.g., hydrolyzable polymer(s), or the like, or any combination thereof) and one or more non-hydrolyzable polymeric material(s) (e.g., non-hydrolyzable polymer(s), or the like, or any combination thereof). In various examples, a solid particle (e.g., a nanoparticle, a microparticle, or the like) or a polymeric shell (e.g., a nanoshell, a microshell, or the like) comprise polymeric material(s) which is/are mixture(s) of hydrolyzable polymeric material(s) (e.g., hydrolyzable polymer(s), or the like, or any combination thereof) and non-hydrolyzable polymeric material(s) (e.g., non-hydrolyzable polymer(s), or the like, or any combination thereof).

In various examples, polymeric material(s) comprise(s) one or more hydrolyzable polymeric material(s), one or more non-hydrolyzable polymeric material(s), a copolymer thereof, or a combination thereof, and where: hydrolyzable polymeric material(s) comprise(s) one or more hydrolyzable polymer(s), one or more hydrolyzable copolymer(s) thereof, or a combination thereof; and/or the non-hydrolyzable polymeric material(s) comprise(s) one or more non-hydrolyzable polymer(s), one or more non-hydrolyzable copolymer(s) thereof, or a combination thereof.

In various examples, the hydrolyzable polymeric material(s) is/are chosen from polyesters, polyamines, polyureas, polyurethanes, polycarbonates, polyamides, polyimides, polyanhydrides, polythioesters, polysulfonylureas, polysulfonylamides, and polysiloxanes, polyaryl halides, polyalkyl halides, copolymers thereof, and combinations thereof.

In various examples, the non-hydrolyzable polymeric material(s) is/are chosen from polystyrene, polyvinyl alcohol, polyether, polyethylene, polypropylene, copolymers thereof, and combinations thereof.

In various examples, the hydrolyzable polymeric material(s) (e.g., hydrolyzable polymer(s), hydrolyzable copolymer(s), or the like, or any combination thereof) comprise(s) one or more hydrolyzable group(s). In various examples, the hydrolyzable group(s) are pendant from and/or within a polymer backbone of the hydrolyzable polymeric material(s).

In various examples, the hydrolyzable groups include, but are not limited to, ester groups, urea groups, urethane groups, carbonate groups, amide groups, imide groups, anhydride groups, thioester groups, sulfonylurea groups, sulfonylamide groups, silyloxy groups, aryl halide groups, alkyl halides groups, and the like, and any combination thereof.

In various examples, the hydrolyzable polymeric material(s) each comprise one or more hydrolyzable group(s), and where, for each hydrolyzable polymeric material, the hydrolyzable group(s) are independently chosen from ester groups, urea groups, urethane groups, carbonate groups, amide groups, imide groups, anhydride groups, thioester groups, sulfonylurea groups, sulfonylamide groups, silyloxy groups, aryl halides, alkyl halides, and combinations thereof.

In various examples, a solid particle (e.g., nanoparticle, microparticle, or the like), a polymeric shell (e.g., nanoshell, microshell, or the like), or a portion thereof comprise one or more hydrolyzable polymeric material(s) which react(s) (e.g., hydrolyze, decompose, or the like) to provide one or more product(s) (e.g., one or more surfactant(s), one or more surfactant precursor(s), or the like, or a combination thereof), one or more or all of which have surfactant properties or the ability to have surfactant properties (e.g., depending on pH, salt concentration, temperature, pressure, or the like, or a combination thereof). In various examples, such a solid particle (e.g., nanoparticle, microparticle, or the like) is referred to as a surfactant solid particle (e.g., nanoparticle, microparticle, or the like) and such a polymeric shell (e.g., nanoshell, microshell, or the like) is referred to as a surfactant polymeric shell (e.g., nanoshell, microshell, or the like).

In various examples, one or more hydrolyzable polymeric material(s) comprise(s) sufficient hydrolyzable polymer(s) such that the charged polymeric particle (e.g., nanoparticle, microparticle, or the like) hydrolyzes and releases a desirable amount of surfactant(s) and/or surfactant precursor(s).

In various examples, one or more hydrolyzable polymeric material(s) (e.g., polymer(s), copolymer(s), or the like, or any combination thereof) are present in a solid particle (e.g., nanoparticle, microparticle, or the like) or in a polymeric shell (e.g., nanoshell, microshell, or the like) at, for example, on average, about 0.1 weight percent (wt. %) or greater (e.g., from about 0.1 wt. % to about 99.9 wt. %, including all 0.01% values and ranges therebetween), at about 1 wt. % or greater (e.g., from about 1 wt. % to about 99.9 wt. %, including all 0.01% values and ranges therebetween), at about 5 wt. % or greater (e.g., from about 5 wt. % to about 99.9 wt. %, including all 0.01% values and ranges therebetween), or at about 10 wt. % or greater (e.g., from about 0.1 wt. % to about 99.9 wt. %, including all 0.01% values and ranges therebetween), based on the total weight of the charged polymeric particle (e.g., a nanoparticle, a microparticle, or the like) or based on the total weight of the polymeric material(s).

A charged polymeric particle (e.g., a nanoparticle, a microparticle, or the like) can comprise various surfactant(s). As used herein, a surfactant is an organic compound that is amphiphilic, meaning containing one or more hydrophobic group(s) and one or more hydrophilic group(s). As used herein, one or more cationic surfactant(s) comprise(s) one or more cationic hydrophilic group(s), one or more anionic surfactant(s) comprise one or more anionic hydrophilic group(s), one or more nonionic surfactant(s) comprise one or more nonionic hydrophilic group(s), and one or more zwitterionic surfactant(s) comprise one or more cationic groups and one or more anionic groups per zwitterionic surfactant. In various examples, the surfactant(s) has/have surfactant properties depending upon the external environment (e.g., depending on pH, salt concentration, temperature, pressure, or the like, or a combination thereof).

In various examples, the surfactant(s) is/are chosen from cationic surfactant(s), anionic surfactant(s), nonionic surfactant(s), zwitterionic surfactant(s), and the like, and combinations thereof. In various examples, the surfactant(s) is/are polymeric surfactant(s). In various examples, the surfactant(s) in the polymeric material(s) and/or the spherical space, which are optionally encapsulated surfactant(s), are surfactant(s) chosen from cationic surfactant(s), anionic surfactant(s), nonionic surfactant(s), zwitterionic surfactant(s), and the like, and any combination thereof, where any one or a portion of, or all of which is/are chosen from non-polymeric surfactant(s) (e.g., low molecular weight surfactant(s)), polymeric surfactant(s), and the like, and any combination thereof. In various examples, a non-polymeric surfactant is a molecular surfactant.

In various examples, the cationic surfactant(s) is/are chosen from alkyl ammonium surfactant(s), aryl ammonium surfactant(s), alkyl phosphonium surfactant(s), aryl phosphonium surfactant(s), alkyl sulfonium surfactant(s), aryl sulfonium surfactant(s), polyquaternium surfactant(s), and the like, and any combination thereof. In various examples, cationic surfactant(s) is/are chosen from hexadecyltrimethylammonium bromide, cetylpyridinium chloride, tributyltetradecyl phosphonium chloride, tributylhexadecyl phosphonium bromide, 1-hexadecyl-3-methylimidazolium chloride, and the like, and any combination thereof.

In various examples, the anionic surfactant(s) is/are chosen from carboxylate salt(s), sulfonate salt(s), phosphate salt(s), and the like, and combinations thereof.

In various examples, the nonionic surfactant(s) is/are chosen from fatty alcohol alkoxylate(s) (e.g., fatty alcohol ethoxylate(s), and the like, and any combination thereof), fatty acid alkoxylate(s) (e.g., fatty acid ethoxylate(s), and the like, and any combination thereof), alkyl phenol alkoxylate(s) (e.g., alkyl phenol ethoxylate(s), and the like and any combination thereof), fatty acid alkanolamide(s), alkylamine oxide(s), alkyl polyglucoside(s), and the like, and any combination thereof.

In various examples, the surfactant(s) is/are present at, for example, on average, from about 0.1 wt. % to about 60 wt. %, including all 0.01 wt. % values and ranges therebetween, based on the total weight of the charged polymeric particle (e.g., nanoparticle, microparticle, or the like).

A charged polymeric particle (e.g., nanoparticle, microparticle, or the like) can comprise various surfactant precursor(s).

In various examples, a surfactant precursor can react (e.g., undergo an ion exchange reaction, decompose, protonation reaction, or the like) to provide one or more product(s) with surfactant properties (e.g., one or more surfactant(s)) or the ability to have surfactant properties depending upon the external environment (e.g., depending on pH, salt concentration, temperature, pressure, or the like, or a combination thereof).

In various example, one or more or all portion(s) of hydrolyzable polymeric material(s) is/are surfactant precursor(s). In various examples, the hydrolyzable polymeric material(s) hydrolyze(s) to provide one or more carboxylic acid material(s), one or more sulfonic acid material(s), one or more phosphoric acid material(s), or the like, or any combination thereof which is/are optionally surfactant(s) and/or surfactant precursor(s). In various examples, the hydrolyzable polymeric material(s) hydrolyze(s) to provide surfactant precursor(s), that, under certain conditions, forms a carboxylate material, a sulfonate material, a phosphate material, the like, or any combination thereof which is/are optionally surfactant(s).

In various examples, carboxylic acid material(s) comprise(s) carboxylic acid(s), carboxylate salts thereof (e.g., sodium carboxylate salts, calcium carboxylate salts, or the like, or any combination thereof), carboxylic acid derivatives thereof, or the like, or any combination thereof. In various examples, the carboxylic acid material(s) comprise C₆-C₂₂ (e.g., C₆-C₂₀, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C_{22,} or the like, or any combination thereof) alkyl groups, including all integer number of carbon and ranges therebetween, or the like, or any combination thereof.

In various examples, the surfactant precursor(s) are chosen from carboxylic acid precursor(s) including but not limited to carboxylic acid derivative(s). In various examples, the carboxylic acid derivative(s) include but are not limited to carboxylic ester(s), amide(s), peptide(s), thioester(s), acylphosphate(s), lactone(s), lactam(s), acid chloride(s), acid anhydride(s), and the like, and any combination thereof.

In various examples, the sulfonic acid material(s) comprise(s) sulfonic acid(s), sulfonate salts thereof (e.g., sodium sulfonate salts, calcium sulfonate salts, or the like, or any combination thereof), sulfonate derivatives thereof, thionyl chloride(s) thereof, or the like, or any combination thereof. In various examples, the sulfonic acid material(s) comprise C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, or the like, or any combination thereof.

In various examples, the surfactant precursor(s) include sulfonic acid precursor(s) including but not limited to sulfonic acid derivative(s). In various examples, the sulfonic acid derivative(s) include but are not limited to thionyl halide(s), sulfonic ester(s), and sulfonamide(s). In various examples, the sulfonic acid derivative(s) are thionyl halide(s) having the formula R—S(O)₂—X, where R is a C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, and X is a halide, carboxyl halide, carbamoyl halide, alkyloxy silane, or the like, or any combination thereof.

In various examples, the surfactant precursor(s) comprise(s) one or more C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, or a polymer, which optionally comprise(s) one or more pendant thionyl chloride group(s).

In various examples, the surfactant precursor(s) is/are chosen from esters, halides, carboxylic acids, sulfonic acids, phosphoric acids, and combinations thereof.

In various examples, the surfactant precursor(s) of a charged polymeric particle is/are present at, for example, on average, from about 10 wt. % to about 90 wt. %, including all 0.1 wt. % values and ranges therebetween, based on the total weight of a charged polymeric particle (e.g., nanoparticle, microparticle, or the like).

A charged polymeric particle (e.g., nanoparticle, microparticle, or the like) can comprise various charged groups.

In various examples, one or more or all portion(s) of an outer surface of a charged polymeric particle (e.g., nanoparticle, microparticle, or the like) comprise(s) a plurality of charged groups. In various examples, one or more polymeric material(s) comprise(s) a plurality of positively charged groups disposed on one or more or all portion(s) of an outer surface of a charged polymer particle (e.g., nanoparticle, microparticle, or the like). In various examples, one or more or all of positively charged group(s) is/are within and/or pendant from one or more backbone(s) of polymeric material(s).

In various examples, the charged polymeric particle(s) (e.g., nanoparticle(s), microparticle(s), or the like, or any combination thereof) further comprise one or more additive(s). Non-limiting examples of additive(s) include emulsifier(s), or the like, or any combination thereof.

In an aspect, the present disclosure provides a brush polymeric particle (e.g., a nanoparticle, a microparticle, or the like) comprising one or more polymer brush(es). A brush polymeric particle (e.g., nanoparticle, microparticle, or the like, or any combination thereof) may be referred to in the alternative as a brush polymeric carrier (e.g., nanocarrier, microcarrier, or the like, or any combination thereof). Non-limiting examples of brush polymeric particles (e.g., nanoparticles, microparticles, or the like, or any combination thereof) are provided herein.

A brush polymeric particle (e.g., a nanoparticle, a microparticle, or the like) can comprise various types of polymer brush(es) at various portion(s) of a brush polymeric particle (e.g., a nanoparticle, a microparticle, or the like). In various examples, the polymer brush(es) is/are polymer chains disposed on (e.g., tethered to) one or more or all portion(s) of an outer surface of a brush polymeric particle (e.g., a nanoparticle, a microparticle, or the like). In various examples, the polymer brush(es) is/are charged and/or neutral polyelectrolyte brush(es). In various examples, the polymer brush(es) are nonionic polymer brush(es).

In various examples, one or more polyelectrolyte brush(es) is/are disposed on one or more or all portion(s) of an outer surface of a brush polymeric particle (e.g., nanoparticle, microparticle, or the like). In various examples, one or more polyelectrolyte brush(es) comprise(s) a plurality of positively charged groups. In various examples, one or more or all of positively charged group(s) is/are within and/or pendant from one or more backbone(s) of the polyelectrolyte brush(es). In various examples, the polyelectrolyte brush(es) disposed on one or more or all portion(s) of an outer surface of a brush polymeric particle (e.g., nanoparticle, microparticle, or the like) is/are present at, for example, on average, about 0.1 wt. % or greater (e.g., from about 0.1 wt. % to about 99.9 wt. %, including all 0.01 wt. % values and ranges therebetween), based on the total weight of the brush polymeric particle (e.g., nanoparticle, microparticle, or the like).

In various examples, each polymer brush independently comprises a plurality of groups chosen from positively charged groups, negatively charged groups, zwitterionic groups, nonionic groups, and the like, and any combination thereof. In various examples, the plurality of groups are disposed at least on at least a portion of the length of each polymer chain of a polymer brush. In various examples, the plurality of groups are not disposed (e.g., not solely disposed) on the end of a linker, such as, for example, a monomer, a polymer, or the like disposed on an outer surface of a brush polymeric particle.

A brush polymeric particle (e.g., a nanoparticle, a microparticle, or the like) can comprise various internal structures. In various examples, a brush polymeric particle (e.g., a nanoparticle, a microparticle, or the like) comprises one or more polymer brush(es) disposed on an exterior surface of a solid particle (e.g., a nanoparticle, a microparticle, or the like) or a capsule (e.g., a nanocapsule, a microcapsule, or the like) comprising a polymeric shell (e.g., a nanoshell, a microshell, or the like) defining a spherical space. In various examples, a polymeric shell (e.g., nanoshell, microshell, or the like) is continuous and/or has no defects that connect (e.g., provide fluid contact with or the like) a spherical space with an exterior environment of a brush polymeric particle (e.g. nanoparticle, microparticle, or the like). In various examples, a spherical space comprises an aqueous medium or a non-aqueous medium (e.g., hydrophobic medium, oil medium, or the like).

A brush polymeric particle (e.g., a nanoparticle, a microparticle, or the like) can comprise various charges disposed at various portion(s) of a brush polymeric particle (e.g., a nanoparticle, a microparticle, or the like). In various examples, one or more or all portion(s) of an outer surface of a brush polymeric particle (e.g., a nanoparticle, a microparticle, or the like) is/are positively charged such as, for example, with a static positive charge or a non-static positive charge. In various examples, one or more polymeric brush(es) and/or a solid particle (e.g., a nanoparticle, a microparticle, or the like) or a capsule (e.g., a nanocapsule, a microcapsule, or the like) upon which the polymeric brush(es) is/are disposed comprise(s) a charge. In various examples, the polymeric brush(es) and a solid particle (e.g., a nanoparticle, a microparticle, or the like) or a capsule (e.g., a nanocapsule, a microcapsule, or the like) upon which the polymeric brush(es) is/are disposed comprise(s) a same or a different charge.

In various examples, a solid particle (e.g., a nanoparticle, a microparticle, or the like) or a polymeric shell (e.g., a nanoshell, a microshell, or the like) of a brush polymeric particle (e.g., a nanoshell, a microshell, or the like) comprises one or more polymeric material(s). In various examples, a solid particle (e.g., a nanoshell, a microshell, or the like) or a polymeric shell e.g., a nanoshell, a microshell, or the like) of a brush polymeric particle (e.g., a nanoshell, a microshell, or the like) further comprises one or more additive(s). In various examples, additive(s) of a brush polymeric particle (e.g., a nanoparticle, a microparticle, or the like) comprise one or more surfactant(s), one or more surfactant precursor(s), or the like, or any combination thereof disposed in the polymeric material(s) and/or the spherical space. In various examples, the polymeric material(s) of a brush polymeric particle (e.g., a nanoparticle, a microparticle, or the like) is/are not crosslinked and/or not complexed.

In various examples, a brush polymeric particle (e.g., nanoparticle, microparticle, or the like) is a capsule (e.g., nanocapsule, microcapsule or the like) comprising a polymeric shell (e.g., nanoshell, microshell, or the like) defining a spherical space, where a polymeric shell (e.g., nanoshell, microshell, or the like) comprises one or more polymeric material(s) and one or more surfactant(s), one or more surfactant precursor(s), or a combination thereof disposed in a polymeric material(s) and/or a spherical space; or a solid particle (e.g., nanoparticle, microparticle, or the like) comprising one or more polymeric material(s) and one or more surfactant(s), one or more surfactant precursor(s), or a combination thereof disposed in the polymeric material(s), where one or more or all portion(s) of an outer surface of a brush polymeric particle (e.g., nanoparticle, microparticle, or the like) comprise(s) a positive charge.

A brush polymeric particle (e.g., nanoparticle, microparticle, or the like) can comprise various shapes and sizes. In various examples, a brush polymeric particle (e.g., nanoparticle, microparticle, or the like) is, for example, on average, spherical (e.g., a nanosphere, a microsphere, or the like). In various examples, a brush polymeric particle is, for example, on average, a brush polymeric nanoparticle, a brush polymeric microparticle, or the like. In various examples, a brush polymeric particle (e.g., nanoparticle, microparticle, or the like) has a longest linear dimension, such as, for example, a diameter of, for example, on average, from about 5 nm to about 2.5 microns (e.g., from about 2 nm to about 200 nm, from about 2 to about 500 nm, or from about 2 nm to about 1 micron), including all 0.1 nm values and ranges therebetween. In various examples, a brush polymeric particle has a longest linear dimension, such as, for example, a diameter of, for example, on average, from about 1 nm to about 50 microns (e.g., from about 2 nm to 200 nm, from about 2 nm to about 500 nm, 2 nm to about 700 nm, from about 2 nm to 1 micron, from about 5 nm to about 2.5 microns, from about 1 micron to about 2.5 microns, from about 1 micron to about 10 microns, from about 1 micron to about 25 microns, or from about 1 micron to about 50 microns), including all 0.1 nm values and ranges therebetween.

In various examples, a brush polymeric particle is, for example, on average, a brush polymeric nanoparticle. In various examples, a brush polymeric nanoparticle has, for example, on average, a longest linear dimension (e.g., width, such as, for example, diameter) of, for example, on average, at least about 1 nanometer (nm) to about 1 micron (e.g., from about 2 nm to about 200 nm, from about 2 nm to about 500 nm, from about 2 nm to about 700 nm, or from about 2 nm to about 1 micron), including all 0.1 nm values and ranges therebetween.

In various examples, a brush polymeric particle is, for example, on average, a brush polymeric microparticle. In various examples, a brush polymeric microparticle has a size (e.g., longest linear dimension, such as, for example, diameter) of, for example, on average, of from about 1 micron to about 50 microns (e.g., from about 1 micron to about 2.5 microns from about 1 micron to about 10 microns, from about 1 micron to about 25 microns, or from about 1 micron to about 50 microns), including all 0.1 micron values and ranges therebetween.

In various examples, a polymeric shell is, for example, on average, a polymeric nanoshell, a polymeric microshell, or the like. In various examples, a polymeric shell has a thickness of, for example, on average, from about 2 nm or greater (e.g., from about 2 nm to about 1 micron (e.g., from about 2 nm to about 500 nm, or from about 2 nm to about 100 nm)), including all 0.1 nm values and ranges therebetween. In various examples, a polymeric shell has a thickness of, for example, on average, from about 2 nm to about 25 microns (e.g., from about 2 nm to about 1 micron, from about 5 nm to about 2.5 microns, from about 1 micron to about 2.5 microns, from about 1 micron to about 10 microns, from about 1 micron to about 25 microns), including all 0.1 nm values and ranges therebetween.

In various examples, a polymeric shell is, for example, on average, a polymeric nanoshell. In various examples, a polymeric shell has a thickness of, for example, on average, from about 2 nm to about 1 micron (e.g. from about 2 nm to about 100 nm, from about 2 nm to about 500 nm), including all 0.1 nm values and ranges therebetween.

In various examples, a polymeric shell is, for example, on average, a polymeric microshell. In various examples, a polymeric shell has a thickness of, for example, on average, from about 1 micron to about 25 microns, (e.g., from about 1 micron to about 2.5 microns, from about 1 micron to about 10 microns, from about 1 micron to about 25 microns), including all 0.1 micron values and ranges therebetween.

A brush polymeric particle (e.g., a nanoparticle, a microparticle, or the like) can comprise various polymeric material(s). In various examples, polymeric material(s) comprise(s) (e.g., is/are) one or more polymer(s), one or more co-polymer(s), or the like, or any combination thereof. In various examples, one or more polymeric brush(es) and/or a solid particle (e.g., a nanoparticle, a microparticle, or the like) or a polymeric shell (e.g., a nanoshell, a microshell, or the like) upon which the polymeric brush(es) is/are disposed compris(es) (e.g., is/are) one or more polymeric material(s) comprising one or more polymer(s), one or more co-polymer(s), or a combination thereof. In various examples, one or more polymeric brush(es) and a solid particle (e.g., a nanoparticle, a microparticle, or the like) or a capsule (e.g., a nanocapsule, a microcapsule, or the like) upon which the polymeric brush(es) is/are disposed comprise(s) the same or different polymeric material(s).

A brush polymeric particle (e.g., a nanoparticle, a microparticle, or the like) can comprise one or more polymeric material(s) subject to various degrees of hydrolysis. In various examples, the polymeric material(s) comprise(s) one or more hydrolyzable polymeric material(s), one or more non-hydrolyzable polymeric material(s), a copolymer thereof, or the like, or any combination thereof. In various examples, a solid particle (e.g., a nanoparticle, a microparticle, or the like) or a polymeric shell (e.g., a nanoshell, a microshell, or the like) comprises (e.g., is) one or more hydrolyzable polymeric material(s). In various examples, one or more polymeric brush(es) comprise one or more non-hydrolyzable polymeric material(s), a copolymer thereof, or the like, or any combination thereof. In various examples, a solid particle (e.g., a nanoparticle, a microparticle, or the like) or capsule (e.g., a nanocapsule, a microcapsule, or the like) of a brush polymeric particle (e.g., nanoparticle, microparticle, or the like) comprise(s) one or more hydrolyzable polymeric material(s), one or more non-hydrolyzable polymeric material(s), a copolymer thereof, or the like, or any combination thereof.

In various examples, the hydrolyzable polymeric material(s) is/are hydrolyzable, such that hydrolysis results in release of at least a portion of or all of the contents of the brush polymeric particle (e.g., nanoparticle, microparticle, or the like). In various examples, a solid nanoparticle (e.g., nanoparticle, microparticle, or the like) or a polymeric shell (e.g., nanoshell, microshell, or the like) comprises one or more hydrolysable polymeric material(s) which is/are hydrolyzable, such that hydrolysis results in release of at least a portion of or all of the contents of the polymeric material(s) and/or spherical space.

In various examples, the hydrolyzable polymeric material(s) are crosslinked and/or complexed. In various examples, the rate of hydrolysis of the hydrolyzable polymeric material(s) is tunable by the degree of crosslinking and/or complexation of the hydrolyzable polymeric material(s).

In various examples, the hydrolyzable polymeric material(s) comprise(s) (e.g., is/are) polymer(s), co-polymer(s), or the like, or any combination thereof one or more or all of which are hydrolyzable. In various examples, the polymeric material(s) comprise(s) one or more hydrolyzable polymer(s). In various examples, a solid particle or a polymeric shell comprise one or more polymeric material(s) which comprise(s) one or more hydrolyzable polymer(s). In various examples, one or more hydrolyzable polymeric material(s) comprise(s) (e.g., is/are) copolymer(s) comprising one or more hydrolyzable polymer(s) and one or more non-hydrolyzable polymer(s). In various examples, a solid particle (e.g., a nanoparticle, a microparticle, or the like) or a polymeric shell (e.g., a nanoshell, a microshell, or the like) comprise hydrolyzable polymeric material(s) which comprise(s) (e.g., is/are) copolymer(s) comprising one or more hydrolyzable polymer(s) and one or more non-hydrolyzable polymer(s). In various examples, the polymeric material(s) is/are mixture(s) of one or more hydrolyzable polymeric material(s) (e.g., hydrolyzable polymer(s), or the like, or any combination thereof) and one or more non-hydrolyzable polymeric material(s) (e.g., non-hydrolyzable polymer(s), or the like, or any combination thereof). In various examples, a solid particle (e.g., a nanoparticle, a microparticle, or the like) or a polymeric shell (e.g., a nanoshell, a microshell, or the like) comprise one or more polymeric material(s) which is/are mixture(s) of one or more hydrolyzable polymeric material(s) (e.g., hydrolyzable polymer(s), or the like, or any combination thereof) and one or more non-hydrolyzable polymeric material(s) (e.g., non-hydrolyzable polymer(s), or the like, or any combination thereof).

In various examples, one or more polymeric material(s) comprise(s) one or more hydrolyzable polymeric material(s), one or more non-hydrolyzable polymeric material(s), a copolymer thereof, or a combination thereof, and where: hydrolyzable polymeric material(s) comprise(s) one or more hydrolyzable polymer(s), one or more hydrolyzable copolymer(s) thereof, or a combination thereof; and/or the non-hydrolyzable polymeric material(s) comprise(s) one or more non-hydrolyzable polymer(s), one or more non-hydrolyzable copolymer(s) thereof, or a combination thereof.

In various examples, the hydrolyzable polymeric material(s) is/are chosen from polyesters, polyamines, polyureas, polyurethanes, polycarbonates, polyamides, polyimides, polyanhydrides, polythioesters, polysulfonylureas, polysulfonylamides, and polysiloxanes, polyaryl halides, polyalkyl halides, copolymers thereof, and combinations thereof.

In various examples, the non-hydrolyzable polymeric material(s) is/are chosen from polystyrene, polyvinyl alcohol, polyether, polyethylene, polypropylene, copolymers thereof, and combinations thereof.

In various examples, the hydrolyzable polymeric material(s) (e.g., hydrolyzable polymer(s), hydrolyzable copolymer(s), or the like, or any combination thereof) comprise(s) one or more hydrolyzable group(s). In various examples, the hydrolyzable group(s) are pendant from and/or within a polymer backbone of hydrolyzable polymeric material(s). In various examples, the hydrolyzable groups include, but are not limited to, ester groups, urea groups, urethane groups, carbonate groups, amide groups, imide groups, anhydride groups, thioester groups, sulfonylurea groups, sulfonylamide groups, silyloxy groups, aryl halide groups, alkyl halides groups, and the like, and combinations thereof.

In various examples, the hydrolyzable polymeric material(s) each comprise one or more hydrolyzable group(s), and where, for each hydrolyzable polymeric material, hydrolyzable group(s) are independently chosen from ester groups, urea groups, urethane groups, carbonate groups, amide groups, imide groups, anhydride groups, thioester groups, sulfonylurea groups, sulfonylamide groups, silyloxy groups, aryl halides, alkyl halides, and combinations thereof.

In various examples, a solid particle (e.g., nanoparticle, microparticle, or the like), a polymeric shell (e.g., nanoshell, microshell, or the like), or a portion thereof comprise one or more hydrolyzable polymeric material(s) which react(s) (e.g., hydrolyze, decompose, or the like) to provide one or more product(s) (e.g., one or more surfactant(s), one or more surfactant precursor(s), or the like, or a combination thereof), one or more or all of which have surfactant properties or the ability to have surfactant properties (e.g., depending on pH, salt concentration, temperature, pressure, or the like, or a combination thereof). In various examples, such a solid particle (e.g., nanoparticle, microparticle, or the like) is referred to as a surfactant solid particle (e.g., nanoparticle, microparticle, or the like) and such a polymeric shell (e.g., nanoshell, microshell, or the like) is referred to as a surfactant polymeric shell (e.g., nanoshell, microshell, or the like).

In various examples, the hydrolyzable polymeric material(s) comprise(s) sufficient hydrolyzable polymer(s) such that the brush polymeric particle (e.g., nanoparticle, microparticle, or the like) hydrolyzes and releases a desirable amount of surfactant(s) and/or surfactant precursor(s).

In various examples, the hydrolyzable polymeric material(s) (e.g., polymer(s), copolymer(s), or the like, or any combination thereof) are present in a solid particle (e.g., nanoparticle, microparticle, or the like) or in a polymeric shell (e.g., nanoshell, microshell, or the like) at, for example, on average, about 0.1 weight percent (wt. %) or greater (e.g., from about 0.1 wt. % to about 99.9 wt. %, including all 0.01% values and ranges therebetween), at about 1 wt. % or greater (e.g., from about 1 wt. % to about 99.9 wt. %, including all 0.01% values and ranges therebetween), at about 5 wt. % or greater (e.g., from about 5 wt. % to about 99.9 wt. %, including all 0.01% values and ranges therebetween), or at about 10 wt. % or greater (e.g., from about 0.1 wt. % to about 99.9 wt. %, including all 0.01% values and ranges therebetween), based on the total weight of the brush polymeric particle (e.g., a nanoparticle, a microparticle, or the like) or based on the total weight of the polymeric material(s).

In various examples, a brush polymeric particle (e.g., a nanoparticle, a microparticle, or the like) comprise(s) polymeric material(s) comprising positively charged groups, negatively charged groups, zwitterionic groups, nonionic groups, or the like, or any combination thereof. In various examples, the polymeric material(s) of a brush polymeric particle (e.g., a nanoparticle, a microparticle, or the like) comprise positively charged groups. In various examples, one or more polymeric brush(es) and a solid particle (e.g., a nanoparticle, a microparticle, or the like) or a capsule (e.g., a nanocapsule, a microcapsule, or the like) upon which the polymeric brush(es) is/are disposed comprise(s) the same or different positively charged groups, negatively charged groups, neutrally charged groups, nonionic groups, or the like, or any combination thereof.

A brush polymeric particle (e.g., a nanoparticle, a microparticle, or the like) can comprise various surfactant(s). As used herein, a surfactant is an organic compound that is amphiphilic, meaning containing one or more hydrophobic group(s) and one or more hydrophilic group(s). As used herein, one or more cationic surfactant(s) comprise(s) one or more cationic hydrophilic group(s), one or more anionic surfactant(s) comprise one or more anionic hydrophilic group(s), one or more nonionic surfactant(s) comprise one or more nonionic hydrophilic group(s), and one or more zwitterionic surfactant(s) comprise one or more cationic groups and one or more anionic groups per zwitterionic surfactant. In various examples, the surfactant(s) has/have surfactant properties depending upon the external environment (e.g., depending on pH, salt concentration, temperature, pressure, or the like, or a combination thereof).

In various examples, surfactant(s) is/are chosen from cationic surfactant(s), anionic surfactant(s), nonionic surfactant(s), zwitterionic surfactant(s), and the like, and combinations thereof. In various examples, surfactant(s) is/are polymeric surfactant(s). In various examples, surfactant(s) in the polymeric material(s) and/or the spherical space, which are optionally encapsulated surfactant(s), are surfactant(s) chosen from cationic surfactant(s), anionic surfactant(s), nonionic surfactant(s), zwitterionic surfactant(s), and the like, and any combination thereof, where any one or a portion of, or all of which is/are chosen from non-polymeric surfactant(s), polymeric surfactant(s), and the like, and any combination thereof. In various examples, a non-polymeric surfactant is a molecular surfactant.

In various examples, the cationic surfactant(s) is/are chosen from alkyl ammonium surfactant(s), aryl ammonium surfactant(s), alkyl phosphonium surfactant(s), aryl phosphonium surfactant(s), alkyl sulfonium surfactant(s), aryl sulfonium surfactant(s), polyquaternium surfactant(s), and the like, and any combination thereof. In various examples, cationic surfactant(s) is/are chosen from hexadecyltrimethylammonium bromide, cetylpyridinium chloride, tributyltetradecyl phosphonium chloride, tributylhexadecyl phosphonium bromide, 1-hexadecyl-3-methylimidazolium chloride, and the like, and any combination thereof.

In various examples, the anionic surfactant(s) is/are chosen from carboxylate salt(s), sulfonate salt(s), phosphate salt(s), and the like, and combinations thereof.

In various examples, nonionic surfactant(s) is/are chosen from fatty alcohol alkoxylate(s) (e.g., fatty alcohol ethoxylate(s), and the like, and any combination thereof), fatty acid alkoxylate(s) (e.g., fatty acid ethoxylate(s), and the like, and any combination thereof), alkyl phenol alkoxylate(s) (e.g., alkyl phenol ethoxylate(s), and the like and any combination thereof), fatty acid alkanolamide(s), alkylamine oxide(s), alkyl polyglucoside(s), and the like, and any combination thereof.

In various examples, the surfactant(s) is/are present at, for example, on average, from about 0.1 wt. % to about 60 wt. %, including all 0.01 wt. % values and ranges therebetween, based on the total weight of the brush polymeric particle (e.g., nanoparticle, microparticle, or the like).

A brush polymeric particle (e.g., nanoparticle, microparticle, or the like) can comprise various surfactant precursor(s).

In various examples, a surfactant precursor can react (e.g., undergo an ion exchange reaction, decompose, protonation reaction, or the like) to provide one or more product(s) with surfactant properties (e.g., one or more surfactant(s)) or the ability to have surfactant properties depending upon the external environment (e.g., depending on pH, salt concentration, temperature, pressure, or the like, or a combination thereof).

In various example, one or more or all portion(s) of hydrolyzable polymeric material(s) is/are surfactant precursor(s). In various examples, hydrolyzable polymeric material(s) hydrolyze(s) to provide one or more carboxylic acid material(s), one or more sulfonic acid material(s), one or more phosphoric acid material(s), or the like, or any combination thereof which is/are optionally surfactant(s) and/or surfactant precursor(s). In various examples, hydrolyzable polymeric material(s) hydrolyze(s) to provide surfactant precursor(s), that, under certain conditions, forms a carboxylate material, a sulfonate material, a phosphate material, the like, or any combination thereof which is/are optionally surfactant(s).

In various examples, the carboxylic acid material(s) comprise(s) carboxylic acid(s), carboxylate salts thereof (e.g., sodium carboxylate salts, calcium carboxylate salts, or the like, or any combination thereof), carboxylic acid derivatives thereof, or the like, or any combination thereof. In various examples, the carboxylic acid material(s) comprise C₆-C₂₂ (e.g., C₆-C₂₀, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C_{22,}or the like, or any combination thereof) alkyl groups, including all integer number of carbon and ranges therebetween, or the like, or any combination thereof.

In various examples, the surfactant precursor(s) are chosen from one or more carboxylic acid precursor(s) including but not limited to one or more carboxylic acid derivative(s). In various examples, the carboxylic acid derivative(s) include but are not limited to carboxylic ester(s), amide(s), peptide(s), thioester(s), acylphosphate(s), lactone(s), lactam(s), acid chloride(s), acid anhydride(s), and the like, and any combination thereof.

In various examples, the sulfonic acid material(s) comprise(s) sulfonic acid(s), sulfonate salts thereof (e.g., sodium sulfonate salts, calcium sulfonate salts, or the like, or any combination thereof), sulfonate derivatives thereof, thionyl chloride(s) thereof, or the like, or any combination thereof. In various examples, the sulfonic acid material(s) comprise C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, or the like, or any combination thereof.

In various examples, the surfactant precursor(s) include sulfonic acid precursor(s) including but not limited to sulfonic acid derivative(s). In various examples, sulfonic acid derivative(s) include but are not limited to thionyl halide(s), sulfonic ester(s), and sulfonamide(s). In various examples, the sulfonic acid derivative(s) are thionyl halide(s) having the formula R—S(O)₂—X, where R is a C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, and X is a halide, carboxyl halide, carbamoyl halide, alkyloxy silane, or the like, or any combination thereof.

In various examples, the surfactant precursor(s) comprise(s) one or more C₁-C₃₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₃₆, C₂₇, C₂₈, C₂₉, C₃₀ or the like, or any combination thereof) alkyl group(s), including all integer number of carbon and ranges therebetween, or a polymer, which optionally comprise(s) one or more pendant thionyl chloride group(s).

In various examples, the surfactant precursor(s) is/are chosen from esters, halides, carboxylic acids, sulfonic acids, phosphoric acids, and combinations thereof.

In various examples, the surfactant precursor(s) of a nonionic hydrophilic polymeric particle is/are present at, for example, on average, from about 10 wt. % to about 90 wt. %, including all 0.1 wt. % values and ranges therebetween, based on the total weight of a brush polymeric particle (e.g., nanoparticle, microparticle, or the like).

A brush polymeric particle (e.g., nanoparticle, microparticle, or the like) can comprise various ionic or nonionic groups.

In various examples, a brush polymeric particle (e.g., nanoparticle, microparticle, or the like) has, for example, on average, a plurality of positively charged, negatively charged, neutrally charged, or nonionic groups. In various examples, a solid particle (e.g., a nanoparticle, a microparticle, or the like) or a polymeric shell (e.g., a nanoshell, a microshell, or the like) comprises one or more polymeric material(s) comprising charged or nonionic groups. In various examples, the positively charged groups include but are not limited to ammonium groups, phosphonium groups, and the like, and any combination thereof. In various examples, the positively charged groups is/are chosen from cationic surfactants, cationic monomers, cationic comonomers, and the like, and any combination thereof. In various examples, the positively charged groups comprise positively charged functionalities, precursors of positively charged functionalities, or the like, or any combination thereof, including but not limited to, amines, pyridines, imidazoles, guanidines, sulfonium, ammonium, phosphonium, boronium, and the like, and any combination thereof.

In various examples, the nonionic groups include, but are not limited to, alcohol groups, alkyl ether groups, polyalkyl ether groups, and the like, and any combination thereof. In various examples, the nonionic groups is/are chosen from nonionic surfactants, nonionic monomers, nonionic comonomers, and the like, and any combination thereof. In various examples, the nonionic hydrophilic groups comprise nonionic hydrophilic functionalities, precursors of nonionic hydrophilic functionalities, or the like, or any combination thereof, including but not limited to alcohol groups, alkyl ether groups, polyalkyl ether groups, and the like, and any combination thereof.

In various examples, one or more or all portion(s) of an outer surface of a brush polymeric particle (e.g., nanoparticle, microparticle, or the like) comprise(s) a plurality of positively charged groups, negatively charged groups, neutrally charged groups, or nonionic groups. In various examples, one or more polymeric material(s) of a solid particle or a capsule of a brush polymeric particle (e.g., nanoparticle, microparticle, or the like) comprise(s) a plurality of positively charged groups disposed on one or more or all portion(s) of an outer surface of a brush polymeric particle (e.g., nanoparticle, microparticle, or the like), where the positively charged groups of the polymeric material(s) provide some or all of the positive charge of the brush polymeric particle (e.g., nanoparticle, microparticle, or the like). In various examples, one or more polyelectrolyte brush(es) disposed on one or more or all portion(s) of an outer surface of a brush polymeric particle (e.g., nanoparticle, microparticle, or the like) comprise(s) positively charged groups, where the positively charged groups of the polyelectrolyte brushe(s) provide some or all of the positive charge of the brush polymeric particle (e.g., nanoparticle, microparticle, or the like).

In various examples, one or more or all portion(s) of an outer surface of a brush polymeric particle (e.g., nanoparticle, microparticle, or the like) has/have, for example, on average, inducible charge depending upon external conditions (e.g., pH or salt concentration). In various examples, under certain external conditions, one or more or all portion(s) of an outer surface of a polymeric particle (e.g., nanoparticle, microparticle, or the like) has/have, for example, on average, inducible positive charge.

In various examples, polyelectrolyte brush(es) disposed on a brush polymeric particle (e.g., nanoparticle, microparticle, or the like) is/are present at, for example, on average, about 0.1 wt. % or greater (e.g., from about 0.1 wt. % to about 99.9 wt. %, including all 0.01 wt. % values and ranges therebetween), based on the total weight of a brush polymeric particle (e.g., nanoparticle, microparticle, or the like).

In various examples, brush polymeric particles (e.g., nanoparticles, microparticles, or the like, or any combination thereof) comprise one or more additive(s) (e.g., surfactant(s), surfactant precursor(s), hydrolysable compound(s), or the like, or any combination thereof). In various examples, the brush polymeric particles (e.g., nanoparticles, microparticles, or the like, or any combination thereof) are hollow particles (e.g., nanocapsules, microcapsules, or the like, or any combination thereof) or solid particles (e.g., nanoparticles, microparticles, or the like, or any combination thereof). The brush polymeric particles (e.g., nanoparticles, microparticles, or the like, or any combination thereof) are referred to herein, in various examples, as brush targeted delivery particle. In various examples, a brush polymeric particle (e.g., nanoparticle, microparticle, or the like) is made by a method of the present disclosure.

In various examples, a surface charge of a brush polymeric particle (e.g., nanoparticle, microparticle, or the like) is tuned using emulsifiers, monomers and functional comonomers. In various examples, a positive surface charge is introduced using cationic surfactants, monomers and/or comonomers containing positively charged functionalities or precursors of the positively charged functionalities (e.g., functional groups) including, but not limited to, amines, pyridines, imidazoles, guanidines, sulfonium, ammonium, phosphonium, boronium, and the like.

A brush polymeric particle (e.g., nanoparticle, microparticle, or the like) can have various colloidal stability values. In various examples, a brush polymeric particle (e.g., nanoparticle, microparticle, or the like) comprises, for example, on average, a positive zeta potential in distilled and/or deionized water. In various examples, a brush polymeric particle (e.g., nanoparticle, microparticle, or the like) comprises, for example, on average, a zeta potential in distilled and/or deionized water of about 10 millivolts (mV) or greater (e.g., from about 10 millivolts (mV) to about 70 mV, including all 0.1 mV values and ranges therebetween). In various examples, one or more or all portion(s) of an outer surface of a brush polymeric particle (e.g., nanoparticle, microparticle, or the like) has/have, for example, on average, a zeta potential in distilled and/or deionized water of from about 10 millivolts (mV) to about 70 mV, including all 0.1 mV values and ranges therebetween.

In various examples, brush particle(s) (e.g., nanoparticle(s), microparticle(s), or the like, or any combination thereof) further comprise one or more additive(s). Non-limiting examples of additive(s) include emulsifier(s), or the like, or any combination thereof.

In an aspect, the present disclosure provides a composition comprising one or more polymeric particle(s) (e.g., charged polymeric particle(s) or brush polymeric particle(s)) (e.g., nanoparticle(s), microparticle(s), or the like, or any combination thereof) of the present disclosure. Non-limiting examples of compositions comprising polymeric particle(s) (e.g., charged polymeric particle(s) or brush polymeric particle(s)) (e.g., nanoparticle(s), microparticle(s), or the like, or any combination thereof) of the present disclosure are provided herein.

In various examples, a composition comprises one or more charged polymeric particles(s) of the present disclosure. In various examples, a composition comprises the charged polymeric particle(s) (e.g., nanoparticle(s), microparticle(s), or the like, or any combination thereof) at from about 5 parts per million (ppm) to about 1000 ppm, including all 1 ppm values and ranges therebetween. In various examples, a composition further comprise(s) one or more carrier(s). In various examples, carriers include but are not limited to clays, porous materials (e.g. porous silicas, porous carbon materials, and the like), and combinations thereof.

In various examples, a composition comprises one or more brush polymeric particles(s) of the present disclosure. In various examples, a composition comprises the brush polymeric particle(s) (e.g., nanoparticle(s), microparticle(s), or the like, or any combination thereof) at from about 5 parts per million (ppm) to about 1000 ppm, including all 1 ppm values and ranges therebetween. In various examples, a composition further comprise(s) one or more carrier(s). In various examples, carriers include but are not limited to clays, porous materials (e.g. porous silicas, porous carbon materials, and the like), and combinations thereof.

In an aspect, the present disclosure provides methods of making polymeric particles (e.g., charged polymeric particles or brush polymeric particle) (e.g., nanoparticles, microparticles, or the like, or any combination thereof) of the present disclosure. Non-limiting examples of methods of making polymeric particles (e.g., charged polymeric particles or brush polymeric particle) (e.g., nanoparticles, microparticles, or the like, or any combination thereof) of the present disclosure are provided herein.

In various examples, charged polymeric particles (e.g., nanoparticles, microparticles, or the like, or any combination thereof) are synthesized via various polymerization (e.g., emulsion polymerization, miniemulsion (nanoemulsion) polymerization, and the like) methods. In various examples, charged polymeric particles (e.g., nanoparticles, microparticles, or the like) such as, for example, a solid particle, are made by a dispersed phase polymerization. In various examples, charged polymeric particles (e.g., nanoparticles, microparticles, or the like) such as, for example, charged polymeric capsules (e.g., nanocapsules, microcapsules, or the like) are synthesized via (from monomer) interfacial polymerization, emulsion polymerization, dispersion polymerization, suspension polymerization, (from pre-synthesized polymer, i.e., the shell polymer) nanoprecipitation, double emulsification, emulsion-diffusion, coacervation, sonication, or the like. In various examples, charged polymeric capsules (e.g., nanocapsules, microcapsules, or the like) comprising polymeric shells (e.g., nanoshells, microshells, or the like) are synthesized via (from monomer) interfacial polymerization, emulsion polymerization, dispersion polymerization, suspension polymerization, (from pre-synthesized polymer, i.e., the shell polymer) nanoprecipitation, double emulsification, emulsion-diffusion, coacervation, sonication, or the like.

In various examples, charged polymeric particles (e.g., nanoparticles, microparticles, or the like) such as, for example, solid polymeric particles (e.g., nanoparticles, microparticles, or the like) are made by emulsion polymerization, miniemulsion polymerization, microemulsion polymerization, nanoemulsion polymerization, suspension polymerization, dispersion polymerization, or the like. In various examples, a solid particle (e.g., nanoparticle, microparticle, or the like) is a solid core or a solid core-shell particle (e.g., nanoparticle, microparticle, or the like). In various examples, a core and shell comprise (or are) the same polymeric material(s). In various examples, a core and shell comprise (or are) one or more or all different polymeric material(s).

In various examples, brush polymeric particles (e.g., nanoparticles, microparticles, or the like, or any combination thereof) are synthesized via various polymerization (e.g., emulsion polymerization, miniemulsion (nanoemulsion) polymerization, and the like) methods. In various examples, brush polymeric particles (e.g., nanoparticles, microparticles, or the like) comprising a solid particle (e.g., nanoparticle, microparticle, or the like) are made by a dispersed phase polymerization. In various examples, brush polymeric particles (e.g., nanoparticles, microparticles, or the like) comprising a polymeric capsule (e.g., nanocapsule, microcapsule, or the like) are synthesized via (from monomer) interfacial polymerization, emulsion polymerization, dispersion polymerization, suspension polymerization, (from pre-synthesized polymer, i.e., the shell polymer) nanoprecipitation, double emulsification, emulsion-diffusion, coacervation, sonication, or the like. In various examples, brush polymeric particles (e.g., nanoparticles, microparticles, or the like) comprising a polymeric capsule (e.g., nanocapsule, microcapsule, or the like) comprising a polymeric shell (e.g., nanoshell, microshell, or the like) are synthesized via (from monomer) interfacial polymerization, emulsion polymerization, dispersion polymerization, suspension polymerization, (from pre-synthesized polymer, i.e., the shell polymer) nanoprecipitation, double emulsification, emulsion-diffusion, coacervation, sonication, or the like.

In various examples, brush polymeric particles (e.g., nanoparticles, microparticles, or the like) comprising solid polymeric particles (e.g., nanoparticles, microparticles, or the like) are made by emulsion polymerization, miniemulsion polymerization, microemulsion polymerization, nanoemulsion polymerization, suspension polymerization, dispersion polymerization, or the like. In various examples, a solid particle (e.g., nanoparticle, microparticle, or the like) is a solid core particle (e.g., nanoparticle, microparticle, or the like) or a solid core-shell particle (e.g., nanoparticle, microparticle, or the like). In various examples, a solid core-shell particle (e.g., nanoparticle, microparticle, or the like) comprise (or are) the same or different polymeric material(s) for the core and shell.

In various examples, one or more polymer brush(es) is/are synthesized at an exterior surface of a brush polymeric particle (e.g., nanoparticle, microparticle, or the like) by graft polymerization from an exterior surface of a solid particle (e.g., nanoparticle, microparticle, or the like) or a polymeric capsule (e.g., nanocapsule, microcapsule, or the like) and/or subsequent functionalization.

In an aspect, the present disclosure provides a method for oil recovery using polymeric particles (e.g., charged polymeric particles or brush polymeric particle) (e.g., nanoparticles, microparticles, or the like, or any combination thereof) of the present disclosure. Non-limiting examples of methods for oil recovery using the polymeric particles (e.g., charged polymeric particles or brush polymeric particles) (e.g., nanoparticles, microparticles, or the like, or any combination thereof)of the present disclosure are provided herein.

In various examples, a method comprises contacting an oil-containing geological formation with one or more positively charged polymeric particle(s) (e.g., nanoparticle(s), microparticle(s), or the like, or any combination thereof) of the present disclosure. In various examples, after contacting, one or more surfactant(s) and/or one or more surfactant precursor(s) is/are released from at least a portion of the positively charged polymeric particle(s) (e.g., nanoparticle(s), microparticle(s), or the like, or any combination thereof). In various examples, contacting is achieved by pumping the positively charged polymeric particle(s) (e.g., nanoparticle(s), microparticle(s), or the like, or any combination thereof) through a well bore. In various examples, contacting results in increased oil production from a geological formation. In various examples, releasing is achieved by diffusion out of at least a portion of the positively charged polymeric particle(s) (e.g., nanoparticle(s), microparticle(s), or the like, or any combination thereof) and/or hydrolysis of at least a portion of the polymeric material(s). In various examples, positively charged polymeric particle(s) (e.g., nanoparticle(s), microparticle(s), or the like, or any combination thereof) is/are present as a composition of the present disclosure.

In various examples, a method comprises contacting an oil-containing geological formation with one or more positively charged brush polymeric particle(s) (e.g., nanoparticle(s), microparticle(s), or the like, or any combination thereof) of the present disclosure. In various examples, after contacting, one or more surfactant(s) and/or one or more surfactant precursor(s) is/are released from at least a portion of the positively charged brush polymeric particle(s) (e.g., nanoparticle(s), microparticle(s), or the like, or any combination thereof). In various examples, contacting is achieved by pumping the positively charged brush polymeric particle(s) (e.g., nanoparticle(s), microparticle(s), or the like, or any combination thereof) through a well bore. In various examples, contacting results in increased oil production from a geological formation. In various examples, releasing is achieved by diffusion out of at least a portion of the positively charged brush polymeric particle(s) (e.g., nanoparticle(s), microparticle(s), or the like, or any combination thereof) and/or hydrolysis of at least a portion of the polymeric material(s). In various examples, positively charged brush polymeric particle(s) (e.g., nanoparticle(s), microparticle(s), or the like, or any combination thereof) is/are present as a composition of the present disclosure.

In an aspect, the present disclosure provides uses of polymeric particles (e.g., charged polymeric particles or brush polymeric particles) (e.g., nanoparticles, microparticles, or the like, or any combination thereof) of the present disclosure. Non-limiting examples of uses of charged polymeric particles (e.g., charged polymeric particles or brush polymeric particles) (e.g., nanoparticles, microparticles, or the like, or any combination thereof) of the present disclosure are provided herein.

The charged polymeric particles (e.g., nanoparticles, microparticles, or the like, or any combination thereof) can have various uses. The charged polymeric particles (e.g., nanoparticles, microparticles, or the like, or any combination thereof) can be used in methods related to the oil and gas industries. In various examples, charged polymeric particles (e.g., nanoparticles, microparticles, or the like, or any combination thereof) are used in methods of enhanced oil recovery, remediation of oil spills, or the like. In various examples, charged polymeric particles (e.g., nanoparticles, microparticles, or the like, or any combination thereof) are used for targeting and release, which, in various examples, are slow release, of surfactants, other additives, or the like, or a combination thereof for enhanced oil recovery. In various examples, the charged polymeric particles (e.g., nanoparticles, microparticles, or the like, or any combination thereof) are used in drug delivery applications/methods, biomedical applications/methods, sensing applications/methods, or the like.

The brush polymeric particles (e.g., nanoparticles, microparticles, or the like, or any combination thereof) can have various uses. The brush polymeric particles (e.g., nanoparticles, microparticles, or the like, or any combination thereof) can be used in methods related to the oil and gas industries. In various examples, brush polymeric particles (e.g., nanoparticles, microparticles, or the like, or any combination thereof) are used in methods of enhanced oil recovery, remediation of oil spills, or the like. In various examples, brush polymeric particles (e.g., nanoparticles, microparticles, or the like, or any combination thereof) are used for targeting and release, which, in various examples, are slow release, of surfactants, other additives, or the like, or a combination thereof for enhanced oil recovery. In various examples, the brush polymeric particles (e.g., nanoparticles, microparticles, or the like, or any combination thereof) are used in drug delivery applications/methods, biomedical applications/methods, sensing applications/methods, or the like.

The steps of the methods described in the various embodiments and examples disclosed herein are sufficient to produce a polymer of the present disclosure or carry out a method of the present disclosure. Thus, in various embodiments, a method consists essentially of a combination of the steps of the methods disclosed herein. In various other embodiments, a method consists of such steps.

The following Statements describe various examples of the present disclosure and are not intended to be in any way limiting:

Statement 1. A nanoparticle (which may be referred to as a nanocapsule) comprising: a polymeric shell defining a spherical space; optionally, one or more surfactant or surfactant precursor disposed in the spherical space, wherein the nanoparticle (e.g., at least a portion of an outer/exposed surface of the polymeric shell) is positively charged.
Statement 2. A nanoparticle according to Statement 1, wherein the polymeric shell comprises a non-hydrolyzable polymer chosen from polystyrene, polyethylene, polypropylene, and the like, and a combination thereof.
Statement 3. A nanoparticle according to Statement 1, wherein the polymeric shell comprises (e.g., is) a hydrolyzable polymer chosen from polyesters, polyamines, polyureas, polyurethanes, polycarbonates, polyamides, polyimides, polyanhydrides, polythioesters, polysulfonylureas, polysulfonylamides, polysiloxanes, and the like, and combinations thereof.
Statement 4. A nanoparticle according to any one of the preceding Statements, wherein the polymeric shell has a thickness of 2 nm or greater (e.g., 2 nm to 1 micron (e.g., 2 nm to 500 nm or 2 nm to 100 nm)), including all 0.1 nm values and ranges therebetween.
Statement 5. A nanoparticle according to any one of the preceding Statements, wherein the polymeric shell further comprises one or more cationic surfactant(s).
Statement 6. A nanoparticle according to any one of the preceding Statements, wherein surfactant is chosen from hexadecyltrimethylammonium bromide, cetylpyridinium chloride, tributyltetradecyl phosphonium chloride, tributylhexadecyl phosphonium bromide, and the like, and combinations thereof.
Statement 7. A nanoparticle according to any one of the preceding Statements, wherein surfactant precursor is chosen from thionyl halides (e.g., thionyl chloride) (e.g., R—S(O)₂—X, wherein in R is a C₁-C₃₀ alkyl group, including all integer number of carbon group and ranges therebetween, and X is a halide (fluoride, chloride, bromide, or iodide), carboxyl halides, carbamoyl halides, alkyloxy silanes, and the like, and combinations thereof.
Statement 8. A nanoparticle according to any one of the preceding Statements, wherein the surfactant(s) and/or surfactant precursor(s) is/are present at 0.1 wt. % to 10 wt. %, including all 0.01 wt. % values and ranges therebetween, based on total weight of the nanoparticle.
Statement 9. A nanoparticle according to any one of the preceding Statements, wherein the nanoparticle has a surface charge of at least 10 mV (e.g., 10 mV to 70 mV), which may be a zeta potential and/or may be measured in distilled and/or deionized water.
Statement 10. A nanoparticle according to any one of the preceding Statements, wherein the nanoparticle is made by interfacial polymerization, or the like.
Statement 11. A nanoparticle (which may be referred to as a solid nanoparticle) comprising: one or more hydrolyzable polymeric material(s), wherein the nanoparticle (e.g., at least a portion of an outer/exposed surface of the polymeric shell) is positively charged.
Statement 12. A nanoparticle according to Statement 11, wherein the hydrolyzable polymer material comprises (e.g., is) a hydrolyzable polymer chosen from polyesters, polyamines, polyureas, polyurethanes, polycarbonates, polyamides, polyimides, polyanhydrides, polythioesters, polysulfonylureas, polysulfonylamides, polysiloxanes, and the like, and combinations thereof.
Statement 13. A nanoparticle according to Statement 11 or 12, wherein the hydrolyzable polymeric material(s) further comprises one or more cationic surfactant(s).
Statement 14. A nanoparticle according to any one of Statements 11-13, wherein the nanoparticle a size (e.g., a longest linear dimension, such as, for example, a diameter of 5 nm to 2.5 microns (e.g., 2 nm to 200 nm, 2 to 500 nm or 2 nm to 1 micron), including all 0.1 nm values and ranges therebetween.
Statement 15. A nanoparticle according to any one of Statements 11-14, wherein the nanoparticle has a surface charge of a surface charge of at least 10 mV (e.g., 10 mV to 70 mV), which may be a zeta potential and/or may be measured in distilled and/or deionized water.
Statement 16. A nanoparticle according to any one of Statements 11-14, wherein the nanoparticle is made by emulsion polymerization, miniemulsion polymerization, microemulsion polymerization, nanoemulsion polymerization, suspension polymerization, dispersion polymerization, or the like.
Statement 17. A composition comprising one or more nanoparticle(s) of the present disclosure (e.g., nanocapsule(s), nanoparticle(s), or a combination thereof) (e.g., nanoparticle(s) according to any one of Statements 1-10, nanoparticle(s) according to any one of Statements 11-16, or a combination thereof).
Statement 18. A composition according to Statement 17, wherein the composition further comprise one or more carrier(s), or the like.
Statement 19. A composition according to Statement 17 or 18, wherein the nanoparticle(s) is/are present at 5 ppm to 1000 ppm (e.g., 10 ppm to 100 ppm, 10 to 200 ppm, or 10 ppm to 1000 ppm), including all integer ppm values and ranges therebetween.
Statement 20. A method for oil recovery comprising: contacting an oil-containing geological formation with one or more nanoparticle(s) of the present disclosure e.g., nanocapsule(s), nanoparticles, or a combination thereof, which may be present in a composition) (e.g., nanoparticle(s) according to any one of Statements 1-10, nanoparticle(s) according to any one of Statements 11-16, or a combination thereof and/or one or more composition(s) according to any one of Statements 17-19), wherein at least a portion of the nanoparticle(s) release one or more surfactant(s) and/or one or more surfactant precursor(s).
Statement 21. A method for oil recovery according to Statement 20, wherein the nanoparticle(s) are contacted with the geological formation by pumping the nanoparticle(s) through a well bore.
Statement 22. A method for oil recovery according to Statement 20 or 21, wherein the contacting results in increased oil production from the geological formation.

The following examples are presented to illustrate the present disclosure. The examples are not intended to be limiting in any matter.

### EXAMPLE 1

The following is an example of charged polymeric particles (e.g., nanoparticles, microparticles, or the like, or any combination thereof) of the present disclosure and methods of producing and using said charged polymeric particles (e.g., nanoparticles, microparticles, or the like, or any combination thereof).

Targeted Delivery via Direct Assembly of Particles (e.g., Nanoparticles, Microparticles, or the Like, or any Combination Thereof) at Liquid-Liquid Interfaces by Fine-tuning Molecular Interactions. A system that combines into a single platform, both controlled assembly and targeted delivery, was demonstrated. Directed assembly of amine-functionalized polystyrene nanoparticles (PS+) NPs at the oil/water interface was shown by introducing carboxylic acid functional groups in the oil. The electrostatic interaction between the amine group of the PS+ NPs and carboxylic groups of oil was confirmed using zeta potential and laser scanning confocal microscopy and contrasted with negatively charged sulfonate-functionalized (PS-) NPs under the same conditions. The positively charged PS NPs dispersed in deionized water or different salinity electrolytes selectively attached to the negatively charged oil. The results also showed that by tuning the pH or the ionic strength of the electrolyte, the extent of the interaction between the NPs and the oil surface was modulated. After assembly at the oil-water interface, the NPs released appropriately loaded cargo, a design feature that can be exploited in various applications, including the delivery of surfactants or other chemicals in fields ranging from pharmaceutical and cosmetics to oil and gas.

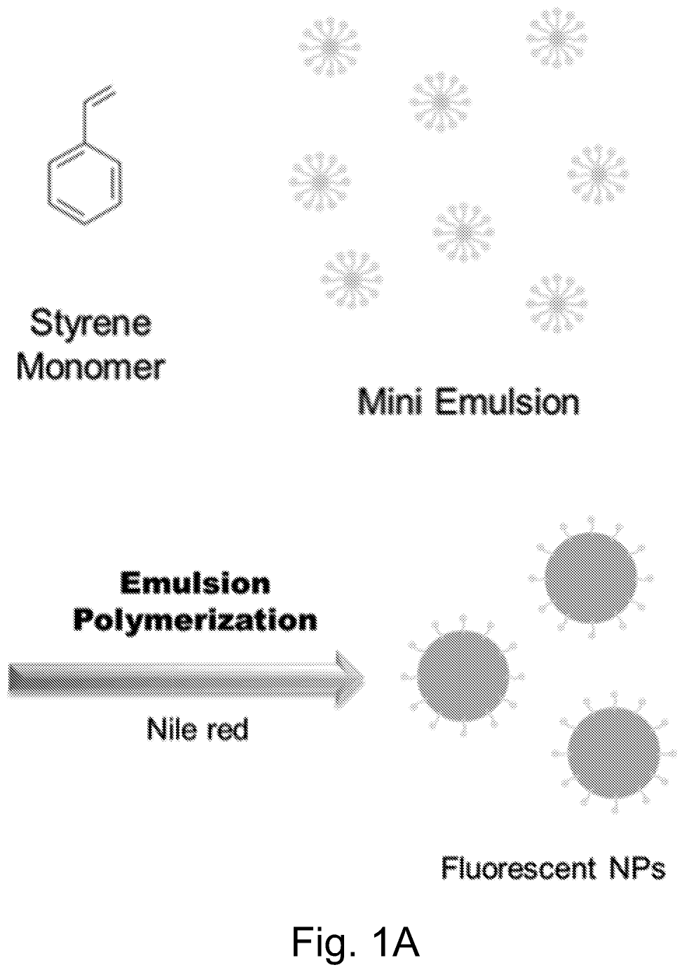

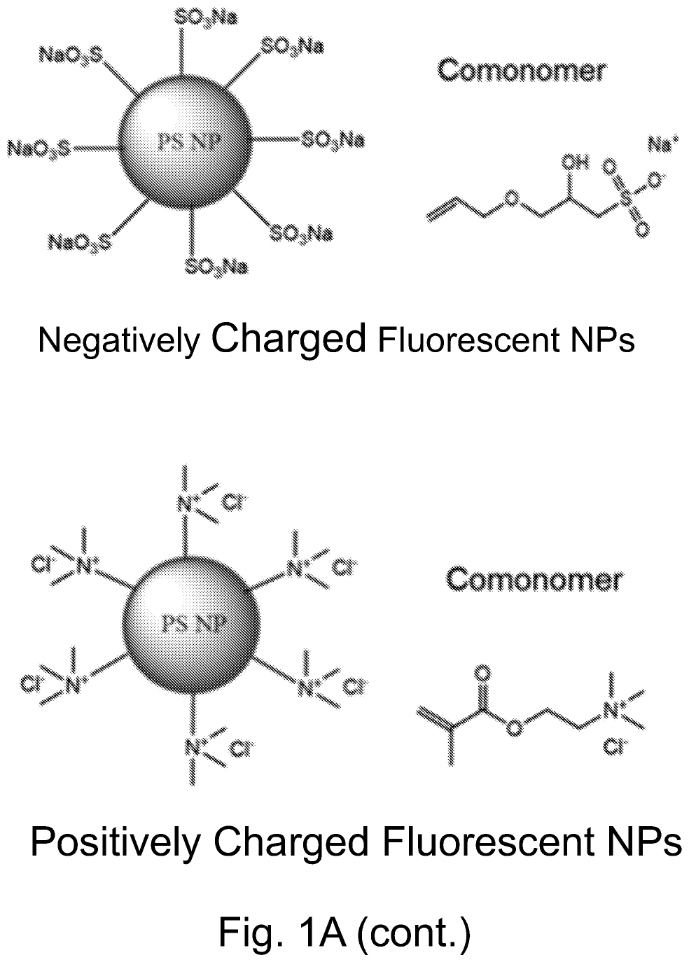

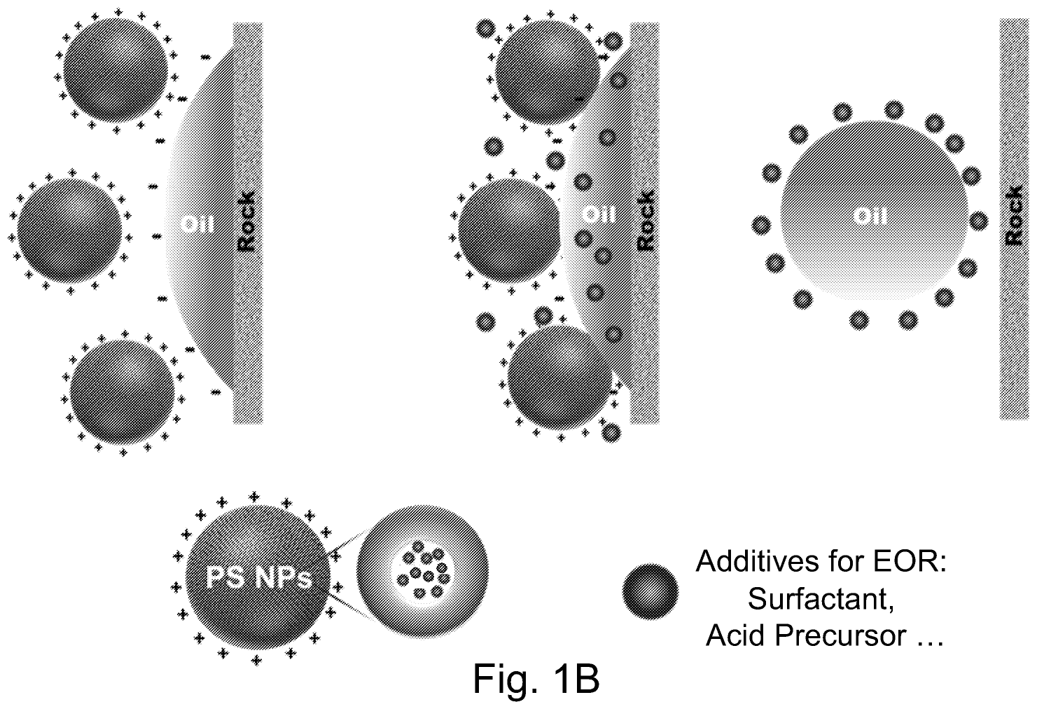

Herein, an efficient and scalable method is disclosed to direct assemble NPs at the oil/water interface by fine-tuning the electrostatic interactions between the oil and NPs (FIGS. 1A-1B). The assembly of negatively charged oil and fluorescent, positively charged aminated PS NPs was investigated by confocal microscopy. The electrostatic interactions were modulated by the use of different salinity electrolytes or by tuning the pH of the aqueous phase. After assembly, the NPs released their cargo, demonstrating a system that combines into a single platform both controlled assembly and targeted delivery. Beyond adding to the fundamental understanding of ways to manipulate and control oil/water interfaces, this study paves the way for a wide number of practical applications in a variety of fields.

Synthesis and characterization of Nile red Polystyrene NPs. Fluorescent, water-dispersible polystyrene nanoparticles were synthesized via free-radical emulsion polymerization in water. Nile red was introduced during the synthesis to distinguish the NPs from the bulk oil phase, which was labeled with a blue fluorescent dye. Quaternary ammonium or sulfonate functional comonomers were used to produce positively (PS+) and negatively (PS−) charged polystyrene nanoparticles, respectively. Both NP systems were dispersible in water or brine.

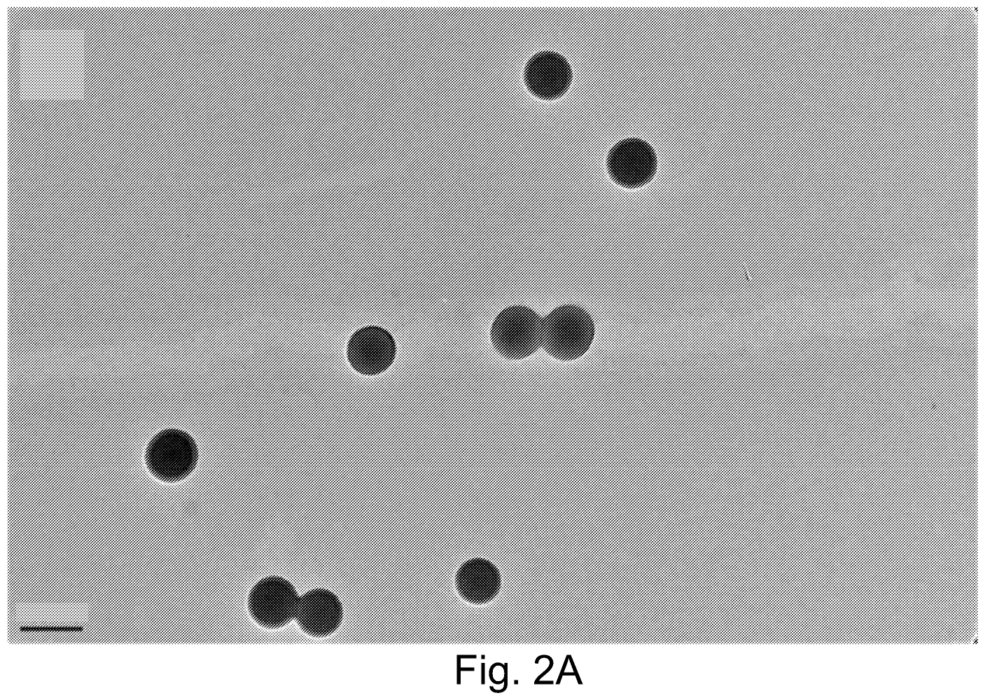

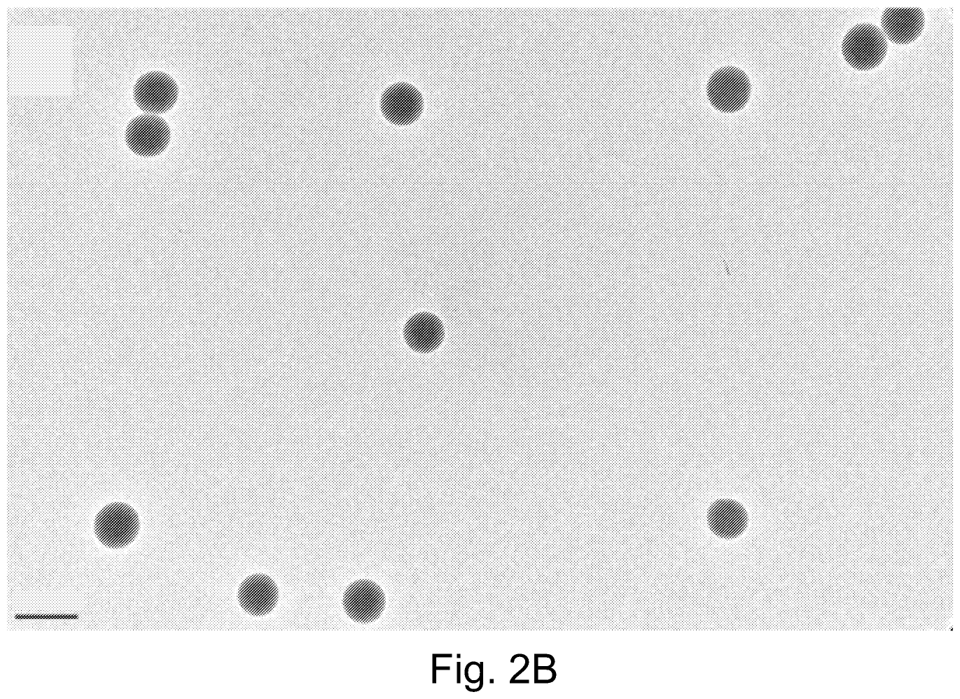

DLS measurements showed that the nanoparticles were relatively monodisperse with a diameter of 144 and 122 nm for PS+ and PS−, respectively. The DLS measurements were consistent with the sizes obtained from TEM (FIGS. 2A-2B). Lastly, the zeta potential in DI water was +41 and −43 mV for the PS+ and PS− nanoparticles, respectively (Tables 1-2).

TABLE 1
Zeta-potential (mV) measurements at different brine salinity.

| Brine | Crude Oil | Model Oil | Polystyrene (+) |
|---|---|---|---|
| Di water | −21 | −24 | +41 |
| Seawater 20% | −18 | −19 | +25 |
| Seawater 50% | −11 | −9 | +10 |
| Seawater 100% | −9 | −8 | +10 |

TABLE 2
Zeta-potential (mV) measurements at sodium chloride brines.

| Concentration of NaCl (%) | Model oil | Polystyrene (+) |
|---|---|---|
| 1 | −23 | +33 |
| 5 | −10 | +11 |

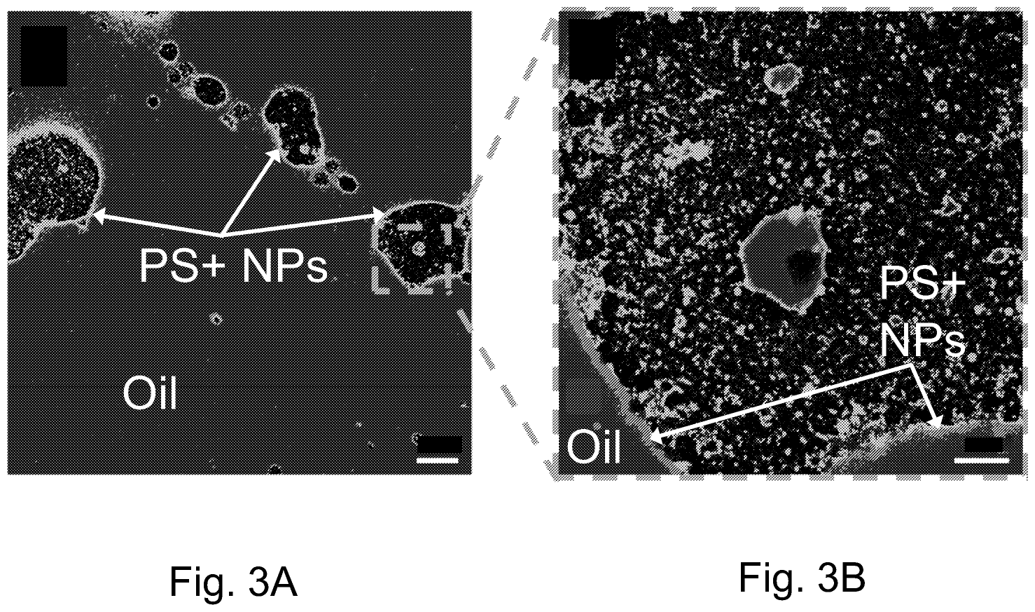

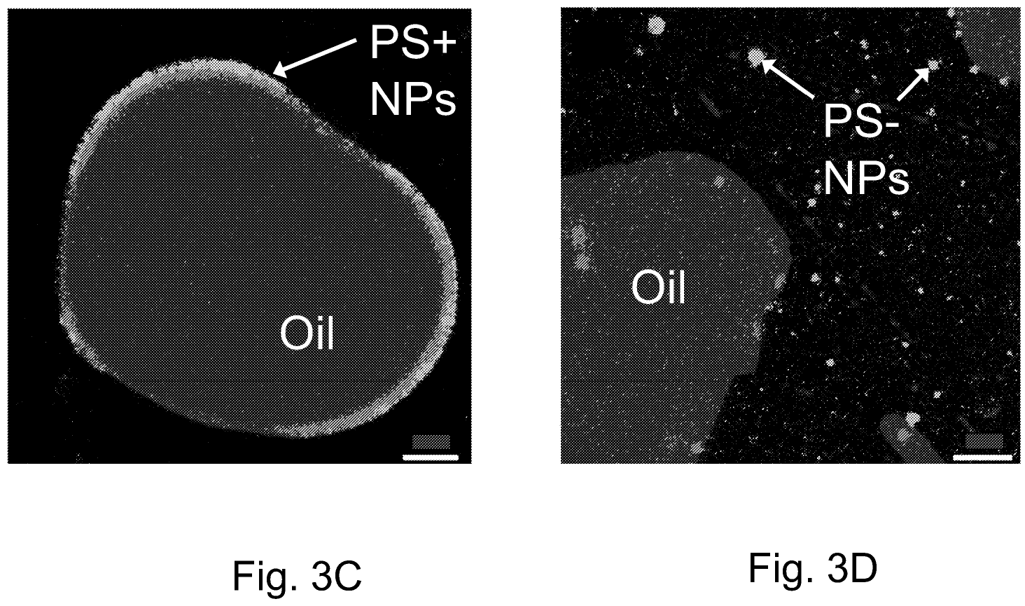

NP attachment at the oil-water interface. To investigate the directed assembly mechanism, how NPs interact with a model oil-water mixture was studied. The selection of model oil was based on the necessity to introduce functional groups into the oil phase as well as to simulate crude oil behavior. Given that model oil is negatively charged (Tables 1-2), positively charged NPs were investigated at two different concentrations in DI water. Once a 1:1 mixture of water and model oil was vigorously agitated in a vortex mixer, it formed a non-uniform emulsion, which phase-separated quickly into the two immiscible phases. Confocal microscope images are shown in FIGS. 3A-3C for a mixture of model oil-water for positively charged NPs at two different concentrations in water (1000ppm, FIGS. 3A-3B) and (100 ppm, FIG. 3C). The images show clearly that the positively charged NPs tended to segregate at the oil-water interface. For the 1000 ppm suspension, in addition to being present at the interface, it can be seen that NPs were also in the water phase. The segregation to the interface is attributed to the positively charged ammonium groups that are attracted to the negatively charged carboxylic groups from the stearic acid in the model oil phase. (Table 1).

These results were contrasted with the negatively charged, sulfonate-functionalized PS NPs under the same conditions. FIG. 3D clearly shows that the negatively charged NPs were not directed to the oil-water interface and stayed dispersed in the water phase. These experiments were consistent with that complementarity of charges is necessary for the successful directed assembly at the interface.

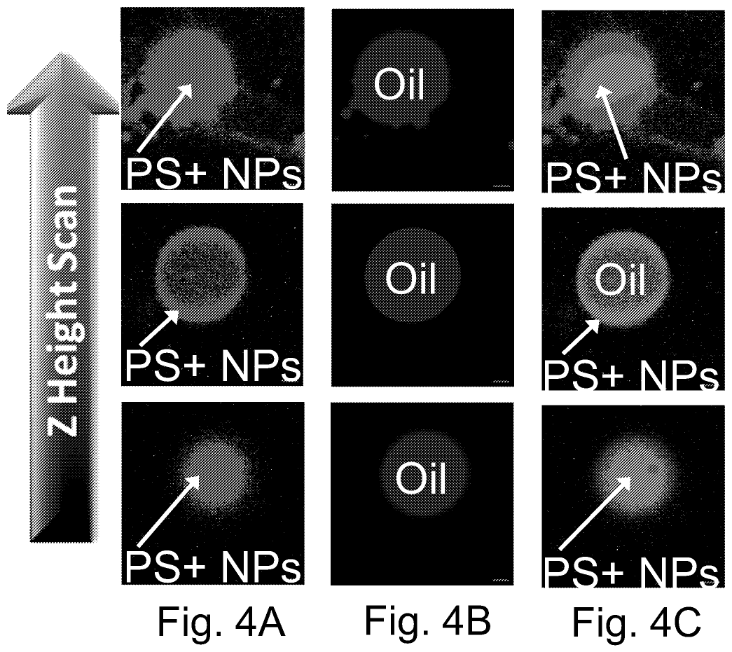

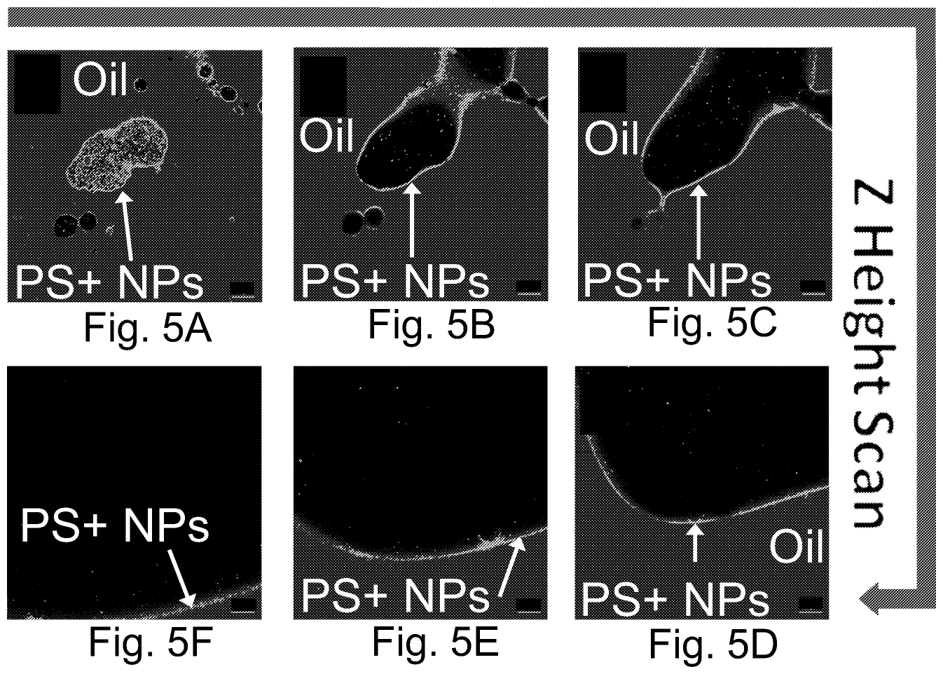

Further evidence was provided by three-dimensional confocal imaging (z-scans). FIGS. 4A-4C show a confocal z-stack of an oil droplet and focuses on the fluorescence of the NPs, the oil, and an overlap of the two (left to right). Three different slices are presented corresponding to (down to up) the bottom, middle, and the top of an oil droplet (FIGS. 4A-4C, 5). By imaging the oil droplet at different depths, the red fluorescent NPs were shown to uniformly decorate the surface of the blue fluorescence oil droplet.

Effect of Salinity on NP Assembly. To evaluate the effect of salinity on the directed assembly of the NPs, a series of suspensions in solutions of varying ionic strength were used instead of DI water. To that end, three different NP suspensions in a mixture of electrolytes simulating seawater (100% seawater, Table 3) as well as lower salinities (50% and 20% seawater) were prepared.

TABLE 3
Salt amount for the seawater preparation.

| Compound | NaCl | CaCl₂•₂H₂O | MgCl₂•6H₂O | Na₂SO₄ | NaHCO₃ |
|---|---|---|---|---|---|
| mass (g) | 41.04 | 2.384 | 17.645 | 6.343 | 0.165 |

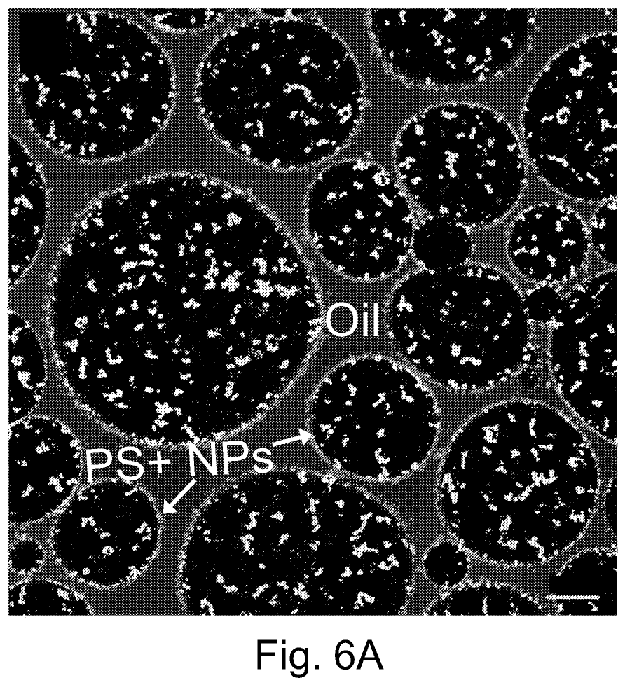

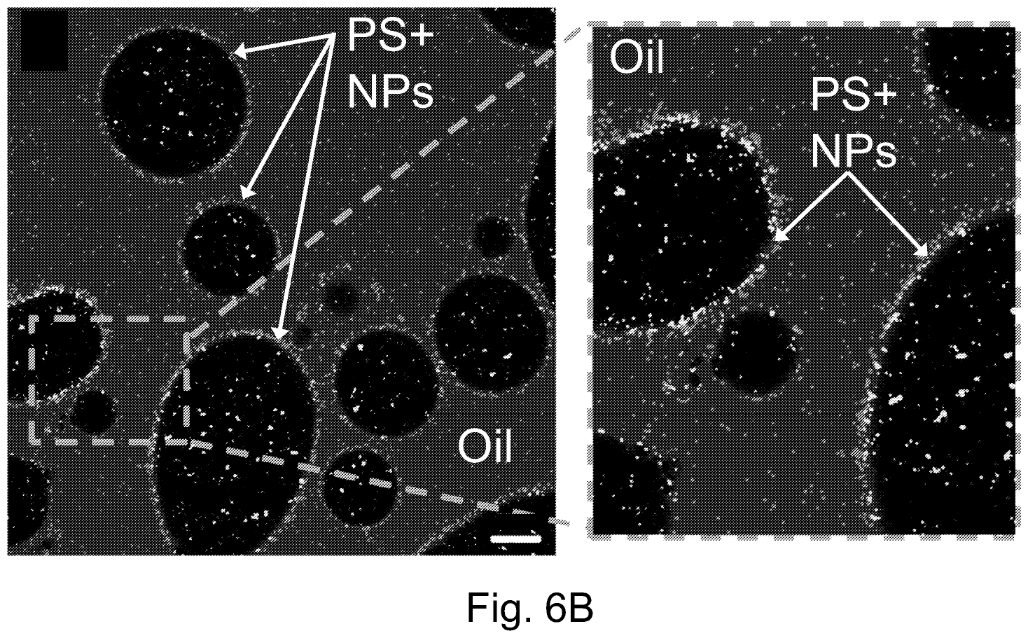

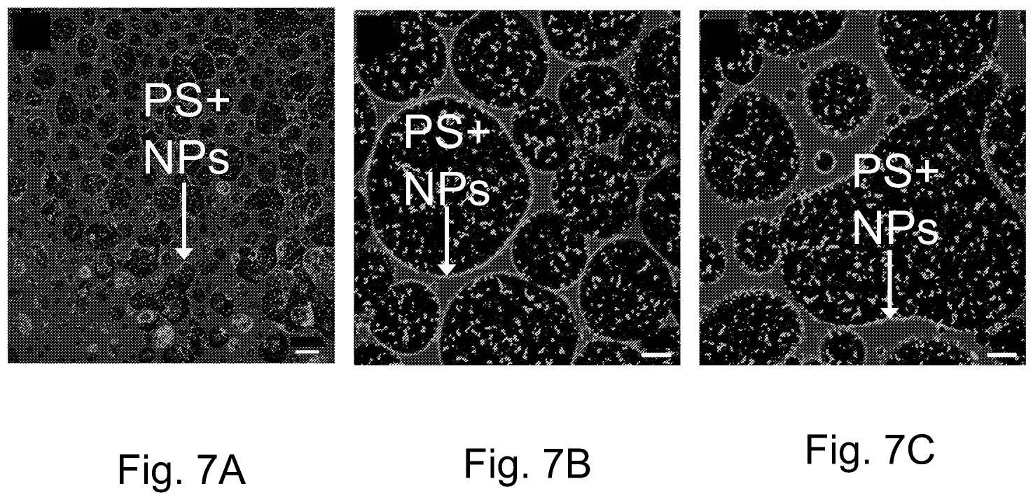

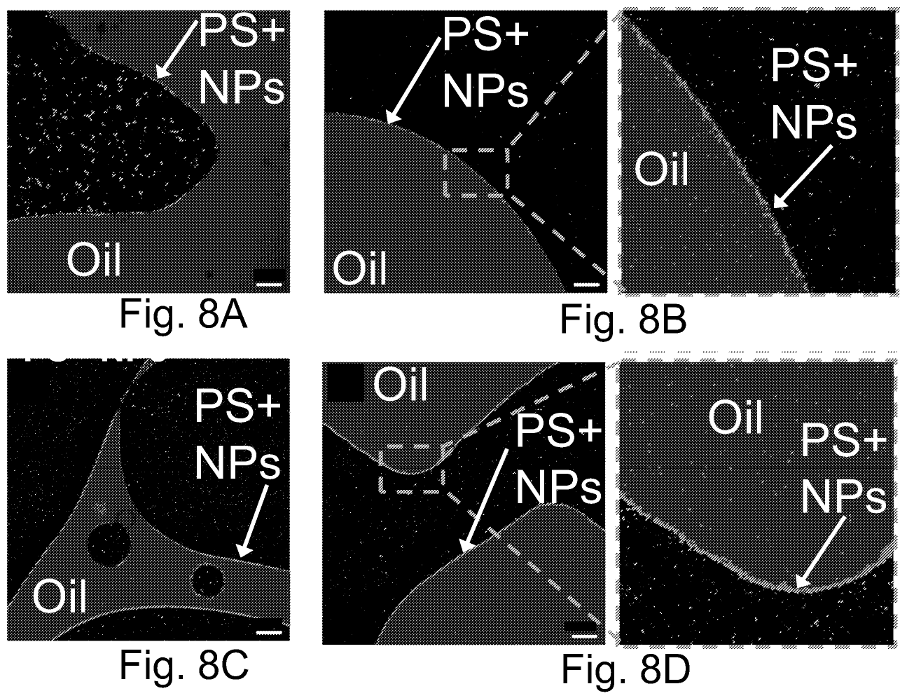

First, the z-potential of the NPs suspensions and the model oil in these different environments was measured. As Table 1 shows, increasing the ionic strength resulted in a decrease of the charge in both NPs and model oil, but both the NPs and the model oil remained oppositely charged (+10 and −9 mV, respectively). The confocal images of FIGS. 6A-6B, 7, and 8 confirm that the NPs segregated at the interface, albeit to a lesser extent compared to the DI water and was consistent with the lowering of the charges on both the NP and model oil surfaces.

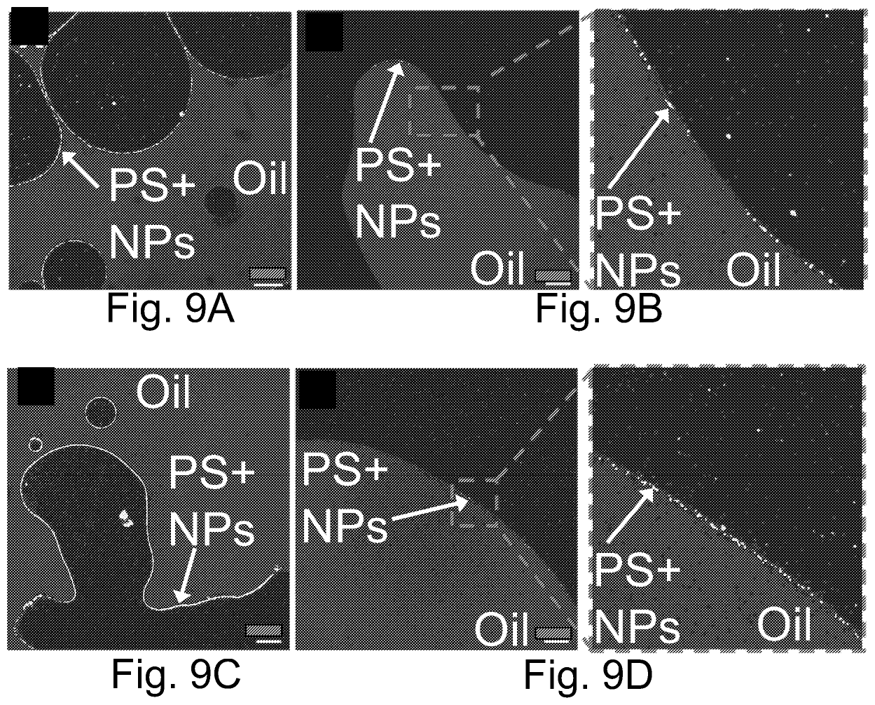

The effect of sodium chloride as the most predominant salt for various industries has been further investigated. To that end, brines with 1 and 5% NaCl were used to prepare PS+ suspensions and mixed with the model oil (FIGS. 9A-9D). The zeta potential measurements (Table 2) showed, like the seawater, the electrostatic screening increased with increasing the salt concentration led to a lesser extent of NPs attachment to the interface. But even at 5%, both NPs and model oil remained oppositely charge to ensure the NPs segregation at the interface (FIGS. 9A-9B).

Effect of pH on the NPs Assembly. Next, the effect of pH on the directed assembly was addressed. As Table 4 highlights the pH affected the charges on positively and negatively charged NPs as well as the model oil.

TABLE 4
Zeta-Potential (mV) at Different pH Environments.

| pH | Crude Oil | Model Oil | Polystyrene (+) | Polystyrene (−) |
|---|---|---|---|---|
| 2 | −2 | 0 | +58 | 0 |
| 4 | −18 | −14 | +44 | −30 |
| 7 | −21 | −24 | +41 | −43 |

Lowering the pH decreased the charge on the model oil and the negatively charged NPs and increased the charge on the positive NPs. At pH 2 the values for the model oil, PS+ and PS− were 0, +58, and 0, respectively.

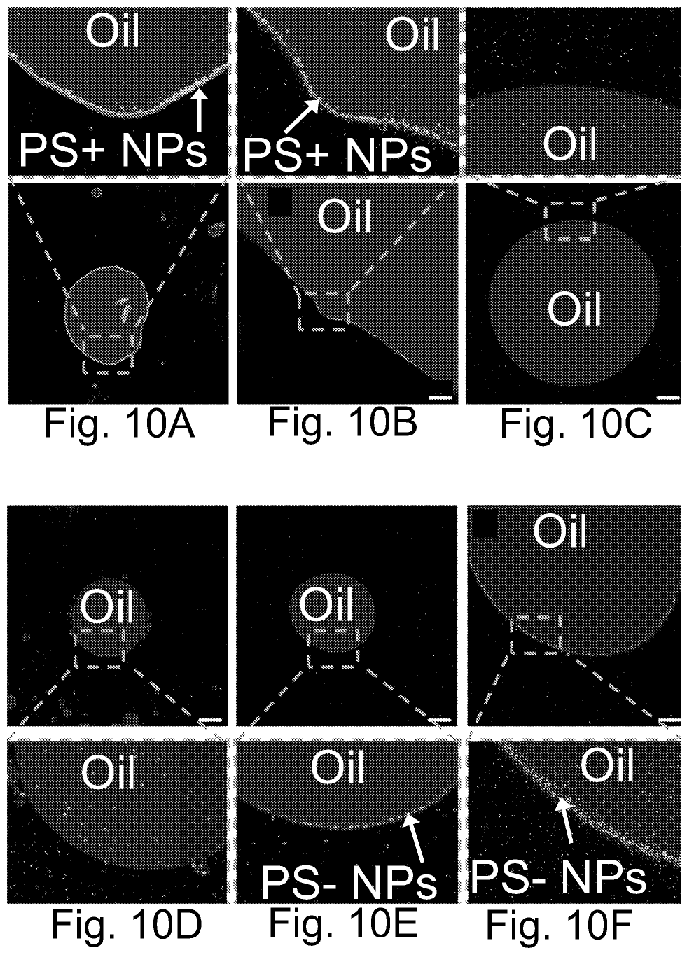

At pH 4 and 7, the surface of the oil was deprotonated and appeared negative, while the ammonium decorated PS+ NPs were always protonated and positive. The charge complementarity gave rise to strong electrostatic interactions and led to uniform decoration of PS+ at the oil interface (FIGS. 10A-10B) with higher charges on opposite surfaces leading to a stronger effect. However, under strong acidic conditions (pH ˜2) when the model oil became neutral no NPs were attracted to the interface despite the high charge on the NPs (FIG. 10C).

Interestingly at pH 2, the sulfonate PS− NPs, which became neutral under these conditions, were still attracted at the interface (FIG. 10F). It is believed that the directed assembly, in this case, was the result of H-bonding between the two neutral surfaces (NPs and model oil).

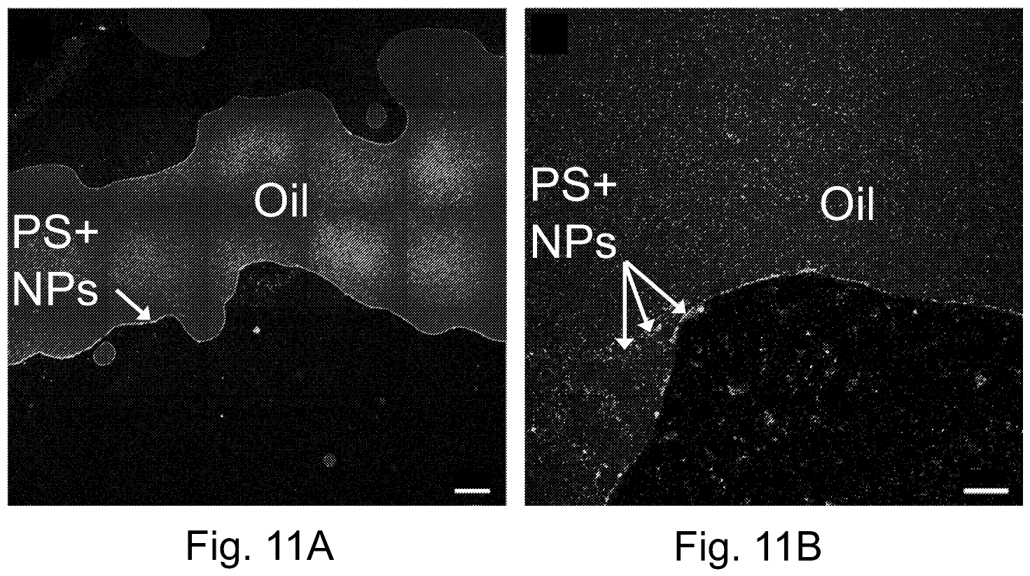

Release and Targeted Delivery. Owing to the interest in targeted delivery of chemicals, 100 ppm of PS+ in DI water (1 ml) were mixed with an equal amount of model oil for 24 h and imaged using the confocal microscope (FIGS. 11A-11B). Since Nile red was not covalently bonded to the NPs, and due to its hydrophobic nature, it could leach out and diffuse into the oil phase. Note that, when the dye was covalently bonded and thus contained in the NPs, it cannot reach the bulk of the model oil phase. These experiments clearly demonstrated that after docking the NPs at the interface, they released appropriately loaded cargo. This design feature can be exploited in various applications and industries, including the delivery of surfactants or other chemicals and drugs.

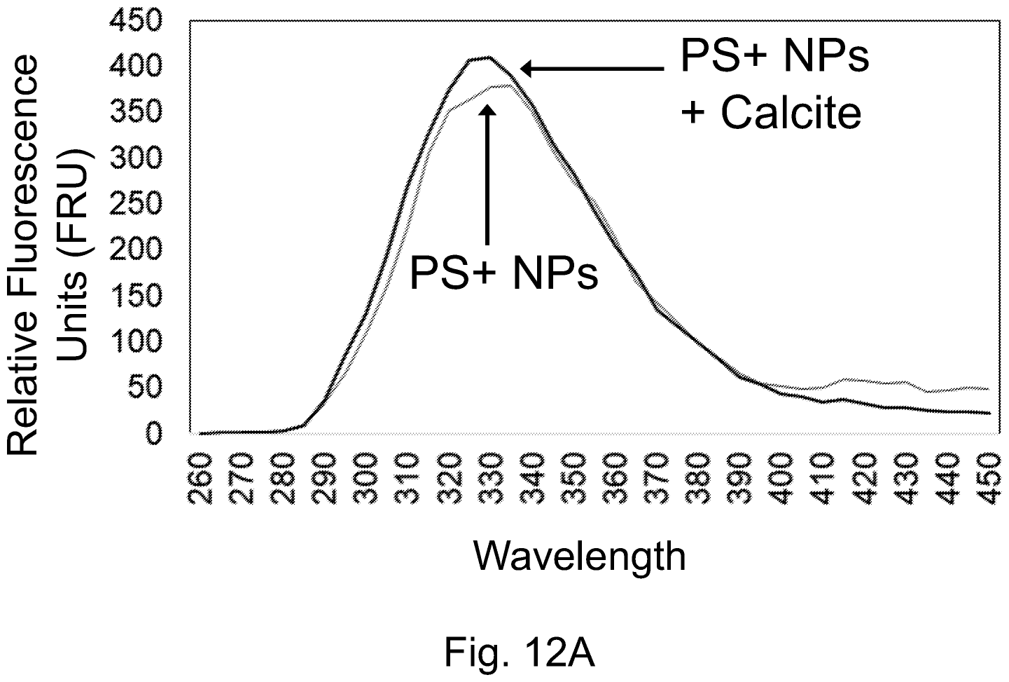

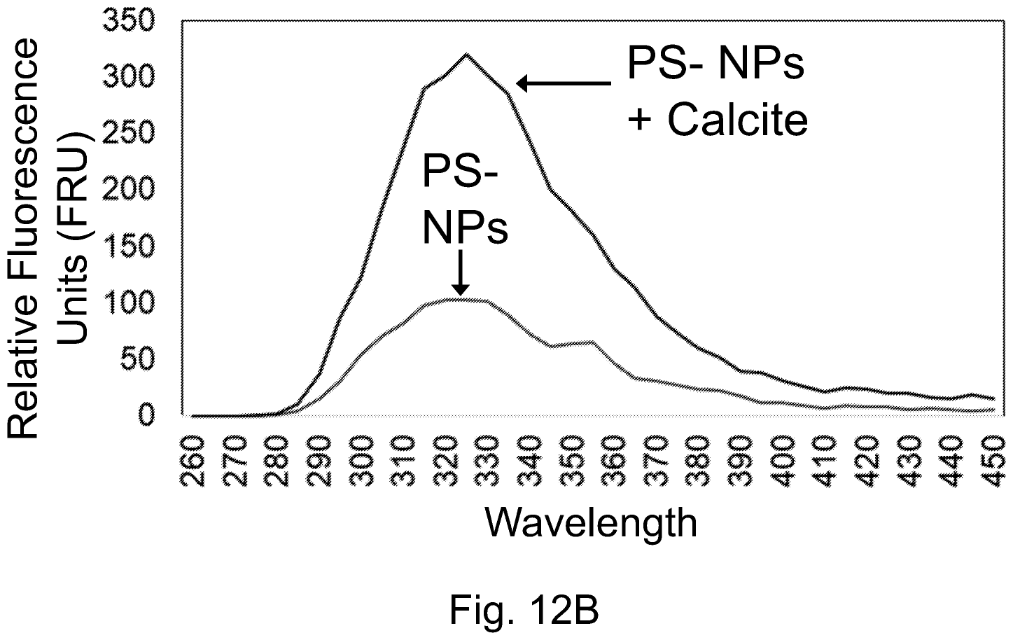

To evaluate the potential use of these NPs in enhanced oil recovery, where delivery of the NPs deep into the reservoir is a requirement, the stickiness of the NPs onto calcite, a mineral present in carbonate reservoirs, was also investigated. A suspension of the nanoparticles was mixed with crashed calcite and aliquots of the supernatant were analyzed by fluorescence spectroscopy for any changes in the fluorescence intensity of the nanoparticles (FIGS. 12A-12B). Consistent with its positive zeta potential (+11 mV), negatively charged NPs appeared to stick to calcite, as evidenced by the decrease in the fluorescence intensity. Importantly, a minimum attachment was observed for positively charged NPs (a trivial decrease in fluorescent intensity was observed), a significant finding because it suggests that properly designed NPs can overcome the major limitation of mineral adsorption during deployment.

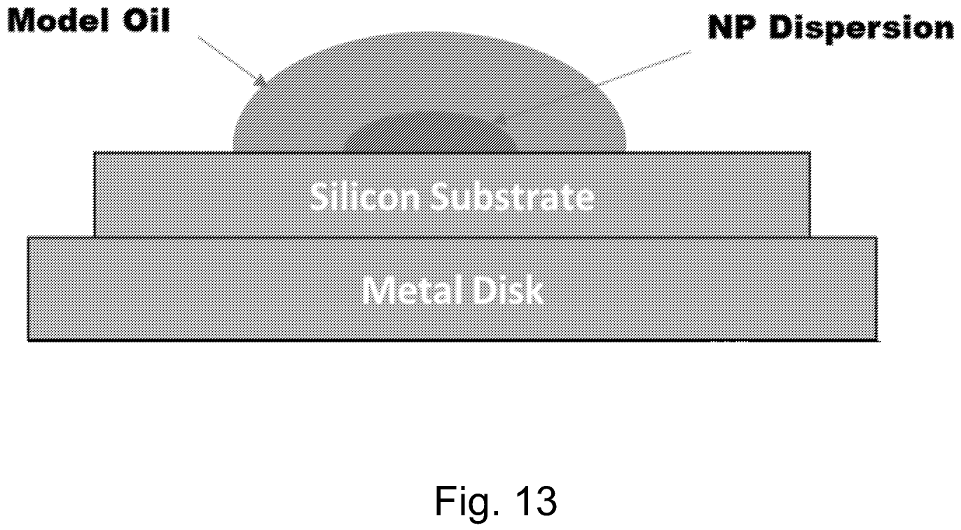

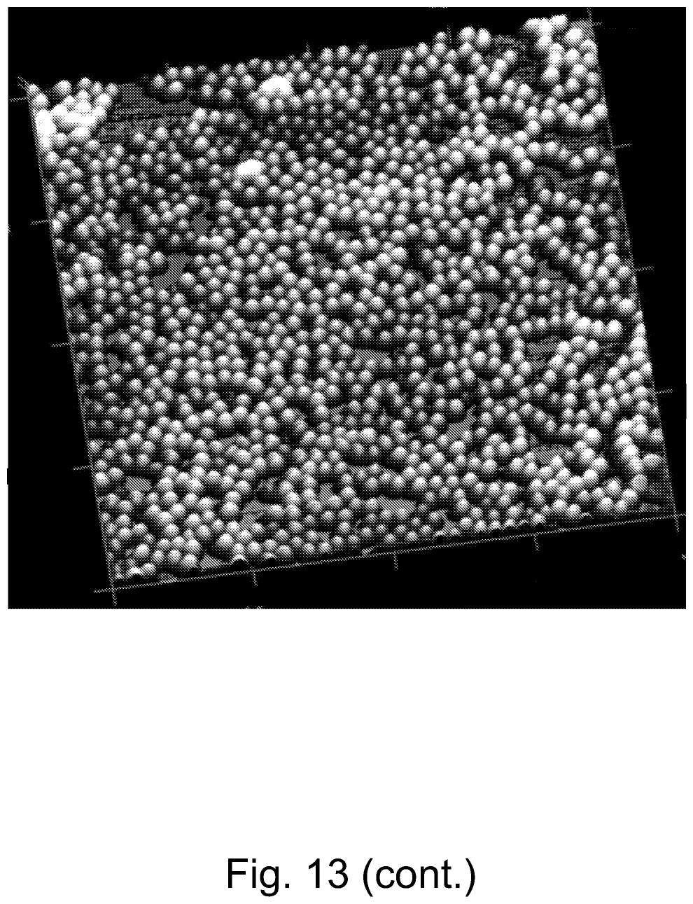

In addition to confocal microscopy, atomic force microscopy (AFM) was performed to provide direct visualization of the NP assembly. The AFM tip was immersed through the aqueous phase and brought into contact with the liquid-liquid interface (FIG. 13). The AFM images in FIG. 13 show that an almost complete monolayer coverage of positively charged polystyrene NPs decorated the interface.

In summary, a system for controlled assembly and targeted delivery has been demonstrated. Positively charged nanoparticles assembled preferentially at the oil/water interface by fine tuning the electrostatic interactions with the negatively charged carboxylic groups in the (model) oil. The electrostatic interactions were modulated by changing the ionic strength of the electrolyte or the pH. After assembly the NPs released appropriately loaded cargo paving the way for a number of potential applications in diverse fields including targeted delivery of surfactants to reduce interfacial tension and manipulate the interface properties.

Experimental Section: Materials. Hexadecane, Nile red, 4,4Bis(2-benzoxazolyl) dye, stearic acid, sodium chloride (NaCl), calcium chloride dihydrate (CaCl₂.2H₂O), magnesium chloride hexahydrate (MgCl₂.6H₂O), sodium sulfate (Na₂SO₄) and sodium bicarbonate (NaHCO₃) were purchased from Sigma-Aldrich and used without further purification.

Preparation of PS NPs. Polystyrene nanoparticles were synthesized via free radical miniemulsion polymerization. Nile red was incorporated into the PS NPs to turn them fluorescent. Positively and negatively charged NPs were synthesized using an ionic initiator and copolymerization of the corresponding ionic functional monomers. Briefly for the positively charged PS NPs, 0.64 g of [2-(acryloyloxy)ethyl] trimethylammonium chloride, 0.75 g of N-dodecyl-N,N-dimethyl-3-ammonio-1-propanesulfonate, 0.2 g of cetyl trimethylammonium bromide (CTAB), and 0.75 g of 2,2′-azobis(2-methylpropionamidine) dihydrochloride were dissolved in 300 g of DI water. The oil phase containing 60 g of styrene, 1 mg of Nile red, and 2 g of hexadecane was added to the aqueous solution and sonicated using a Branson Ultrasonics 450 Digital Sonifier for 15 min. The obtained milky emulsion was purged with N₂, heated to 67° C. and kept at that temperature for 12 h. The resulting PS NPs were purified via dialysis against DI water.

The negatively charged PS NPs were synthesized similarly except that 1.08 g of 3-allyloxy-2-hydroxy-1-propanesulfonic acid sodium salt solution, 0.58 g of sodium bicarbonate and 0.85 g of sodium persulfate were used for the aqueous phase.

Preparation of the model oil. 0.01M stearic acid was dissolved in hexadecane by stirring overnight at 50° C. 4,4-Bis (2-cetyltrimethylammonium) dye was used to label the model oil for the confocal microscopy imaging.

Apparatus and methods. Transmission Electron Microscopy (TEM) images were obtained using an FEI Tecnai 12 BioTwin microscope. Confocal microscopy images were obtained using a Zeiss LSM 710 confocal laser scanning microscope with a Plan-Apochromat×25, 1.40 water-immersion objective. Nile red and a 4,4Bis(2-benzoxazolyl) fluorescent dye were introduced in the PS nanoparticles and model oil, respectively, to make them fluorescent. Emulsions were prepared by vertexing a 1:1 mixture of an aqueous suspension prepared by adding different amounts of the NPs into DI water or brine and model oil (Hexadecane+0.01M stearic acid). To conduct the confocal experiments, a few ml of the emulsion were placed between two coverslips and placed subsequently on the microscope for imaging. Zeta Potential Measurements and Dynamic Light Scattering Measurements were carried out utilizing Zetasizer Nano ZS90 (Malvern Instruments).

### EXAMPLE 2

The following is an example of charged polymeric particles (e.g., nanoparticles, microparticles, or the like, or any combination thereof) of the present disclosure and methods of producing and using said charged polymeric particles (e.g., nanoparticles, microparticles, or the like, or any combination thereof).

In various examples, a system combines into a single platform, both controlled assembly and targeted delivery. The directed assembly of positively-charged, amine-functionalized polystyrene nanoparticles, PS NPs, at the oil/water interface was accomplished by introducing carboxylic acid functional groups in the oil phase. The electrostatic interactions between the ammonium groups on the NPs and the carboxylic groups on the oil surface were supported by zeta potential measurements and confirmed by laser scanning confocal microscopy. In contrast, negatively-charged, sulfonate-functionalized PS NPs failed to assemble at the interface and remain in the aqueous phase under the same conditions. By tuning the pH or the ionic strength of the medium, the extent of the interactions between the NPs and the oil surface was modulated. After assembly at the oil-water interface, the NPs released appropriately loaded cargo including surfactant molecules. The released surfactant led to the formation of a much finer oil-water emulsion. In various examples, this unique design feature can be exploited in various applications in fields ranging from pharmaceutical and cosmetics to hydrocarbon recovery and oil-spill remediation. For example, the controlled delivery of surfactant molecules, specifically at the oil/water interface, is of tremendous practical importance in oil spill remediation, removal of contaminants from soil as well as enhanced oil recovery.

Herein, an efficient and scalable method is reported to direct assemble NPs at the oil/water interface by fine-tuning the electrostatic interactions between the oil and the NPs (FIG. 1). The assembly of positively-charged PS NPs facilitated by introducing negatively charged, carboxylate groups in the oil (by adding stearic acid to produce model oil) was investigated by confocal microscopy and atomic force microscopy. The electrostatic interactions were modulated by employing different salinity electrolytes or by tuning the pH of the aqueous phase.

After assembly, the NPs released their cargo, demonstrating a system that combines into a single platform both controlled assembly and targeted delivery. More specifically, the targeted release of octadecylamine has been demonstrate as a means to emulsify an oil-water mixture. Beyond adding to the fundamental understanding of ways to manipulate and control oil/water interfaces, this paves the way to a wide number of practical applications including hydrocarbon recovery and environmental remediation.

Synthesis and characterization of Nile red Polystyrene NPs. Fluorescent, water-dispersible polystyrene nanoparticles were synthesized via free-radical emulsion polymerization in water using Nile red. Nile red was selected to distinguish the NPs from the oil phase, which was labeled with a blue, fluorescent dye. The fluorescent labels allow for direct imaging via Laser Scanning Confocal Microscopy, LSCM. Quaternary ammonium or sulfonate functional comonomers were used to produce either positively—(PS+) and negatively—(PS−) charged polystyrene nanoparticles, respectively. Both NP systems were dispersible in water and brine.

Dynamic light scattering, DLS, measurements showed that the nanoparticles were relatively monodisperse with a diameter of 144 and 122 nm for PS+ and PS−, respectively. The DLS measurements were consistent with the sizes obtained from TEM (FIG. 2). The zeta potential in DI water was +41 mV and −43 mV for the PS+ and PS− nanoparticles, respectively.

Segregation and Attachment of the NPs' at the oil-water interface. To investigate the directed assembly mechanism, how NPs interact with a model oil-water mixture was studied. The selection of model oil was based on the necessity to introduce functional groups into the oil phase as well as to simulate crude oil behavior typically encountered in the field. Recall that the model oil is prepared by adding stearic acid in hexadecane. In the presence of water, the carboxylate groups segregate at the interface rendering the oil surface negatively-charged with a z-potential of −24 mV. Given its negative charge (Tables 1 and 2), positively-charged NPs at two different concentrations (100 and 1,000 ppm) in DI water were investigated.

When an equimolar mixture of water and model oil was vigorously agitated in a vortex mixer, it formed a non-uniform emulsion, which phase-separated quickly into the two immiscible phases. In contrast, when positively-charged NPs were added in the aqueous phase a different behavior was observed. LSCM images are shown in FIG. 3 for an equal volume mixture of model oil and DI water in the presence of positively-charged NPs at two different concentrations (1000 ppm, FIGS. 3A-3B) and (100 ppm, FIG. 3C). The images show clearly that the positively-charged NPs tended to segregate at the oil-water interface attracted by the negatively charged carboxylate groups in the oil phase (Table 1). For the 1000 ppm suspension, in addition to their presence at the interface, NPs can also be seen in the water phase probably due to an excess of NPs. These results are contrasted with experiments contradicted with the negatively-charged, sulfonate-functionalized PS NPs under the same conditions. FIG. 3D shows that in the absence of a driving force the negatively charged NPs were not directed to the oil-water interface and stayed dispersed in the water phase. These experiments confirmed a hypothesis that complementarity of charges does provide the necessary interactions and binding and it is necessary for the successful directed assembly at the interface.

Further evidence was provided by three-dimensional confocal imaging (z-scans). FIG. 4 is a confocal z-stack of an oil droplet showing separately the fluorescence of the NPs (red, left) and the oil (blue, middle), and then an overlap of the two (right). Three different images are presented corresponding to the bottom, middle, and the top of the oil droplet (FIG. 4). The imaging of the oil droplet at different depths demonstrates that the red fluorescent NPs decorated uniformly the surface of the model oil droplet (blue fluorescence).

In addition to confocal microscopy, atomic force microscopy (AFM) was performed to provide direct visualization of the NP assembly. The AFM tip was immersed through the aqueous phase and brought into contact with the liquid-liquid interface (FIG. 13). The AFM images in FIG. 13 show an almost complete monolayer coverage of polystyrene NPs decorating the interface.

Effect of Salinity on NP Assembly. To evaluate the effect of salinity on the directed assembly, a series of NP suspensions of varying ionic strength were used in the place of DI water. To that end, three different NP suspensions in a mixture of electrolytes simulating seawater (100% seawater) (the corresponding salt concentrations are given in Table 3) as well as lower salinities (50% and 20% seawater) were tested. Since ionic strength affects charge screening, the z-potential of the NPs suspensions and the model oil in these different environments were measured and the results are presented in Table 1. Increasing ionic strength resulted in a decrease of the charge in both NPs and model oil, but both the NPs and the model oil remained oppositely charged (+10 and −9 mV, respectively) even when the highest salinity brine was used. As expected, the NPs were still attracted to and segregated at the interface, (FIGS. 6-8), albeit with a lower coverage compared to that in DI water and consistent with the lowering of the charge on both the NP and model oil.

The effect of sodium chloride on the process as one of the most common electrolytes used was also investigated. To that end, suspensions of PS+ in the presence of various concentrations of NaCl (1 and 5 wt. %) were prepared and mixed with the model oil. Similar to the case of seawater, NaCl screens the surface charges and the zeta-potential of both systems decreased with increasing salt concentration. Nevertheless, the weaken ionic interactions between the positively charged PS nanoparticles and the model oil were still operable and forced the NPs to the interface. The degree of segregation and assembly at the interface became less with increasing NaCl concentration consistent with the reduced charge on both the NPs and the model oil (FIG. 9).

Effect of pH on the NPs Assembly. Next, the effect of pH on the process was addressed. As expected the pH affected the charges on both the positively- and negatively-charged NPs as well as the model oil (Table 4). Lowering the pH decreased the charge on the model oil and the negatively charged NPs. In contrast, lowering the pH increased the charge on the positive NPs. At pH 2 the model oil and the originally negatively charged PS became neutral (z-potential ˜0 mV) while the z-potential of PS+ was +58 mV.

At pH 7, the carboxylic groups were deprotonated and the surface of the oil was negative, while the ammonium decorated PS+ NPs were protonated and positive. The same was true for pH 4 although the charge was somewhat lower. The charge complementarity on the NPs and the oil surface gave rise to strong electrostatic interactions and led to a uniform decoration of PS+ NPs at the interface (FIGS. 10A-10B) with the higher charges on opposite surfaces leading to a stronger effect (pH 7 vs pH 4). However, under strong acidic conditions (pH ˜2), the model oil became neutral and no positively charged NPs were attracted to the interface despite the high charge on the NPs (FIG. 10C).

Recall that the sulfonate decorated, negatively charged NPs were not attracted to the negatively-charged oil surface and no assembly took place at the oil-water interface (FIGS. 10D-10E). Interestingly at pH 2, where both the sulfonate PS NPs and the oil surface became neutral, the NPs assembled at the interface (FIG. 10F). It is believed the assembly, in this case, was the result of H-bonding between the NP and neutral oil surfaces (rather than the electrostatic attractions as discussed above).

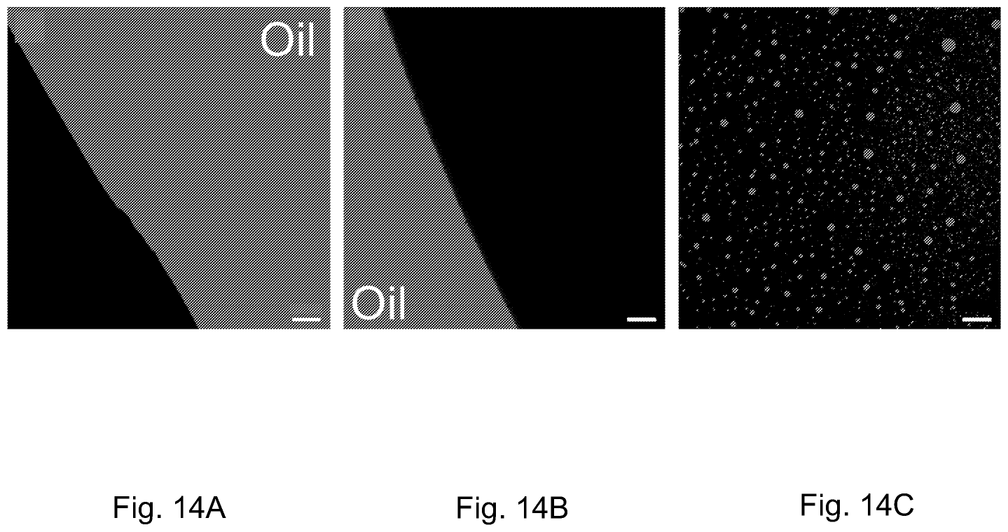

Targeted Delivery and Release. Owing to interest in targeted delivery, the potential of the assembled NPs to release their cargo locally was studied. More specifically, the targeted release and delivery of surfactants as a means to emulsify an oil-water mixture was evaluated. To that end, octadecylamine (ODA, C₁₈H₃₇NH₂), with its relatively long hydrocarbon chain was encapsulated in the core of PS+ NPs during the synthesis. A suspension of 100 ppm of the ODA-PS+ in DI water were mixed with an equal amount of model oil and imaged using a confocal microscope right after mixing and after 24 h (FIGS. 14B-14C). For comparison, the image of a model oil-DI water mixture in the absence of the NPs was also included (FIG. 14A). As can be seen, mixing the model oil with water led to a large-scale phase separation (FIG. 14A). When the NPs were added to the aqueous phase and an image was taken right after mixing with the oil (FIG. 14B), the phase separation did not seem to be very much affected by the positively charged polystyrene NPs, which tended to assemble at the oil-water interface (see discussion above). In contrast, after 24 hours a finer oil-water emulsion with much smaller oil droplets was formed (FIG. 14C). The emulsification was attributed to the release and diffusion of ODA from the NPs into the oil phase. In other words, the positively charged NPs assembled at the oil-water interface driven by the electrostatic interactions and released their cargo. This demonstrated both a targeted and controlled delivery of surfactants to enhance emulsification.

The stickiness of the NPs onto calcite, a mineral present in carbonate oil reservoirs was also investigated. A suspension of the nanoparticles was mixed with crashed calcite and aliquots of the supernatant were analyzed by fluorescence spectroscopy for any changes in the fluorescence intensity of the suspension (FIG. 12). A decrease in fluorescent intensity of the suspension will signal adsorption by the calcite surface. Consistent with the positive zeta-potential of calcite (+11 mV), negatively charged NPs appeared to stick to calcite, as evidenced by the decrease in the fluorescence intensity of the suspension. In contrast, a minimum attachment was observed for positively charged NPs (a trivial decrease in fluorescent intensity was observed). This is a significant finding because it suggests that properly designed NPs can overcome the major limitation of mineral adsorption during deployment and be able to effectively target the release of surfactant molecules in situ at the oil-water interface.

In summary, a system for controlled assembly and targeted delivery has been demonstrated. Positively charged nanoparticles assembled preferentially at the oil/water interface by fine-tuning the electrostatic interactions with the negatively charged carboxylic groups added in the oil (model oil). The electrostatic interactions were modulated by changing the ionic strength of the aqueous phase or the pH. After assembly, the NPs released appropriately loaded cargo paving the way for a number of potential applications in diverse fields including targeted delivery of surfactants. The latter can be exploited to reduce interfacial tension and manipulate the interface properties of oil-water mixtures.

Experimental Section. Materials. Hexadecane, Nile red, 4,4Bis(2-benzoxazolyl) dye, stearic acid, sodium chloride (NaCl), calcium chloride dihydrate (CaCl₂.2H₂O), magnesium chloride hexahydrate (MgCl₂.6H₂O), sodium sulfate (Na₂SO₄) and sodium bicarbonate (NaHCO₃) were purchased from Sigma-Aldrich and used without further purification.

Preparation of PS NPs. Polystyrene nanoparticles were synthesized via free radical miniemulsion polymerization. Nile red was incorporated into the PS NPs to render them fluorescent. Positively or negatively charged NPs were synthesized using an ionic initiator and copolymerization of the corresponding ionic functional monomers. Briefly, for the positively-charged PS NPs, 0.64 g of [2-(acryloyloxy) ethyl] trimethylammonium chloride, 0.75 g of CTAB and 0.75 g of 2,2′-azobis(2-methylpropionamidine) dihydrochloride were dissolved in 300 g of DI water. The oil phase containing 60 g of styrene, 1 mg of Nile red, and 2 g of hexadecane was added to the aqueous solution and sonicated using a Branson Ultrasonics 450 Digital Sonifier for 15 min. The obtained milky emulsion was purged with N₂, heated to 67° C. and kept at that temperature for 12 h. The resulting PS NPs were purified via dialysis against DI water. The ODA-PS NPs were synthesized similarly except that 3 g of octadecylamine (ODA) were added to the oil phase.

The negatively-charged PS NPs were synthesized similarly except that 1.08 g of 3-allyloxy-2-hydroxy-1-propanesulfonic acid sodium salt solution, 0.58 g of sodium bicarbonate and 0.85 g of sodium persulfate were used for the aqueous phase.

Preparation of the model oil. 0.01M stearic acid was dissolved in hexadecane by stirring overnight at 50° C. 4,4-Bis (2-cetyltrimethylammonium) dye was used to add a fluorescent label for the confocal microscopy imaging.

### EXAMPLE 3

The following is an example of charged polymeric capsules (e.g., nanocapsules, microcapsules, or the like, or any combination thereof) and charged polymeric particles (e.g., nanoparticles, microparticles, or the like or any combination thereof) of the present disclosure and methods of producing and using said charged polymeric capsules (e.g., nanocapsules, microcapsules, or the like or any combination thereof) and charged polymeric particles (e.g., nanoparticles, microparticles, or the like or any combination thereof).

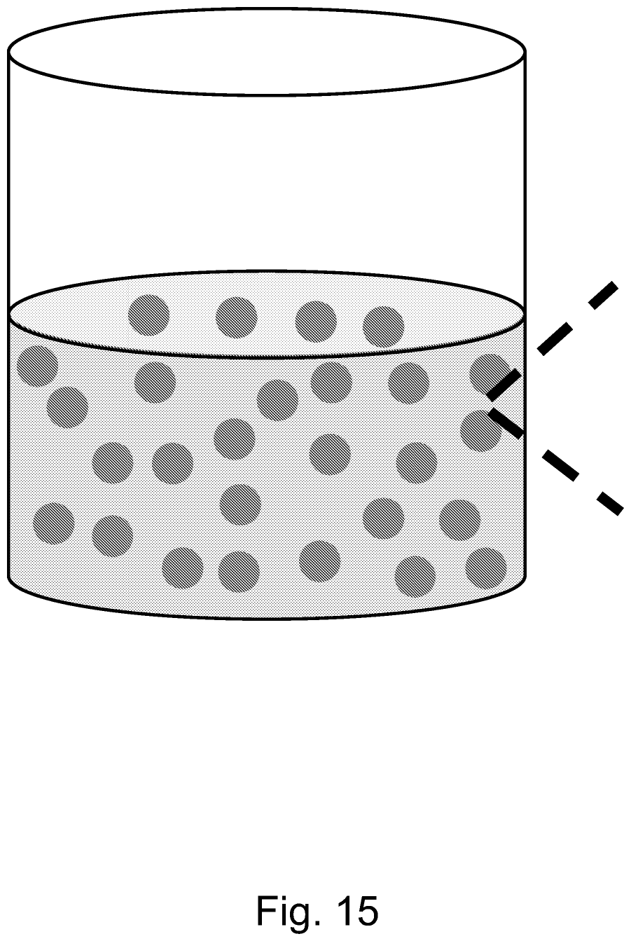

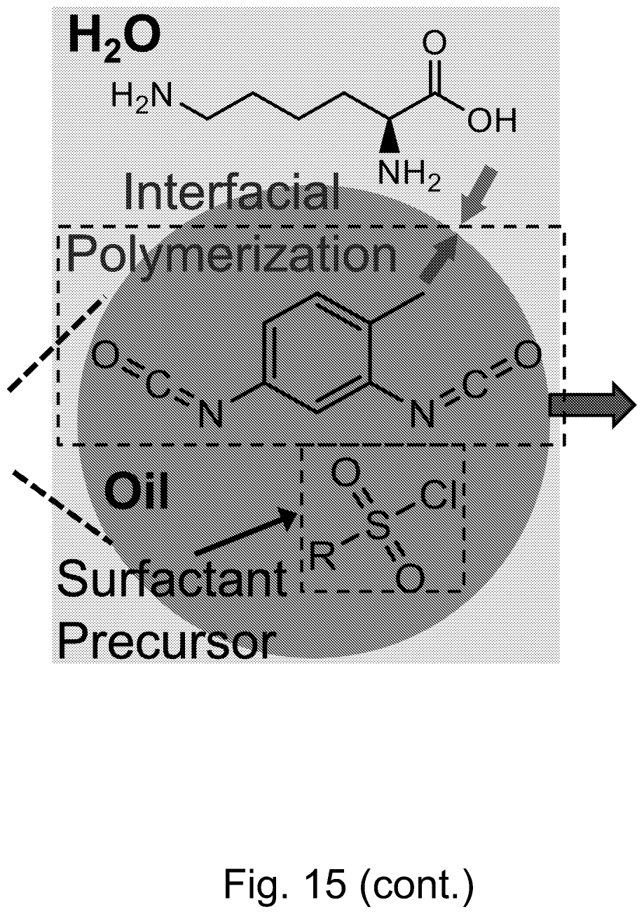

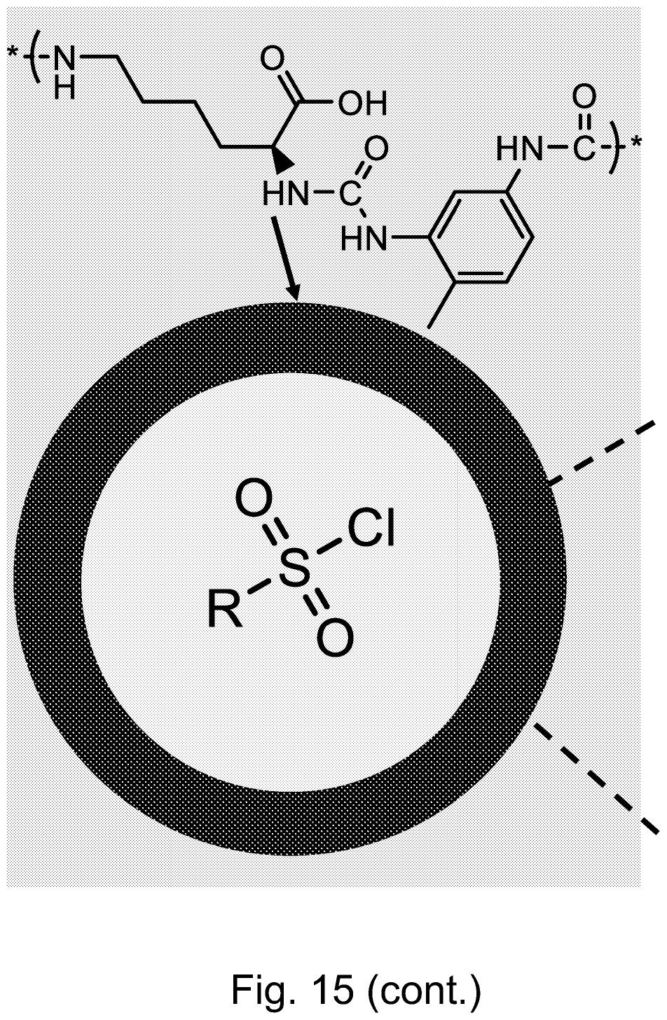

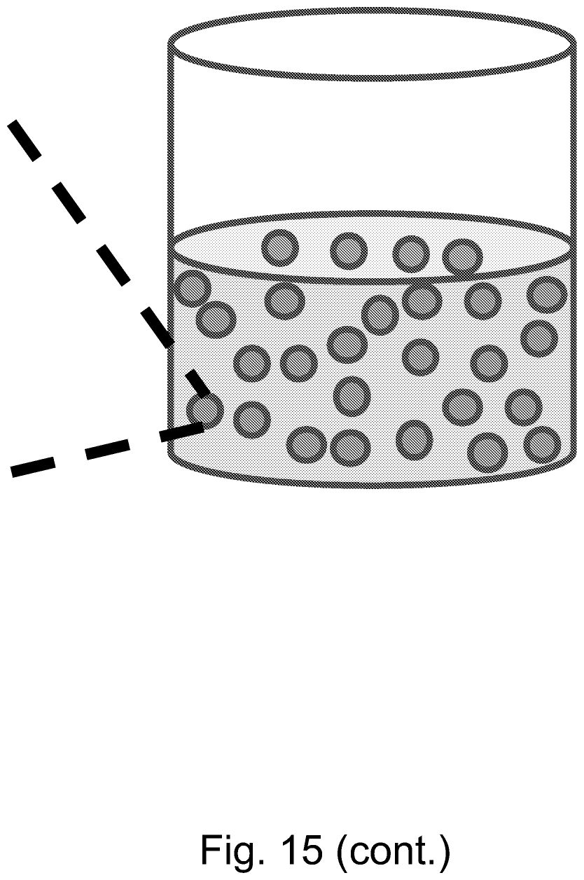

Synthesis of charged polymeric capsules (e.g., nanocapsules, microcapsules, or the like, or any combination thereof) loaded with acid/emulsifier precursors. Nanocapsules were synthesized via interfacial emulsion polymerization (FIG. 15). In an illustrative synthesis, the aqueous phase containing 12 g of deionized water, 0.1 g of CTAB and 0.26 g of lysine was stirred at 50° C. for 1 hour. The oil phase containing 0.25 g of hexadecane, 1.3 g of xylene, an acid/emulsifier precursor (e.g., 1.3 g of 1-dodecanesulfonyl chloride), and 0.48 g of isophorone diisocyanate, was added to the aqueous phase solution and then sonicated by a Branson digital sonifier 450 for 3 min. The obtained emulsion was stirred overnight at 200 rpm at room temperature to generate the positively charged nanocapsules incorporated with an acid/emulsifier precursor. The size of the nanocapsules was ˜160 nm with zeta potential of ˜+35 mv.

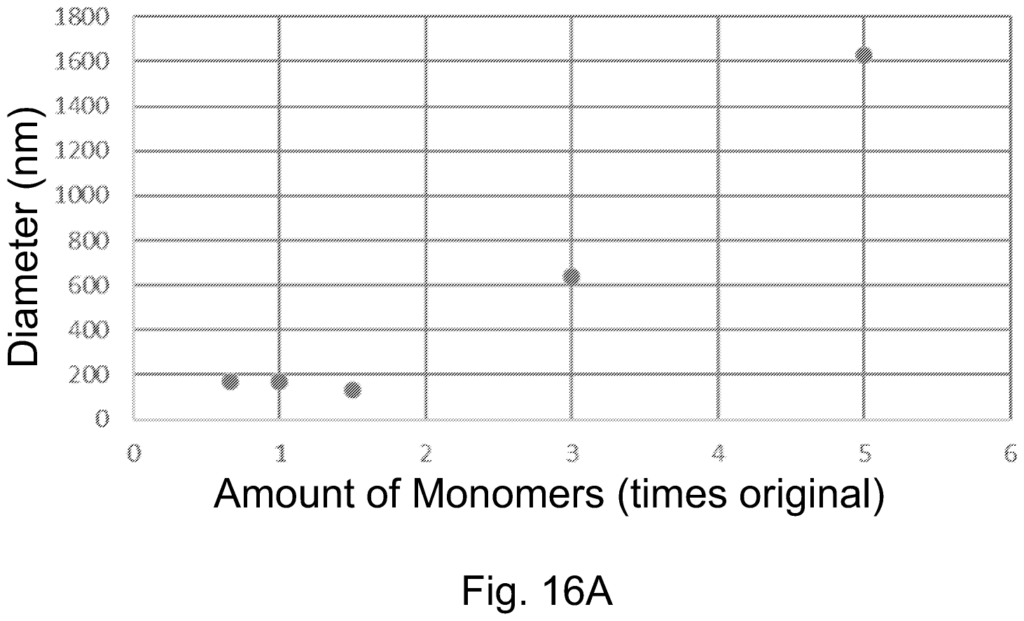

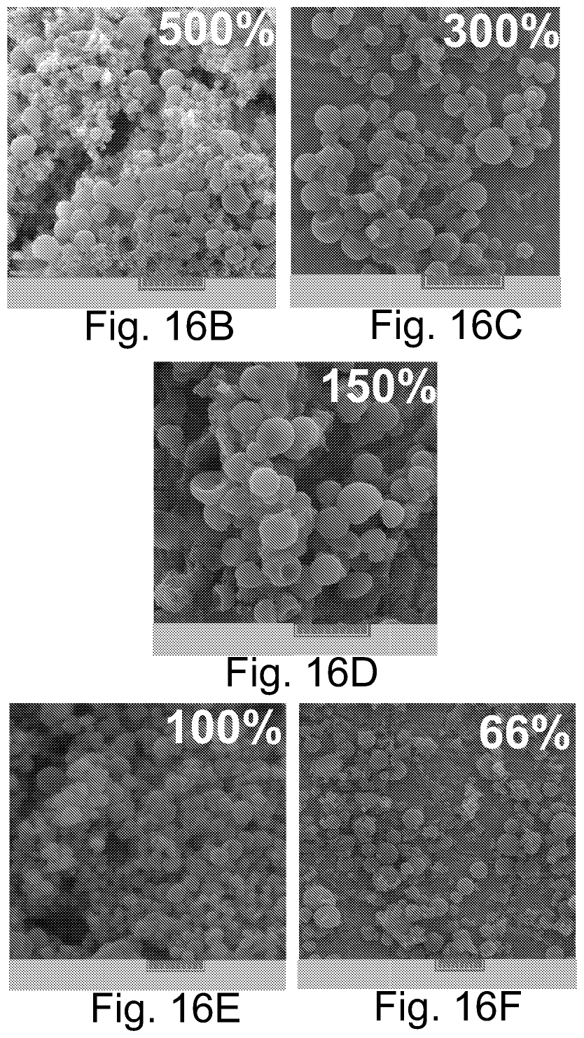

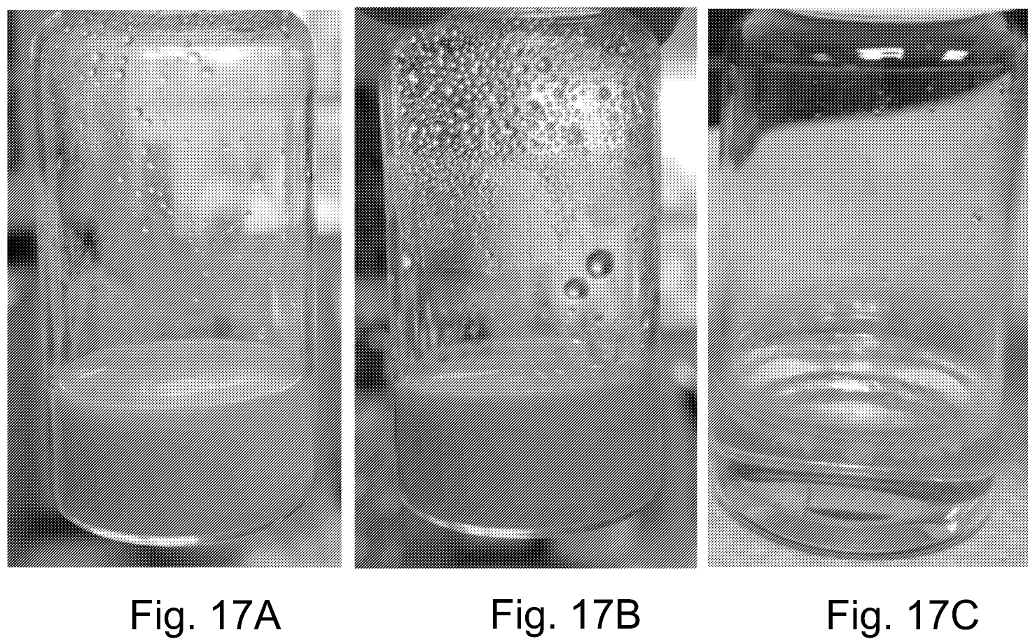

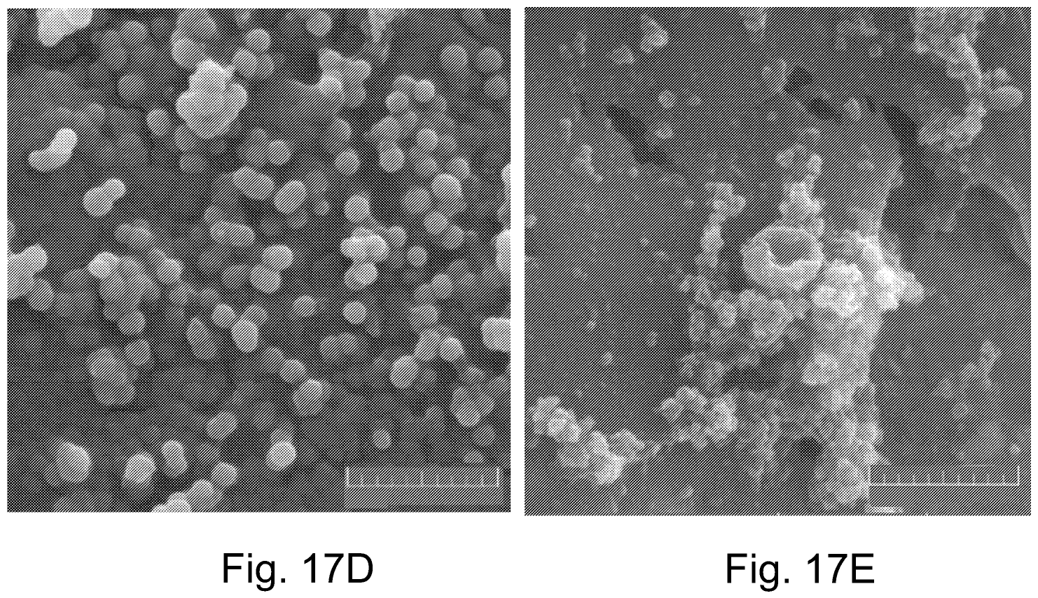

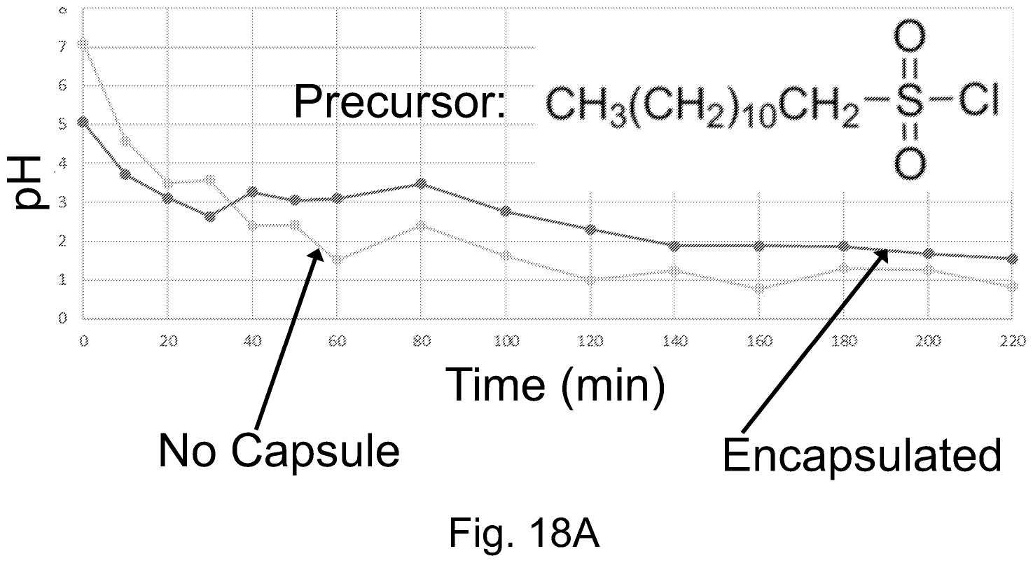

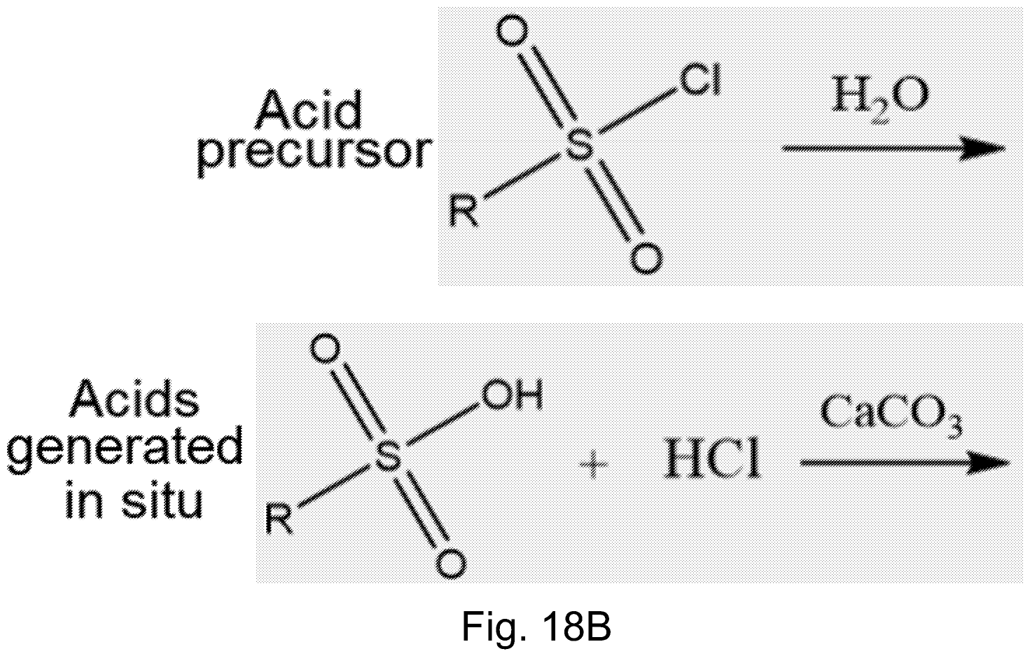

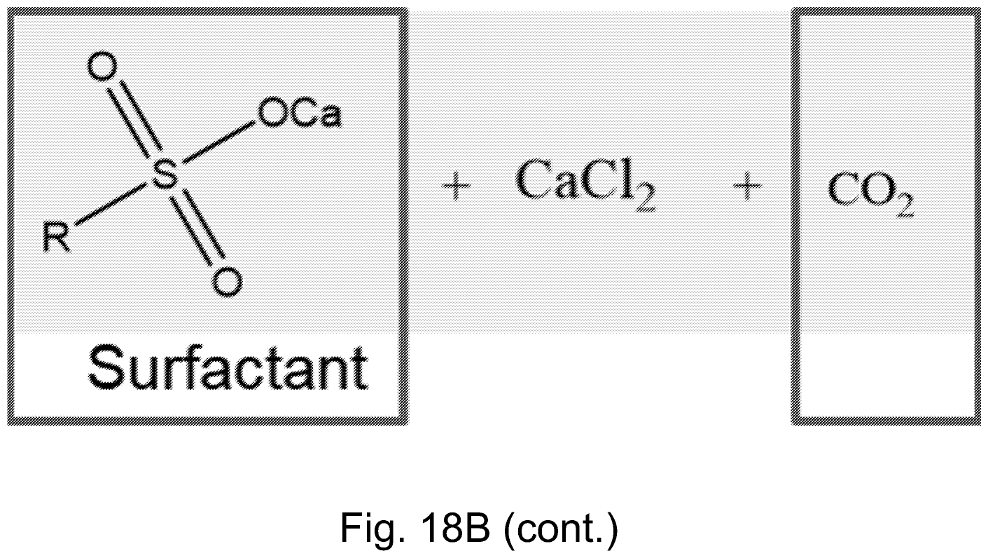

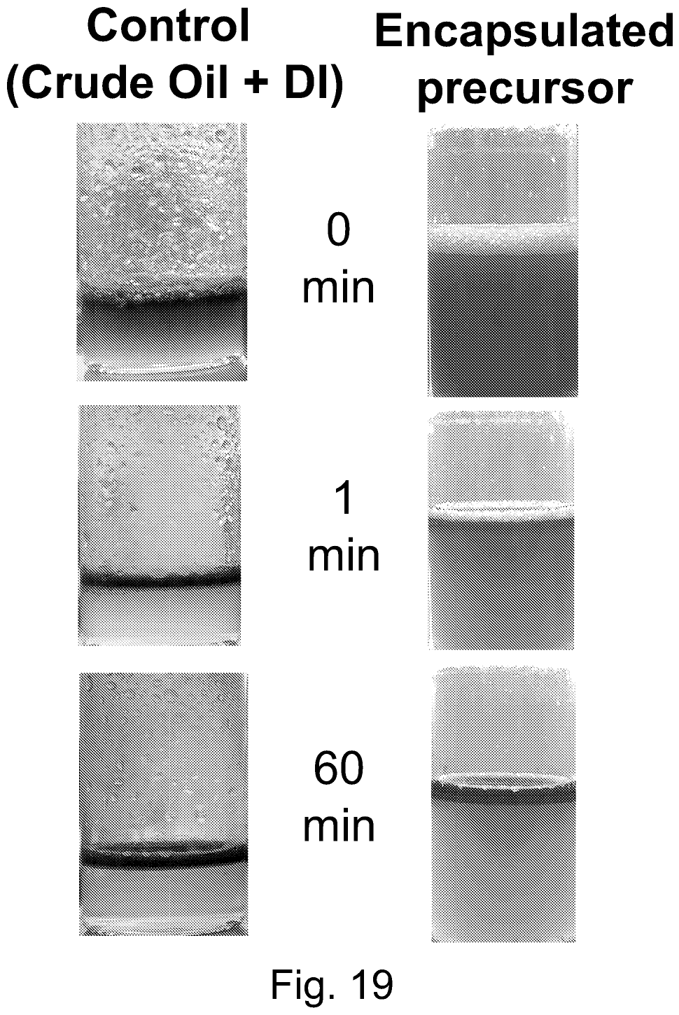

The size of the capsules was tunable by changing the amount of surfactant and the monomers making the shell (FIGS. 16A-16F). FIGS. 16A-16F show an effect of monomer concentration on size of hydrolyzable capsules: (FIG. 16A) a chart of monomer concentration versus capsule dimension (nm). SEM images of hydrolysable microcapsules (MCs) prepared with (FIG. 16B) 500% of an original amount of monomer and SEM images of hydrolyzable nanocapsules (NCs) prepared with (FIG. 16C) 300%, (FIG. 16D) 150%, (FIG. 16E) 100%, and (FIG. 16F) 66% of an original amount of monomer. FIGS. 17A-17E show hydrolyzable capsules undergoing hydrolysis in saline solution (FIG. 17A) at RT at t=0 min, (FIG. 17B) at 80° C. and at t=0 min, and (FIG. 17C) at 80° C. and at t=800 min, and SEM images of hydrolyzable capsules (FIG. 17D) before and (FIG. 17E) after hydrolysis. FIGS. 18A-18B show (FIG. 18A) degradation rates of an acid precursor dodecane sulfonyl chloride with and without encapsulation in hydrolyzable capsules and (FIG. 18B) a representation of a proposed delayed generation of a sulfonic acid and a sulfonate salt by encapsulation of an acid precursor in hydrolyzable capsules. FIG. 19 shows an emulsification of crude oil and distilled water with and without encapsulation of an acid precursor dodecane sulfonyl chloride in hydrolyzable capsules.

Synthesis of hydrolyzable particles (e.g., nanoparticles, microparticles, or the like, or any combination thereof) with acid/emulsifier precursors via miniemulsion polymerization. In an illustrative synthesis, 0.12 g of N-dodecyl-N,N-dimethyl-3-ammonio-1-propanesulfonate, 0.2 g of CTAB, 0.05 g of [2-(methacryloyloxy)ethyl]trimethylammonium chloride, and 0.04 g of 2,2′-azobis(2-methylpropionamidine) dihydrochloride were dissolved in 16 g of salinity water containing ˜10 wt. % sodium chloride. 2.66 g of vinyl laurate (VL) and 0.34 g of vinyl acetate (VA) were added to the surfactant solution and sonicated using a Branson digital sonifier 450 for 3 min. After purging N₂ for 5 min, the obtained milky emulsion was heated to 60° C. and kept at that temperature for 20 h to generate positively charged hydrolyzable nanoparticles. The nanoparticles had a size of ˜90 nm and their zeta potential was ˜+36 mv.

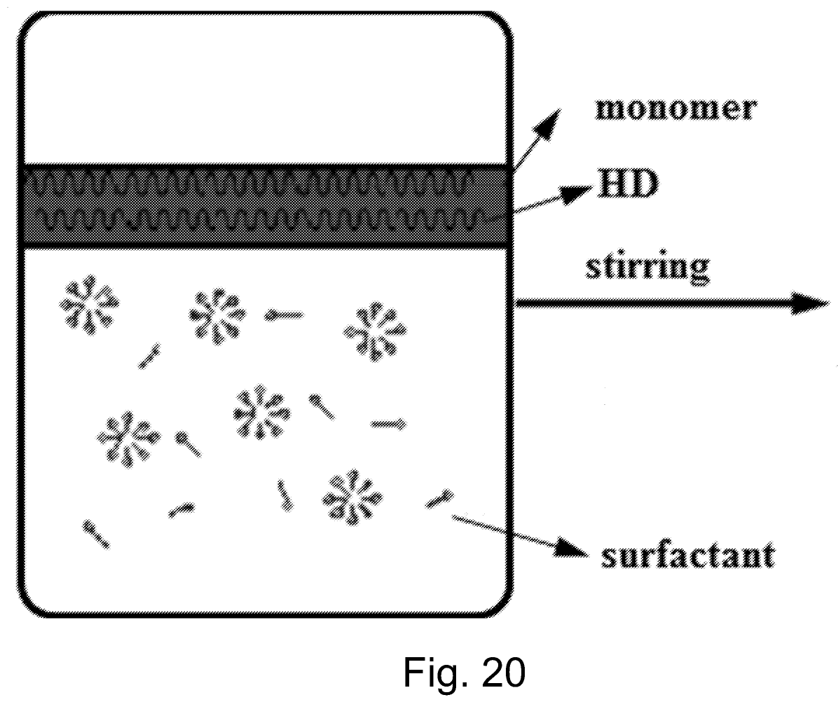

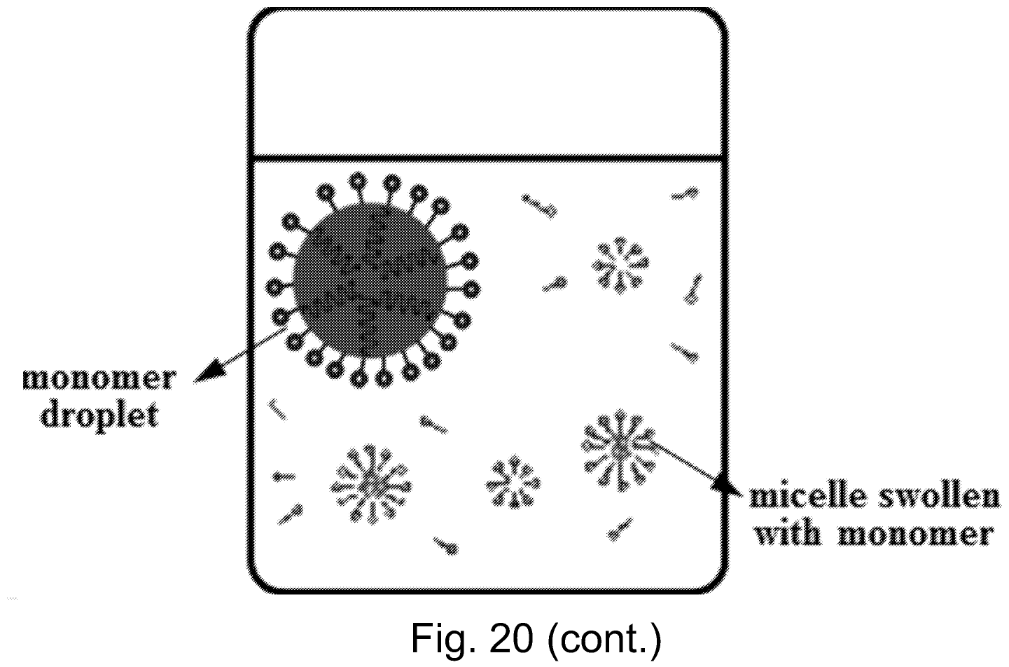

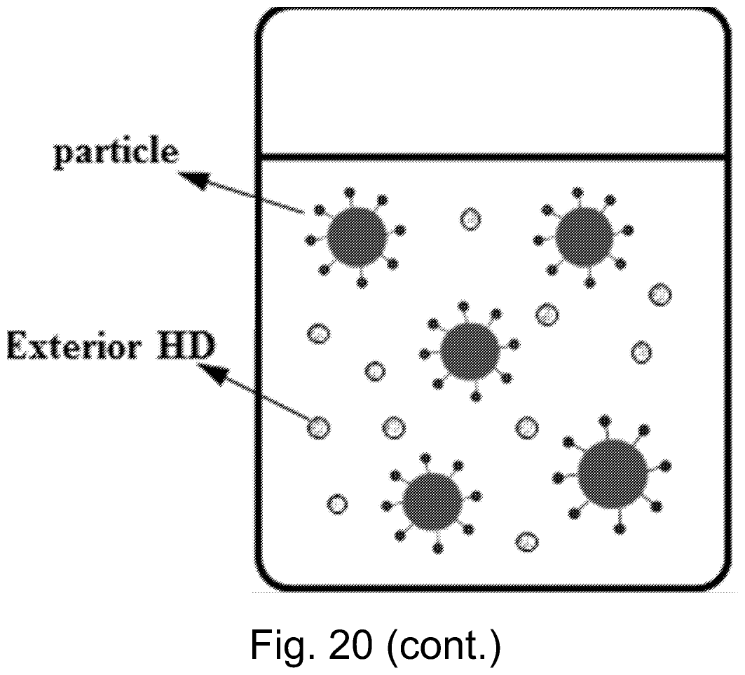

Synthesis of hydrolyzable particles (e.g., nanoparticles, microparticles, or the like, or any combination thereof) with acid/emulsifier via emulsion polymerization. FIG. 20 shows a representation of a synthesis of solid hydrolyzable nanoparticles using emulsion polymerization. Micellar nucleation occurs without sonication. Swollen micelles grow into nanoparticles. Droplets only serve as a monomer reservoir. In an illustrative synthesis, 0.12 g of N-dodecyl-N,N-dimethyl-3-ammonio-1-propanesulfonate, 0.3 g of Brij L23, 1.2 g of isopropanol, 0.6 g of [2-(methacryloyloxy)ethyl]trimethylammonium chloride, and 0.04 g of 2,2′-azobis(2-methylpropionamidine) dihydrochloride were dissolved in salinity water containing ˜10 wt. % sodium chloride. To the obtained clear solution 2.66 g of vinyl laurate (VL) and 0.34 g of vinyl acetate (VA) were added under vigorous stirring. The emulsion was heated to 55° C. and kept at that temperature for 24 h to generate positively charged hydrolyzable nanoparticles. The nanoparticles had a size of ˜60 nm and their zeta potential was ˜+38 mv.

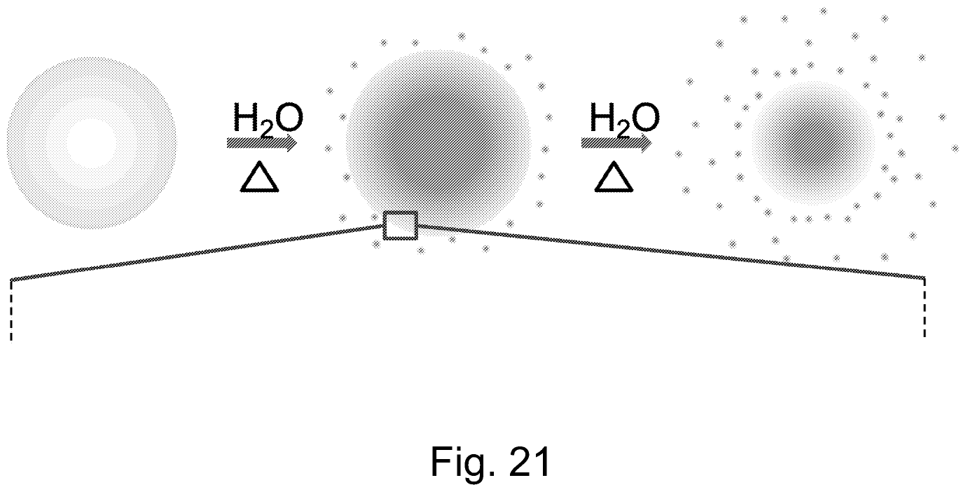

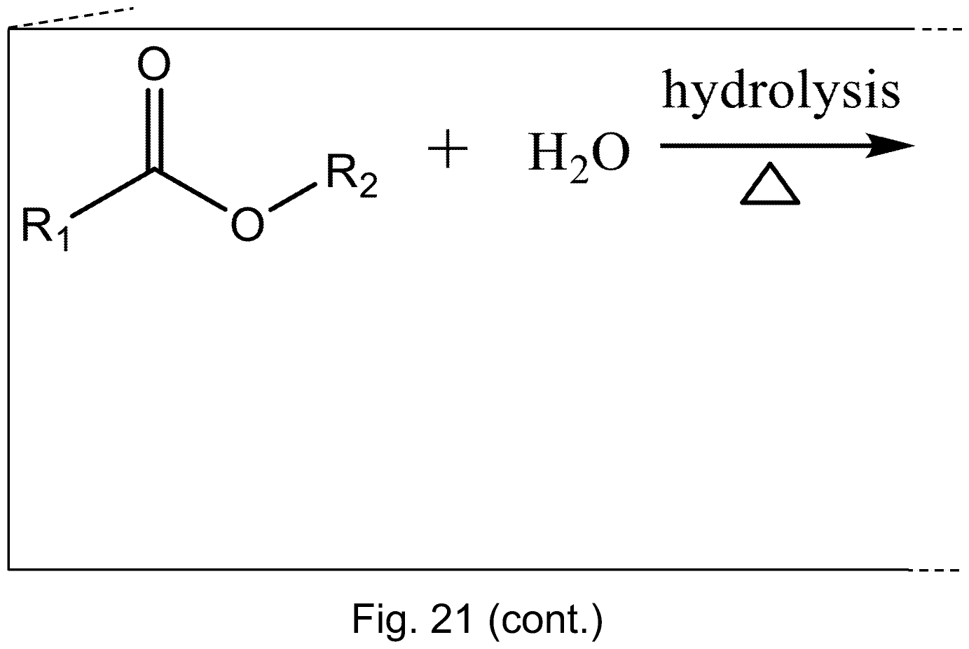

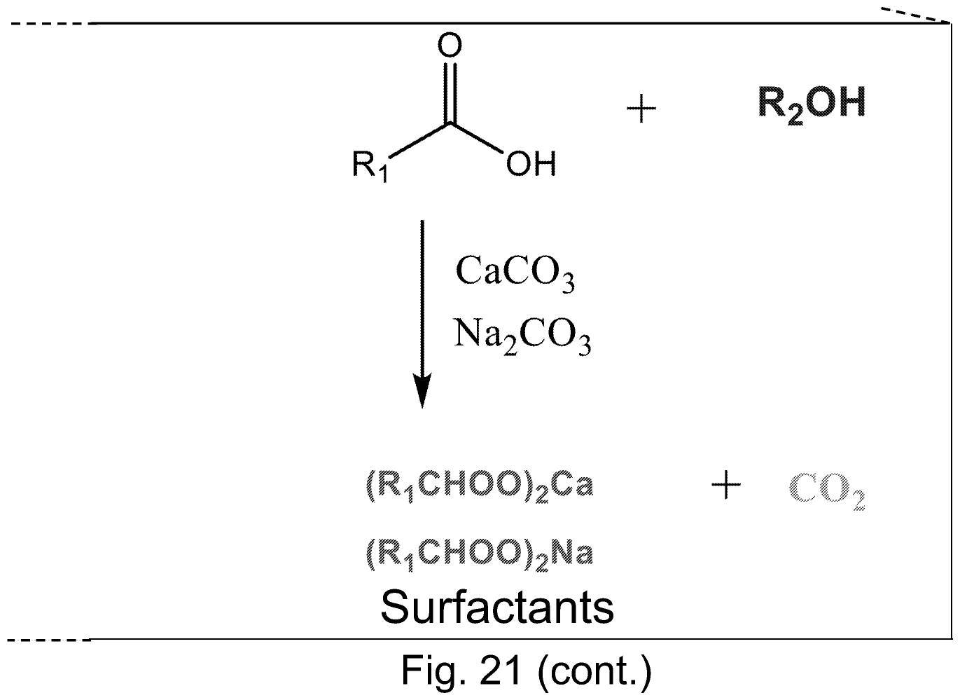

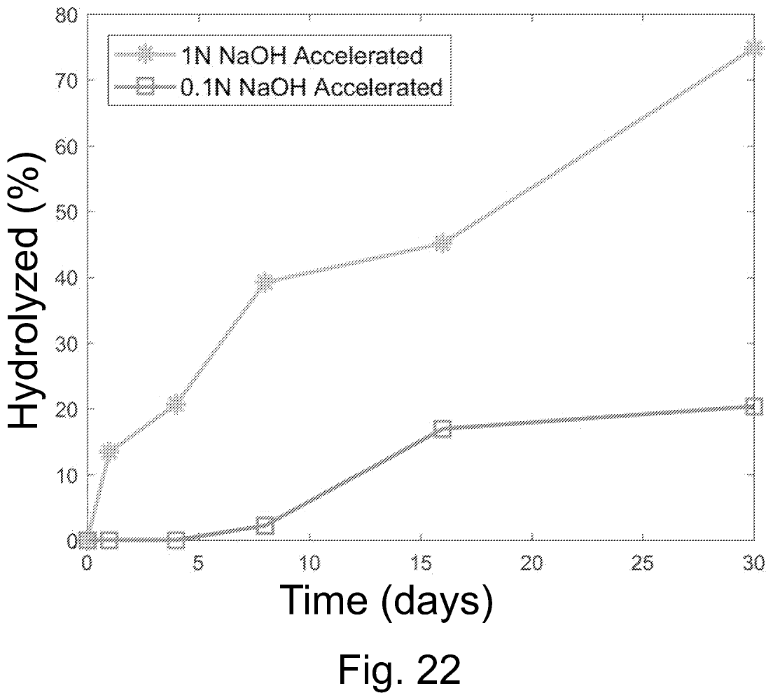

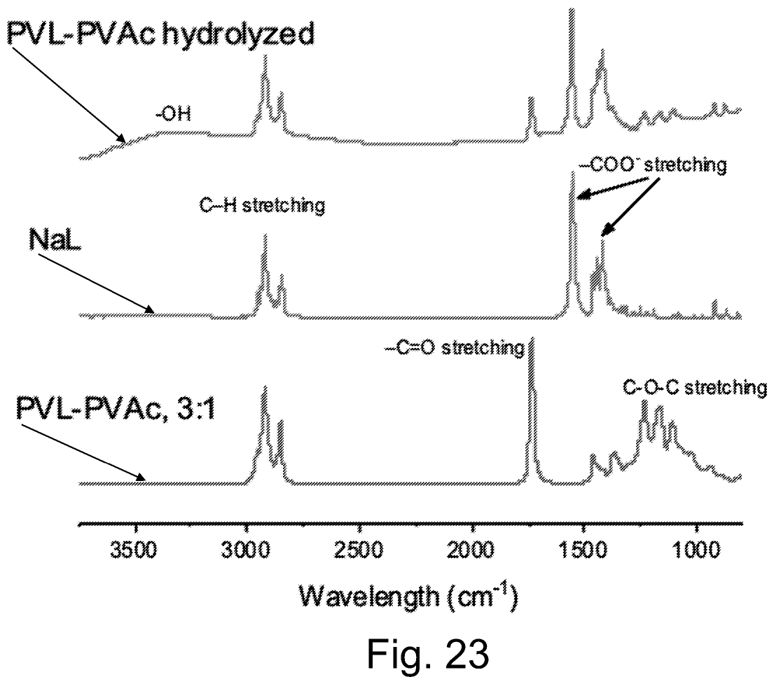

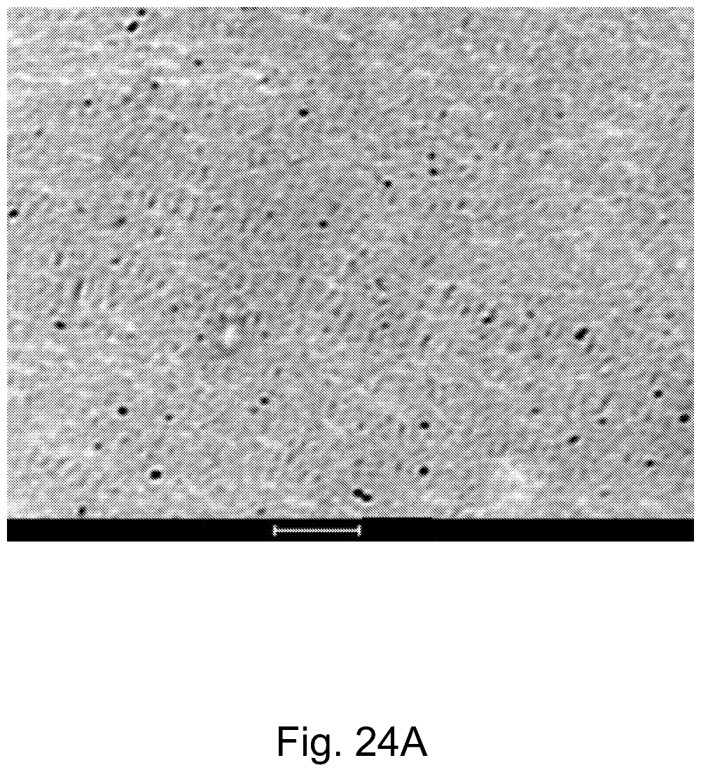

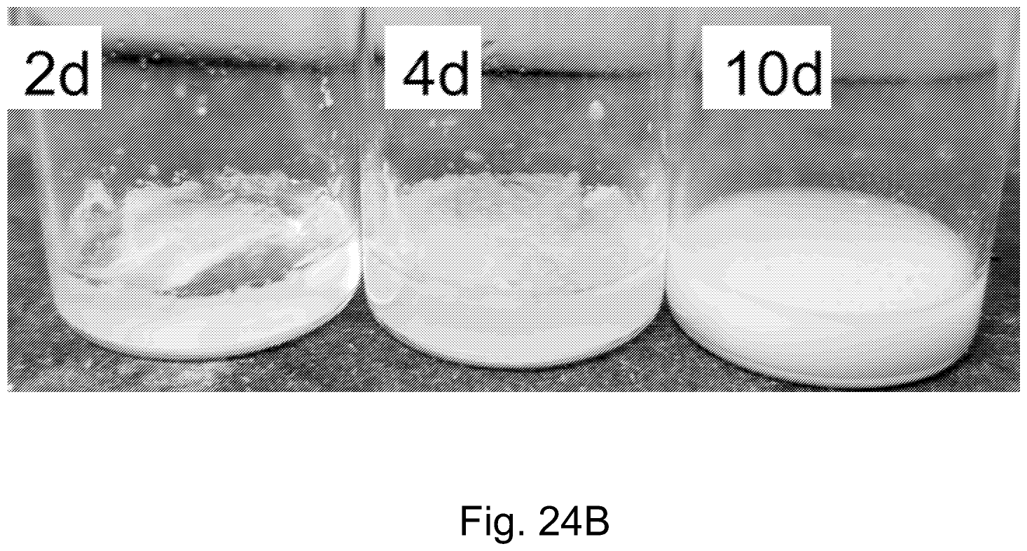

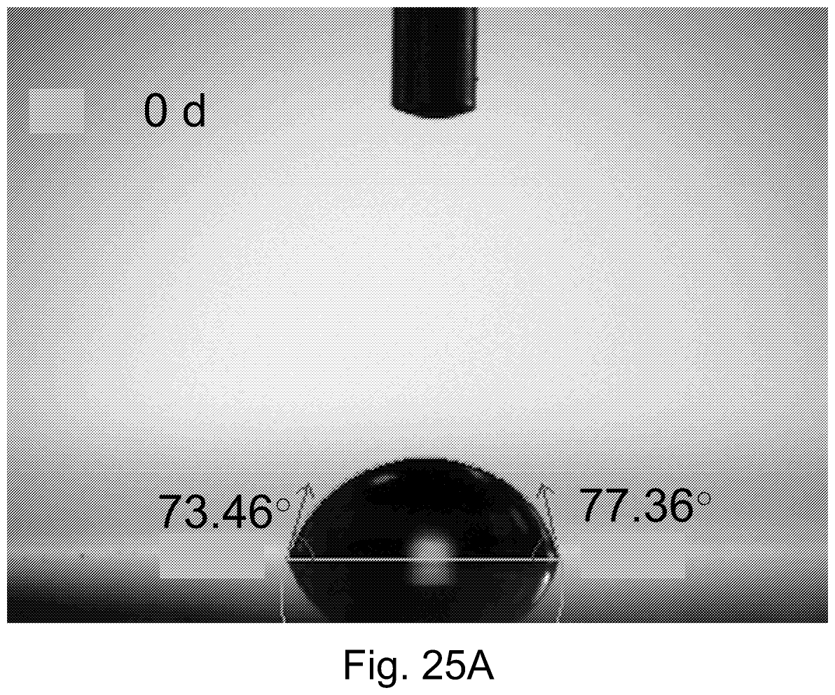

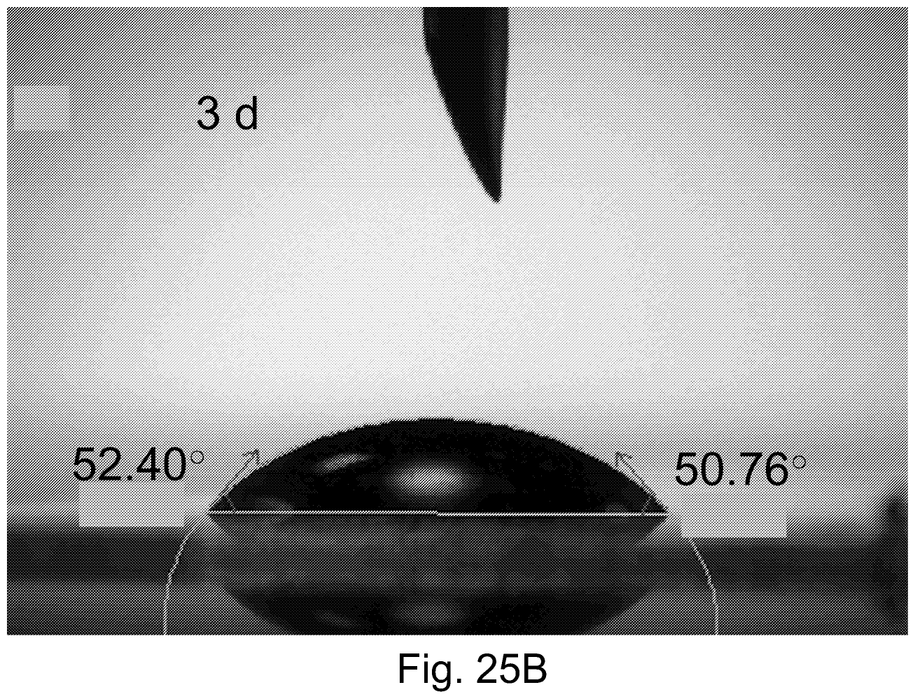

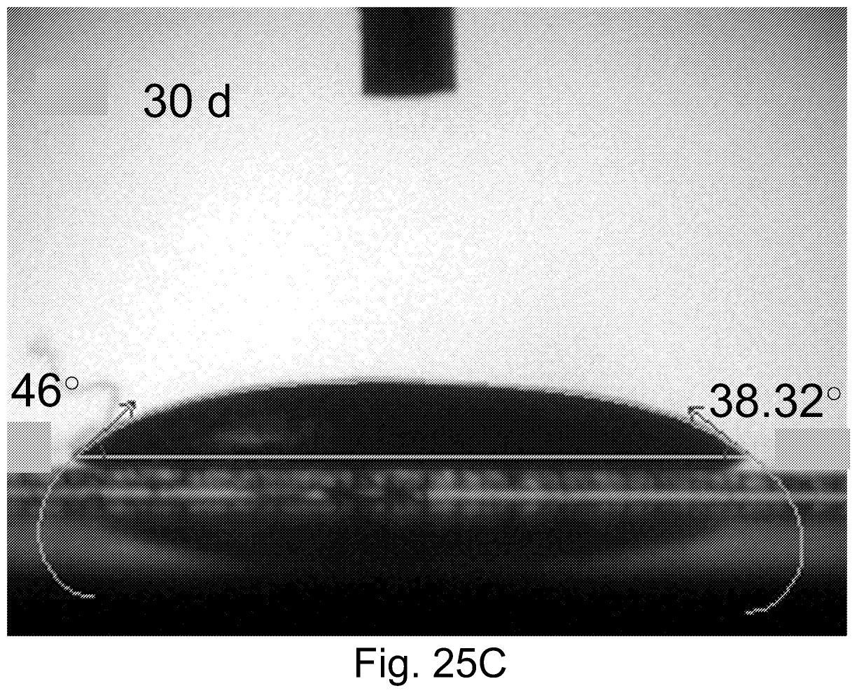

FIG. 21 shows a representation of solid hydrolyzable nanoparticles undergoing retarded surfactant release via hydrolysis. FIG. 22 shows hydrolysis rates of hydrolyzable solid nanoparticles prepared from poly(vinyl laurate)/poly(vinyl acetate)(3:1 mole ratio) (PVL/PVA (3:1)) copolymers in varying NaOH concentrations for varying time (days). FIG. 23 shows FTIR spectra of hydrolyzable nanoparticles prepared from PVL/PVA (3:1) before and after hydrolysis, compared with sodium laurate (NaL). FIGS. 24A-24B show hydrolysis of PVL/PVA (3:1) Particles: (FIG. 24A) SEM of pristine PVL/PVA nanoparticles, (FIG. 24B) photographs of solutions after hydrolysis for 2 days (d), 4 d, and 10 d. FIGS. 25A-24C show contact angle changes for PVL/PVA (3:1) nanoparticles hydrolyzed in IN NaOH: (FIG. 25A) at t=0 days (d), (FIG. 25B) at t=3 d, (FIG. 25C) at t=30 days).

### EXAMPLE 4

The following is an example of charged polymeric particles (e.g., nanoparticles, microparticles, or the like, or any combination thereof) of the present disclosure and methods of producing and using said charged polymeric particles(e.g., nanoparticles, microparticles, or the like, or any combination thereof).

There is increasing evidence that NP injection can have a significant impact on reservoir monitoring (estimating saturation and state of oil) and remediation (increased mobilization and production). The following is an example of an approach based on a design that provides the necessary colloidal stability and prevents adsorption by rock minerals both of which are critical limitations of existing systems.

In one example, a system is described based on NP cores (solid or hollow) decorated with polyelectrolyte brushes. In various examples, the polyelectrolyte brushes carrying either positive or negative charges endow the system with the necessary colloidal stability. In various examples, the NPs decorated with brushes carrying positive charges have the added advantage of being attracted to the oil/water interface. In various examples, the assembly and decoration of the interface by the NPs is exploited to enhance the contrast between oil and water. In addition, in various examples, the attraction and assembly is exploited to deliver specific cargo (e.g. surfactant molecules in order to emulsify oil/water mixtures). Lastly, in various examples, the positive charge on the NPs minimizes adsorption to the pore rock allowing the NPs to travel and reach deeper into the reservoir.

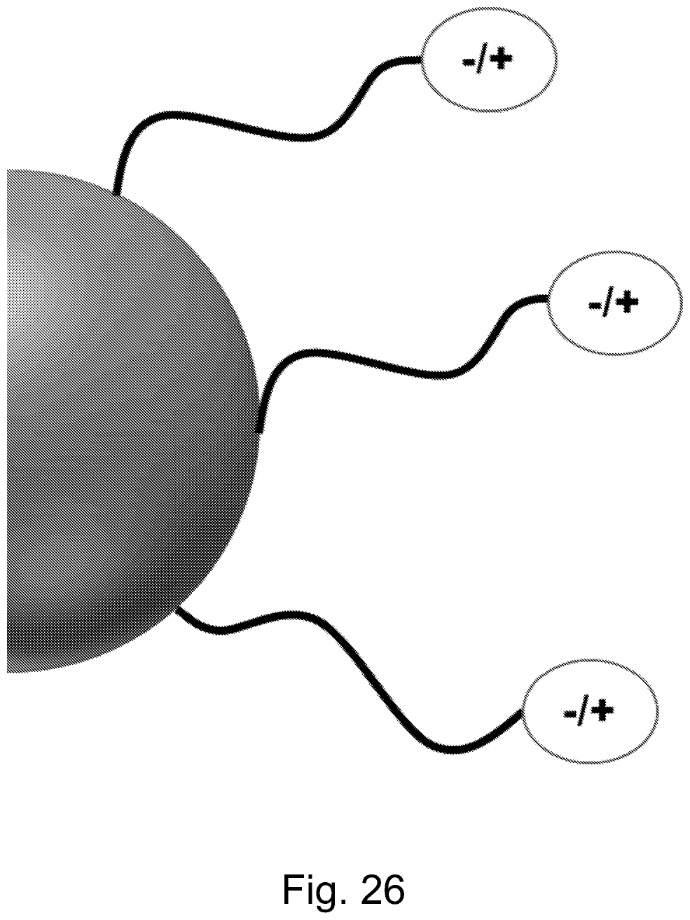

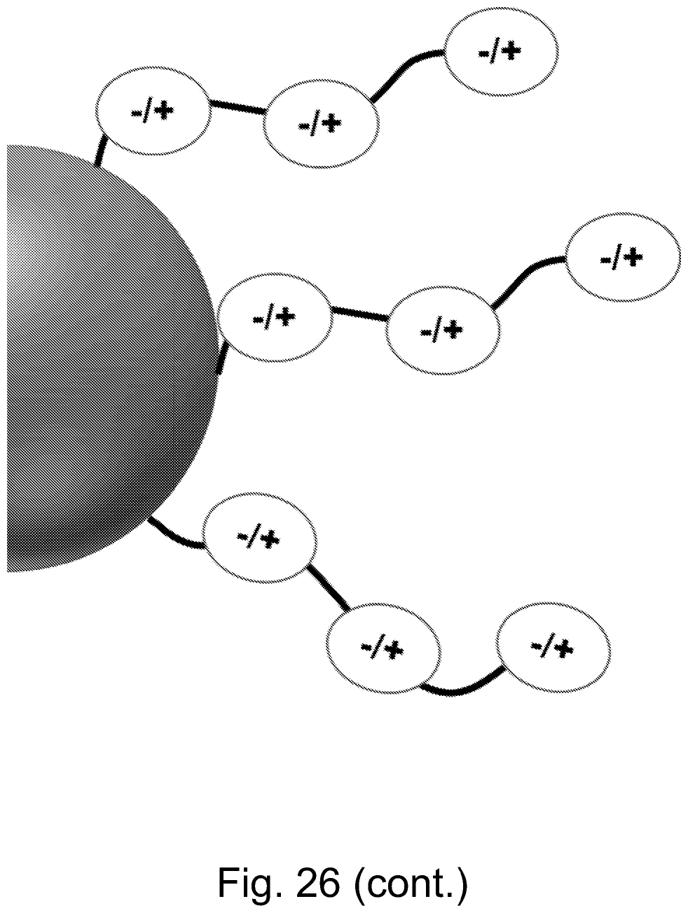

The design and synthesis of a new particle (e.g., NP, MP, or the like, or any combination thereof) platform comprised of a particle (e.g., NP, MP, or the like, or any combination thereof) core, which is further decorated with a corona of polyelectrolyte brushes is disclosed herein. One important distinguishing factor to this new system is that the charges (and accompanying counter ions) are distributed throughout the polyelectrolyte brushes rather than placed at the end of polymer chains (FIG. 26). This feature allows for fine-tuning the stability of the particles (e.g., NPs, MPs, or the like, or any combination thereof) to meet specific salinity environments, which are applicable for different reservoirs. In addition to subsurface applications, these new particles (e.g., NPs, MPs, or the like, or any combination thereof) may find applications in a number of fields, where long-term colloidal stability remains a challenge. Of particular importance for oil reservoir applications is a subset based on particles (e.g., NPs, MPs, or the like, or any combination thereof) decorated with a corona of polyelectrolyte brushes that bear a positive charge. The importance stems from that oil in a reservoir is typically negatively charged. Because of their positive charge, these particles (e.g., NPs, MPs, or the like, or any combination thereof) are attracted and assembled at the water/oil interface. In addition, adsorption of the particles (e.g., NPs, MPs, or the like, or any combination thereof) on mineral surfaces (e.g., calcite) that are also positively charged, is minimized. While the examples below demonstrate their use on hydrocarbon reservoirs the particles (e.g., NPs, MPs, or the like, or any combination thereof) are also applicable for monitoring geothermal reservoirs or for subsurface environmental remediation, where water and contaminants flow through interconnected pores.

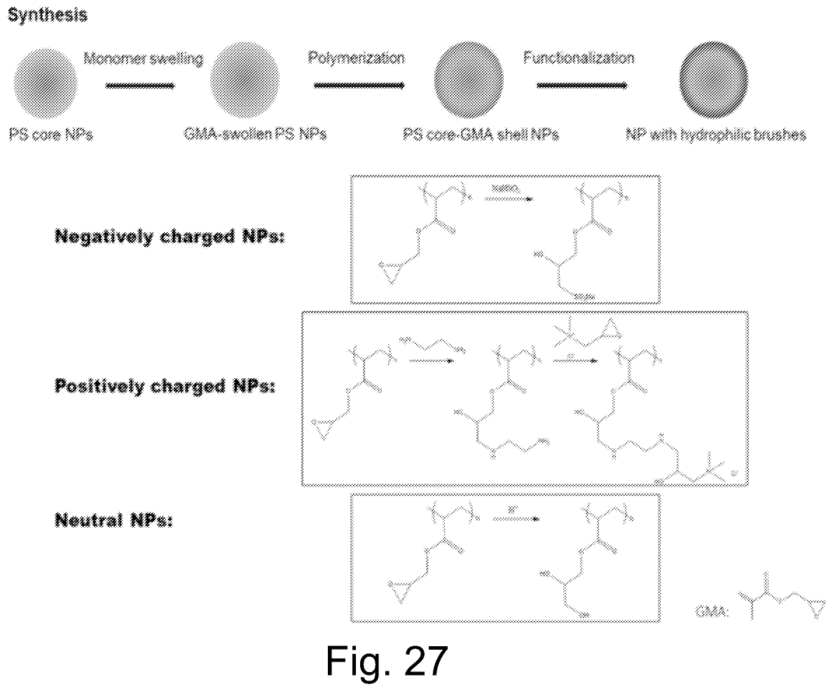

Synthesis of NP Cores for Subsequent Functionalization with Positively-Charged Polyelectrolyte Brushes (FIG. 27). NP cores were synthesized via emulsion or miniemulsion (nanoemulsion) polymerization followed by grafting of the polyelectrolyte brushes. In a typical synthesis, an emulsion was prepared by adding styrene (1.8 g) to a homogeneous solution containing CTAB (0.8 g), 2,2′-azobis(2-methylpropionamidine) dihydrochloride (0.1 g) and water (60 g) under vigorous stirring at room temperature. After purging with nitrogen for 10 minutes at room temperature, the emulsion was quickly heated to 75° C. and then maintained at that temperature for 60 min. The size and z-potential of the cores were 125 nm and +42 mV.

Process to Produce NPs Decorated with Positively-charged Polyelectrolyte Brushes, b-NPs(+). To the above a solution of glycidyl methacrylate (1.6 g) and divinylbenzene (0.16 g) were added at a rate of 2 mL per hour. After further polymerization for 200 min, the mixture was cooled down to 50° C. followed by the addition of ethylenediamine (2.7 g). The dispersion was kept stirring for 2 days and then dialyzed against deionized water for 3 days with frequent changes of the water. Subsequently, glycidyltrimethylammonium chloride (5.1 g) was added and the mixture kept stirring at 50° C. for 2 days. The product was purified against deionized water for 3 days. The average size of the b-NPs(+) was 195 nm and their zeta potential +40 mV. The size and charge were tunable by changing the amount of the surfactant and monomers used.

Synthesis of NP Cores for Subsequent Functionalization with Negatively-Charged Polyelectrolyte Brushes. An emulsion was prepared by adding styrene (1.8 g) to a homogeneous solution containing sodium dodecyl sulfate (0.8 g), sodium persulfate (0.1 g), sodium bicarbonate (0.1 g) and water (60 g) under vigorous stirring at room temperature. After purging with nitrogen for 10 minutes at room temperature, the emulsion was quickly heated to 75° C. and then maintained at that temperature for 60 min.

Process to Produce NPs Decorated with Negatively-charged Polyelectrolyte Brushes, b-NPs(−). To the above a solution of glycidyl methacrylate (1.6 g) and divinylbenzene (0.16 g) were added at a rate of 2 mL per hour. After further polymerization for 200 min the mixture was cooled down to room temperature. Subsequently, a solution of sodium sulfite (2.5 g) and sodium bisulfite (2.5 g) in deionized water (30 g) was added under vigorous stirring at room temperature. The resultant mixture was heated under nitrogen at 85° C. for 48 h. The product was dialyzed against deionized water for 3 days. The average size of the nanoparticles was 120 nm and the zeta potential −25 mV. Similarly to the positively charged b-NPs(+) described, both the size and charge of the b-NPs(−) were tunable by changing the amount of the surfactant and monomers used.

Synthesis of NPs with Neutral Brushes, b-NPs. An emulsion was prepared by adding styrene (1.8 g) to a homogeneous solution containing Triton X-305 (1.6 g), sodium persulfate (0.1 g), sodium bicarbonate (0.1 g) and water (60 g) under vigorous stirring at room temperature. After purging with nitrogen for 10 minutes at room temperature, the emulsion was quickly heated to 75° C. and then maintained at that temperature for 90 min. Subsequently, a solution of glycidyl methacrylate (1.6 g) and divinylbenzene (0.16 g) was added to the mixture at a rate of 2 mL per hour. After further polymerization for 200 min, the pH of the latex was adjusted to 4 using hydrochloric acid. The product was kept stirring for 1 day and then dialyzed against deionized water for 3 days.

Example 1 shows the assembly of positively charged NPs at the oil-water interface (FIGS. 3A-3B). Example 2 shows the use of assembled NPs as vehicles to deliver a cargo (e.g. surfactants) at the interface (FIGS. 14A-14C). However, the colloidal stability of these NPs were rather limited. To overcome the colloidal stability problem, a new material design was adopted, where the charges instead of being placed at the end of the polymer chains surrounding the NP cores, they were distributed along the chain similar to a polyelectrolyte brush (FIG. 26).

SEM images show both the positive NP cores (FIGS. 28A-28B) and the NPs after decoration with positively charged polyelectrolyte brushes, b-NPs(+) (FIGS. 28C-28D). Both systems were relatively monodispersed, and the sizes obtained from the SEM images agreed well with those obtained from Dynamic Light Scattering measurements. Interestingly, after decoration with the polyelectrolyte brushes the NPs no longer appeared smooth but rather patchy.

The colloidal stability of the NP cores and those decorated with the polyelectrolyte brushes were tested by mixing with high salinity water (HSW) and heating at 90° C. for several days. Aliquots were removed periodically and the size and dispersity of the suspension were evaluated by dynamic light scattering.

The core NPs whether positively- or negatively-charged aggregated almost instantaneously, when added to high salinity water sometimes even before heating to 90° C. The aggregation was believed to be the result of the efficient screening by the divalent ions present in high salinity water. In contrast, the NPs after functionalization with the polyelectrolyte brushes became far more stable (Table 5).

TABLE 5
Particle size (nm) stability for polystyrene NPs with
positively charged (b-NPs(+)) or negatively charged
(b-NPs(−)) polyelectrolyte brushes.

| Day | b-NPs(+) | b-NPs(−) |
|---|---|---|
| 1 | 219 | 105 |
| 2 | 235 | 90 |
| 3 | 285 | 94 |
| 4 | 285 | 101 |
| 5 | 301 | 100 |
| 8 | 307 | 103 |
| 11 | 338 | 102 |
| 15 | 427 | 106 |
| 18 | 465 | 107 |
| 22 | 516 | 109 |
| 25 | 555 | 105 |
| 29 | 603 | 105 |
| 36 | 680 | 110 |
| 47 | 690 | 111 |

Specifically, the negatively-charged NPs after functionalization with the polyelectrolyte brushes, b-NPs(−) showed no size increase and the dispersity of the suspension remained unchanged even after 47 days. The positively-charged polyelectrolyte brush functionalized NPs, b-NPs(+), showed some small increase and an increase in the dispersity of the suspension suggesting that some aggregation might be happening (although swelling was not ruled out as the cause of the size/dispersity increase). Nevertheless, even the positively charged polyelectrolyte brush NPs appeared far more stable than other systems.

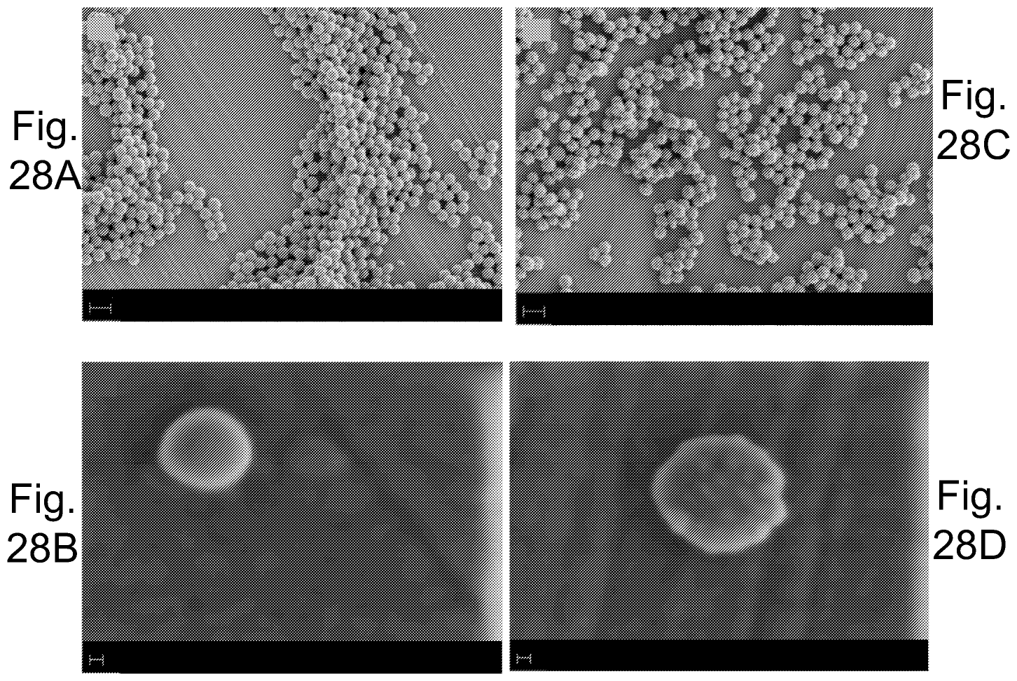

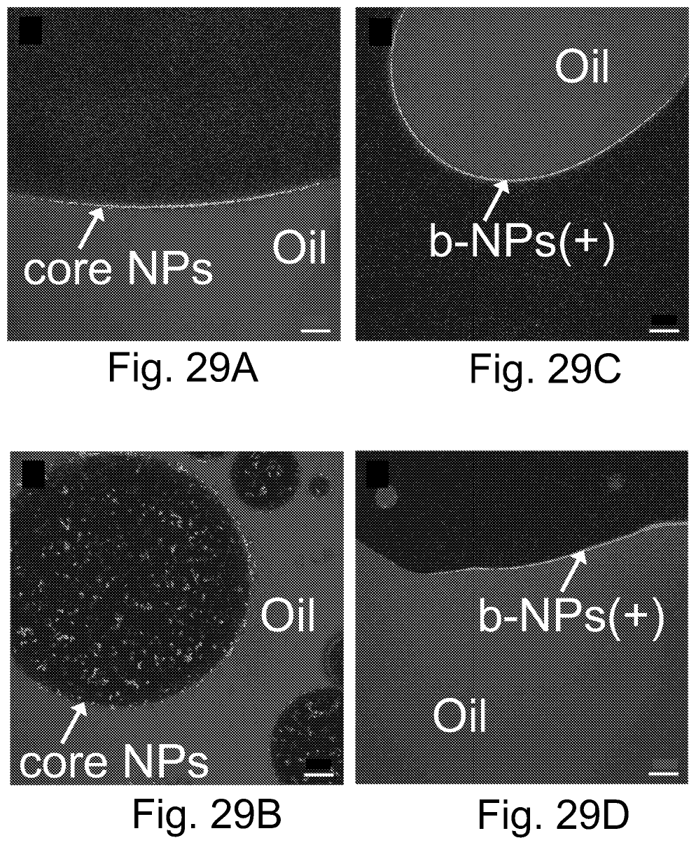

To investigate the directed assembly mechanism, interaction of positive NPs with a model oil-water mixture was studied. The selection of model oil was based on the necessity to introduce functional groups into the oil phase as well as to simulate crude oil behavior typically encountered in the field. Recall that the model oil was prepared by adding stearic acid in hexadecane. In the presence of water, the carboxylate groups segregated at the interface rendering the oil surface negatively-charged with a z-potential of −24 mV. Given the oils negative charge, positively-charged NPs (core and decorated with the polyelectrolyte brushes, b-NPs(+)) were investigated at the same concentrations (1,000 ppm) in DI water and seawater. When an equimolar mixture of water and model oil was vigorously agitated in a vortex mixer, it formed a non-uniform emulsion, which phase-separated quickly into the two immiscible phases. In contrast, when positively-charged NPs were added in the aqueous phase a different behavior was observed. LSCM images are shown for an equal volume mixture of model oil and DI water in the presence of positively-charged NPs (both the core only (FIG. 29A) and those decorated with the polyelectrolyte brush, b-NPs(+) (FIG. 29B)).

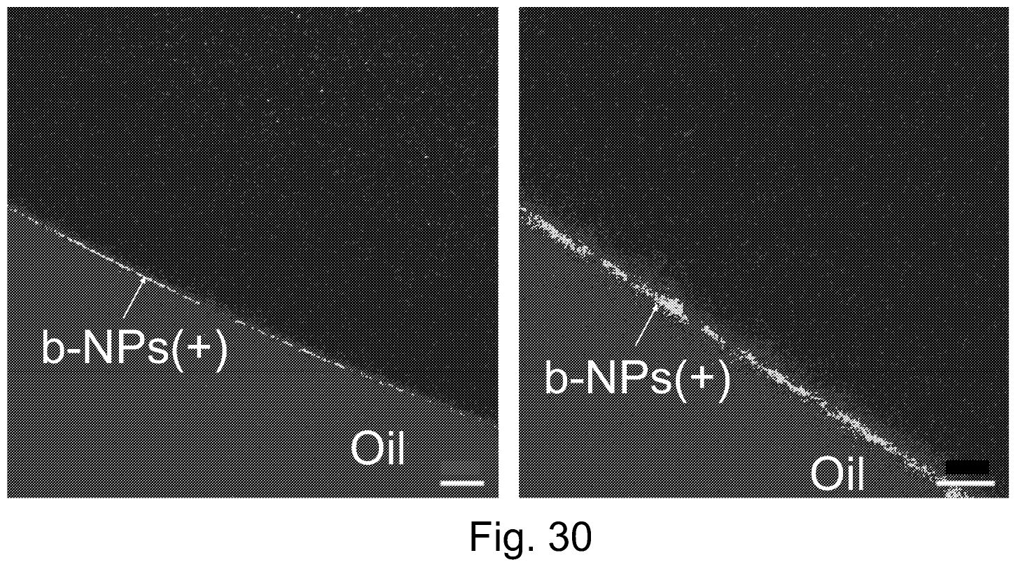

In DI water, the images show clearly that both NPs tended to segregate at the oil-water interface attracted by the negatively charged carboxylate groups in the oil phase. As previously disclosed, these experiments confirmed that complementarity of charges provided the necessary interactions and binding and was necessary for the successful directed assembly at the interface. When the medium was changed to seawater, confocal microscopy images show that the core NPs (FIG. 29C) still segregated and assembled at the interface, albeit to a lesser extent compared to the DI water due to the aggregation of the core NPs in seawater. In contrast, the assembly was virtually unaffected and no aggregation was observed, when a suspension of NPs decorated with the polyelectrolyte brush in seawater was used (FIG. 29D). To further evaluate the stability of the brush NPs, aliquots were removed after spending 22 days in high salinity water at 90° C. and mixed with model oil. LSCM images (FIG. 30) show clearly that the NPs with polyelectrolyte brushes assembled at the oil-water interface and no aggregation was observed. However, as previously mentioned, the positively charged core NPs aggregated almost instantaneously, when added to high salinity water even before heating to 90° C. This is a significant finding because it suggests that properly designed NPs can overcome the major limitation of aggregation and settling during deployment and effectively provide targeted delivery of surfactants at the oil-water interface.

Although the present disclosure has been described with respect to one or more particular examples, it will be understood that other examples of the present disclosure may be made without departing from the scope of the present disclosure.

1. A polymeric particle, wherein the polymeric particle is:
a capsule comprising a polymeric shell defining a spherical space, wherein the polymeric shell comprises one or more polymeric material(s) and one or more surfactant(s), one or more surfactant precursor(s), or a combination thereof disposed in the polymeric material(s) and/or the spherical space; or
a solid particle comprising one or more polymeric material(s) and one or more surfactant(s), one or more surfactant precursor(s), or a combination thereof disposed in the polymeric material(s),
wherein one or more or all portion(s) of an outer surface of the polymeric particle is/are positively charged.

2. The polymeric particle of claim 1, wherein the polymeric material(s) is/are not crosslinked and/or not complexed.

3. The polymeric particle of claim 1, wherein the polymeric particle has a longest linear dimension of from about 2 nanometers (nm) to about 50 microns (μm).

4. The polymeric particle of claim 1, wherein the polymeric shell has a thickness of from about 2 nanometers (nm) to about 25 microns (μm).

5. The polymeric particle of claim 1, wherein the polymeric material(s) comprise(s) one or more hydrolyzable polymeric material(s), one or more non-hydrolyzable polymeric material(s), a copolymer thereof, or a combination thereof, and wherein:
the hydrolyzable polymeric material(s) comprise(s) one or more hydrolyzable polymer(s), one or more hydrolyzable copolymer(s) thereof, or a combination thereof; and/or
the non-hydrolyzable polymeric material(s) comprise(s) one or more non-hydrolyzable polymer(s), one or more non-hydrolyzable copolymer(s) thereof, or a combination thereof.

6. The polymeric particle of claim 5, wherein the hydrolyzable polymeric material(s) each comprise one or more hydrolyzable group(s), and wherein, for each hydrolyzable polymeric material, the hydrolyzable group(s) are independently chosen from ester groups, urea groups, urethane groups, carbonate groups, amide groups, imide groups, anhydride groups, thioester groups, sulfonylurea groups, sulfonylamide groups, silyloxy groups, aryl halides, alkyl halides, and combinations thereof.

7. The polymeric particle of claim 5, wherein the hydrolyzable polymeric material(s) is/are chosen from polyesters, polyamines, polyureas, polyurethanes, polycarbonates, polyamides, polyimides, polyanhydrides, polythioesters, polysulfonylureas, polysulfonylamides, and polysiloxanes, polyaryl halides, polyalkyl halides, copolymers thereof, and combinations thereof.

8. The polymeric particle of claim 5, wherein the non-hydrolyzable polymeric material(s) is/are chosen from polystyrene, polyvinyl alcohol, polyether, polyethylene, polypropylene, copolymers thereof, and combinations thereof.

9. The polymeric particle of claim 5, wherein one or more or all portion(s) of the hydrolyzable polymeric material(s) is/are the surfactant precursor(s).

10. The polymeric particle of claim 5, wherein the hydrolyzable polymeric material(s) is/are present at about 0.1 weight percent (wt. %) or greater, based on the total weight of the polymeric particle.

11. The polymeric particle of claim 1, wherein the surfactant(s) is/are present at from about 0.1 weight percent (wt. %) to about 60 wt. %, based on total weight of the polymeric particle.

12. The polymeric particle of claim 1, wherein the surfactant(s) is/are chosen from cationic surfactant(s), anionic surfactant(s), nonionic surfactant(s), zwitterionic surfactant(s), and combinations thereof and, optionally, is/are polymeric surfactant(s).

13. The polymeric particle of claim 12, wherein the cationic surfactant(s) is/are chosen from alkyl ammonium surfactant(s), aryl ammonium surfactant(s), alkyl phosphonium surfactant(s), aryl phosphonium surfactant(s), alkyl sulfonium surfactant(s), aryl sulfonium surfactant(s), polyquaternium surfactant(s), and combinations thereof.

14. The polymeric particle of claim 12, wherein the cationic surfactant(s) is/are chosen from hexadecyltrimethylammonium bromide, cetylpyridinium chloride, tributyltetradecyl phosphonium chloride, tributylhexadecyl phosphonium bromide, 1-hexadecyl-3-methylimidazolium chloride, and combinations thereof.

15. The polymeric particle of claim 12 wherein the anionic surfactant(s) is/are chosen from carboxylate salt(s), sulfonate salt(s), phosphate salt(s), and combinations thereof.

16. The polymeric particle of claim 12 wherein the nonionic surfactant(s) is/are chosen from fatty alcohol alkoxylate(s), fatty acid alkoxylate(s), fatty acid alkanolamide(s), alkyl phenol alkoxylate(s), alkylamine oxide(s), alkyl polyglucoside(s), and combinations thereof.

17. The polymeric particle of claim 1, wherein the surfactant precursor(s) is/are chosen from ester(s), halide(s), carboxylic acid(s), sulfonic acid(s), phosphoric acid(s), and combinations thereof.

18. The polymeric particle of claim 1, wherein the surfactant precursor(s) is/are present at from about 10 weight percent (wt. %) to about 99 wt. %, based on total weight of the polymeric particle.

19. The polymeric particle of claim 1, wherein one or more or all portion(s) of the outer surface of the polymeric particle has/have a static positive charge and/or a non-static positive charge.

20. The polymeric particle of claim 1, wherein one or more or all portion(s) of the outer surface has/have a zeta potential of from about 10 millivolts (mV) to about 70 mV.

21. The polymeric particle of claim 1, wherein the polymeric material(s) comprise(s) a plurality of positively charged groups disposed on one or more or all portion(s) of the outer surface of the polymer particle.

22. The polymeric particle of claim 1, further comprising one or more polyelectrolyte brush(es) disposed on one or more or all portion(s) of the outer surface of the polymeric particle, wherein the polyelectrolyte brush(es) comprise(s) a plurality of positively charged groups.

23. The polymeric particle of claim 22 wherein the polyelectrolyte brush(es) is/are present at from about 0.1 weight percent (wt. %) or greater, based on the total weight of the polymeric particle.

24. A composition comprising one or more polymeric particle(s) of claim 1.

25. The composition of claim 24, wherein the polymeric particle(s) is/are present at from about 5 parts per million (ppm) to about 1000 ppm.

26. The composition of claim 24, wherein the composition further comprises one or more carrier(s).

27. A method for oil recovery comprising:
contacting an oil-containing geological formation with one or more polymeric particle(s) of claim 1,
wherein after the contacting, one or more surfactant(s) and/or one or more surfactant precursor(s) is/are released from at least a portion of the polymeric particle(s).

28. The method for oil recovery of claim 27, wherein the polymeric particle(s) is/are contacted with the geological formation by pumping the polymeric particle(s) through a well bore.

29. The method for oil recovery of claim 27, wherein the contacting results in increased oil production from the geological formation.

30. The method for oil recovery of claim 27, wherein the surfactant(s) and/or surfactant precursor(s) is/are released from at least a portion of the polymeric particle(s) by diffusion out of and/or hydrolysis of at least a portion of the polymeric material(s).

31. The method for oil recovery of claim 27, wherein the polymeric particle(s) is/are present as a composition of claim 24.
